(19) United States
(12) Patent Application Publication
(10) Pub. No.: US 2007/0174151 A1
(43) Pub. Date: Jul. 26, 2007

(54) Shipment provider system

(76) Inventors: Jeff Anderson, San Diego, CA (US); Joseph Barrus, San Diego, CA (US); Patti Giberson, Vista, CA (US); Bharat Gogia, Carlsbad, CA (US); Dan McCauley, San Diego, CA (US); Jerome Snell, San Diego, CA (US); Brent Vincent, San Diego, CA (US)

Correspondence Address: PETER K. TRZYNA, ESQ., P O BOX 7131, CHICAGO, IL, 60680, US

(21) Appl. No.: 11/590,609

(22) Filed: Oct. 30, 2006

Related U.S. Application Data
(60) Provisional application No. 60/731,792, filed on Oct. 31, 2005.
(60) Provisional application No. 60/731,961, filed on Oct. 31, 2005.

(51) Int. Cl. G06Q 10/00

(52) U.S. Cl. 705/28

(57) ABSTRACT

A computing system receiving, from a wide area network, a real-time stream of delivery date-specific orders, the computing system processing the stream, the processing including controlling printing of the stream of delivery date-specific orders. Exemplary embodiments include, depending on the implementation, apparatus or system, communication systems, articles of manufacture, method of use and method of making, and corresponding products produced thereby, as well as data structures, computer-readable media tangibly embodying program instructions, manufactures, and necessary intermediates of any of the foregoing.

### II. PRIORITY STATEMENT

This is a continuation in part of (claiming priority from and incorporating by reference): U.S. Patent Application Ser. No. 60/731,792 filed Oct. 31, 2005, titled “Grower System”. This incorporates by reference U.S. Patent Application Ser. Nos. 60/700,062, filed Jul. 18, 2005, titled “Multi-Carrier Management System”; 60/731,961, filed Oct. 31, 2005, titled “Order Fulfillment System,”; Ser. No. 11/488,546, titled “Multi-Carrier Management System,” filed: Jul. 17, 2006; and that patent application titled “ORDER FULFILLMENT SYSTEM,” filed contemporaneously herewith on Oct. 30, 2006, having Express Mail No. EQ140106271 US. All applications have the same inventors. Also, incorporated by reference are: U.S. patent application Ser. No. 09/149,650 filed Aug. 9, 1998 and titled “Computer Control System Located at an Order Center for Shipping Product from a Remotely Located Distribution Center”; and Ser. No. 09/847,644 filed May 2, 2001 and titled “Generating a Courier Shipping Label or the Like, Including an Ornamental Graphic Design, at a Non-courier Printer”.

### I. COMPUTER CODE APPENDIX

A portion of the disclosure of this patent document contains material that is subject to copyright protection. The copyright owner has no objection to a statutory fair use of this material, as it appears in the files of the files or records of the U.S. Patent and Trademark Office, but otherwise reserves all copyright rights whatsoever. Computer code (as an appendix incorporated herein) is provided on the enclosed two (2) CD-ROM discs. Each of the discs contains the same information as the other.

This patent application includes Appendix with code on a CD, the CD filed herewith being incorporated by reference herein. The machine format is Industry Standard, the operating system compatibility is MS Windows. Most of the files are viewable in a simple text format, but are best interpreted, and only editable, using MS Visual Studio or the other MS software product designated for such file, and a list of the files contained on the CD-Roms, including their names, sizes in bytes, and dates of creation is as follows:

LENGTHY TABLE REFERENCED HERE
US20070174151A1-20070726-T00001
Please refer to the end of the specification for access instructions.

### III. TECHNICAL FIELD

The technical field is computers and data processing systems, as illustrated more particularly herein. Exemplary embodiments include, depending on the implementation, apparatus, communication systems, articles of manufacture, method of use and method of making the foregoing, and corresponding products produced thereby, as well as data structures, computer-readable media tangibly embodying program instructions, manufactures, and necessary intermediates of any of the foregoing.

### IV. BRIEF DESCRIPTION OF THE DRAWINGS

FIG. 1 illustrates an embodiment.

FIG. 2 illustrates an embodiment.

FIG. 3 illustrates an embodiment.

FIG. 4 illustrates an embodiment.

FIG. 5 illustrates an embodiment.

FIG. 6 illustrates an embodiment.

FIG. 7 illustrates an embodiment.

FIG. 8 illustrates an embodiment.

FIG. 9 illustrates an embodiment.

FIG. 10 illustrates an embodiment.

FIG. 11 illustrates an embodiment.

FIGS. 12-12B illustrate an embodiment.

FIG. 13 illustrates an embodiment.

FIG. 14 illustrates an embodiment.

FIG. 15 illustrates an embodiment.

FIG. 16 illustrates an embodiment.

FIG. 17 illustrates an embodiment.

FIG. 18 illustrates an embodiment.

FIG. 19 illustrates an embodiment.

FIGS. 20-20B illustrate an embodiment.

FIG. 21 illustrates an embodiment.

FIG. 22 illustrates an embodiment.

FIG. 23 illustrates an embodiment.

FIG. 24 illustrates an embodiment.

FIG. 25 illustrates an embodiment.

FIG. 26 illustrates an embodiment.

FIG. 27 illustrates an embodiment.

FIG. 28 illustrates an embodiment.

FIG. 29 illustrates an embodiment.

FIG. 30 illustrates an embodiment.

FIG. 31 illustrates an embodiment.

FIG. 32 illustrates an embodiment.

FIG. 33 illustrates an embodiment.

FIG. 34 illustrates an embodiment.

FIG. 35 illustrates an embodiment.

FIG. 36 illustrates an embodiment.

FIG. 37 illustrates an embodiment.

FIG. 38 illustrates an embodiment.

FIG. 39 illustrates an embodiment.

FIG. 40 illustrates an embodiment.

FIG. 41 illustrates an embodiment.

FIG. 42 illustrates an embodiment.

FIG. 43 illustrates an embodiment.

FIG. 44 illustrates an embodiment.

FIG. 45 illustrates an embodiment.

FIG. 46 illustrates an embodiment.

FIG. 47 illustrates an embodiment.

FIG. 48 illustrates an embodiment.

FIG. 49 illustrates an embodiment.

FIG. 50 illustrates an embodiment.

FIG. 51 illustrates an embodiment.

FIG. 52 illustrates an embodiment.

FIG. 53 illustrates an embodiment.

FIG. 54 illustrates an embodiment.

FIG. 55 illustrates an embodiment.

FIG. 56 illustrates an embodiment.

FIG. 57 illustrates an embodiment.

FIG. 58 illustrates an embodiment.

FIG. 59 illustrates an embodiment.

FIG. 60 illustrates an embodiment.

FIG. 61 illustrates an embodiment.

FIG. 62 illustrates an embodiment.

FIG. 63 illustrates an embodiment.

FIG. 64 illustrates an embodiment.

FIG. 65 illustrates an embodiment.

FIG. 66 illustrates an embodiment.

FIG. 67 illustrates an embodiment.

FIG. 68 illustrates an embodiment.

FIG. 69 illustrates an embodiment.

FIG. 70 illustrates an embodiment.

FIG. 71 illustrates an embodiment.

FIG. 72 illustrates an embodiment.

FIG. 73 illustrates an embodiment.

### V. MODES

The accompanying drawings are intended to illustrate and exemplify in a teaching manner. Therefore, embodiments used to carry out the teaching should not be viewed as limiting, but rather, should be viewed as instructively building to an overall teaching.

As used herein, the term “computer” or “computer system” generally refers to hardware or hardware in combination with one or more program(s), such as can be implemented in software. Computer aspects can be implemented on general purpose computers or specialized devices, and can operate electrically, optically, or in any other fashion. A computer as used herein can be viewed as at least one computer having all functionality or as multiple computers with functionality separated to collectively cooperate to bring about the functionality. Logic flow can represent signal processing, such as digital data processing, communication, or as evident from the context hereinafter. Logic flow can be implemented in discrete circuits. Computer-readable media, as used herein can comprise at least one of a RAM, a ROM, a disk, an ASIC, and a PROM. Industrial applicability is clear from the description, and is also stated below.

By way of the following prophetic teaching, there is provided computer (and support thereof, as in a data processing system, for implementations pertaining to embodiments herein, as well as related or necessary computer support such as for providing or facilitating shipments responsive to orders.

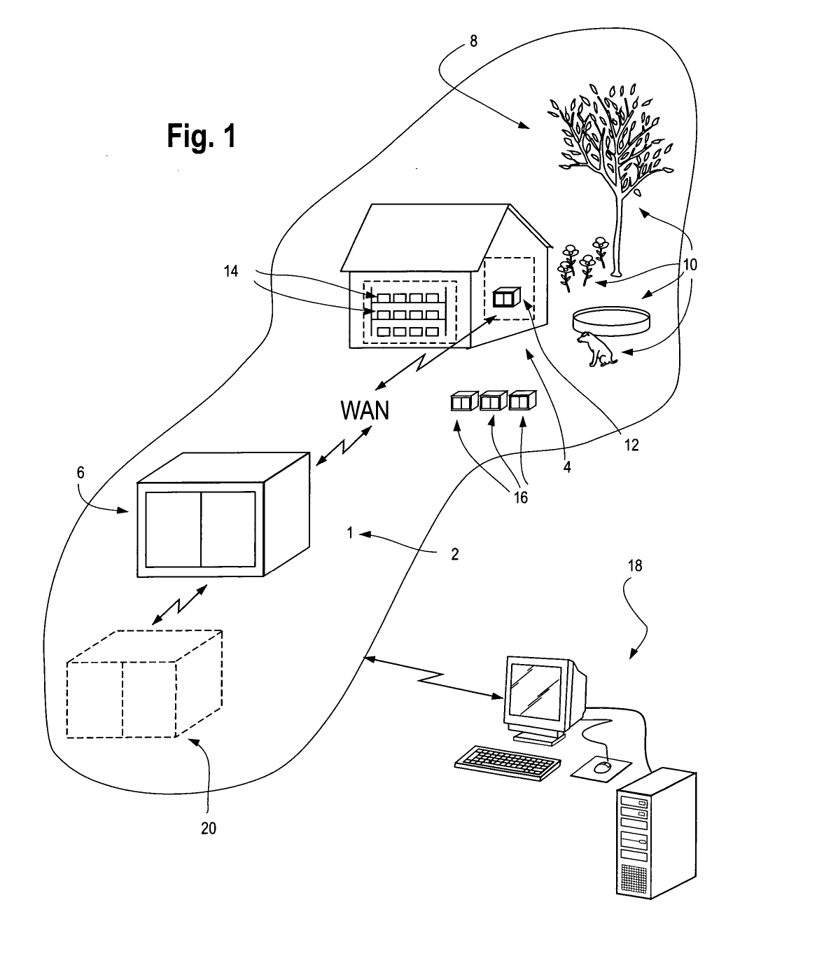

FIG. 1 illustrates an embodiment, though it is to be understood that this is for teaching, rather than limiting, particularly as regards an overview. Many variations and embodiments can utilize this teaching to variations suitable for one application or another, depending on the particulars of the situation of use.

By way of a prophetic example, there can be a system including a proximate end 2 and a distal end 4. The proximate end 2 can include a computing system 6 adapted for communicating, at least in part over a wide area network such as the Internet. The communicating can include a real-time stream of delivery date-specific orders. The distal end 4 can include a provider 8, which can, but need not be such as a farm producing perishables 10, which representatively can include meat, such as beef and/or fish, fruit, one or more flowers and/or one or more plants. At the distal end, there can be a second computing system 12 receiving the orders and controlling printing of the orders, for example on a plurality of printers 14. A plurality of shipments 16, from the distal end, can include at least one of the perishables 10 harvested, packed, and shipped such that the shipping corresponds to the orders. The shipments 16 can produce an order that leads to one of the shipments 16, which may include a card with a message, sent from one of a plurality of purchaser's computing systems 18, to be delivered to a recipient of one of the shipments 16. The message, and order for that matter, can be communicated over the wide area network to computing system 6, or via one or more computer systems 20. Computer systems 20 may comprise a web site, an ordering system backing up the web site, a fulfillment system cooperating with the ordering system, and/or a combination of any of the foregoing, as well as other systems such as back end systems and the like. Collectively, computer systems 6 and 20 can be considered as representative of an e-commerce system, though the illustrative configuration in FIG. 1 using multiple computer systems is not a necessity, (e.g., depending on the implementation of choice, these can be collapsed into one computer system or otherwise, as preference in embodiment may dictate). Other computer systems not shown in FIG. 1 can also be involved, such as charge card systems, a multi-carrier system, shipper/carrier systems (such as Federal Express's and UPS's computer systems). See, e.g., U.S. patent application Ser. No. 09/149,650 filed Aug. 9, 1998 and titled “Computer Control System Located at an Order Center for Shipping Product from a Remotely Located Distribution Center,” incorporated by reference.

Computing system 6 can be an Intel-based system, with a Windows-based operating system, though a Unix system is another an alternative.

The producer 8 can be a provider, which can be a producer, e.g., a farm or perishable production facility, such as a bakery, confectionary, etc.

The perishables 10 can be such as meat, e.g., ground beef, steaks, etc., sea food such as fish, crustacea, etc. In another embodiment, the perishables can be cookies or other sweets, confections, etc. Pharmaceuticals, dietary supplements, or other perishables are also feasible.

The second computing system 12 (at farm) can include an Intel-based system, with a Windows-based operating system, though a Unix system is another an alternative.

The printers 14 can be Lexmark printers with respective software. Other such printers can be used.

The shipments 16 can each include at least one perishable, and/or such as an accessory. For example, a shipment of a bouquet of flowers can include a vase as an accessory; a shipment of fruit can include a basket as an accessory. Stuffed animals, balloons, are other examples of accessories. It is also possible for the shipments to include different kinds of perishables, such as fruit and chocolate, flowers and chocolate, etc. The producer 8 can also ship one kind of perishable, such as chocolate, to satisfy one or more orders; and a different kind of perishable, such as flowers, to satisfy one or more other orders.

The shipments 16 can be boxes that include goods corresponding to the respective orders, along with a card with a message sent by one exemplary purchaser's computing system 18 to the recipient of one of the shipments 16. See, e.g., U.S. patent application Ser. No. 09/149,650 filed Aug. 9, 1998 and titled “Computer Control System Located at an Order Center for Shipping Product from a Remotely Located Distribution Center.”

As previously mentioned, there can be one or more purchaser's computer systems 18. At least one of the purchaser's computer systems 18 can include a digital computer with a processor (such as an Intel Pentium or Centrino processor), a memory, an input device (such as a keyboard, mouse, speech recognizer, disk or CD drive, computer-to-computer communication device, etc.), and an output device (such as a monitor, printer, disk or CD drive, or a computer-to-computer communication device such as a modem). The memory can include an operating system such as Windows or Linux to run the purchaser's computer systems 18, for example, enable application(s) software. The purchaser's computer systems 18 can use its computer-to-computer communication device to communicate via wide area network, such as the Internet.

In another embodiment, there can be a computer system computing system 12 adapted for receiving, from a WAN, a real-time stream of delivery date-specific orders. The computing system 12 is programmed for processing the stream, including controlling printing of the stream of delivery date-specific orders, e.g., at a set of printers 14. The processing can include managing a wave of the orders by distinguishing the wave from others of the orders. Computer system 12 can also be adapted to optimize printing with a set of printers 14 by using a subset of the printers 14 to maintain integrity of the wave of the orders. Representatively, the printing can include printing any or all of the following: cards with messages, packing lists, carrier waybill labels, etc., as well as a box end label for each of a plurality of the orders, the box end label preferably including a carrier shipping mode image.

Computer system 12 can be geared for handling the stream of orders by sorting the orders, but as the orders are preferably delivery-date specific orders for perishables, embodiments can (but need not) be devoid of sorting the orders according to warehouse efficiency. Instead, the sorting can be according to carrier drop ship locations, carrier shipment routing zones, shipment dates, pre-boxing requirements, carrier, delivery dates, minimizing shipping transit time, shipping mode, fulfillment, perishable, shipment contents, or any combination thereof. Note that some of said delivery date-specific orders can specify a different perishable than others of the orders specify, some of the orders may signal to pick, pack, and ship, and these can form a basis for sorting too.

As illustrated in FIG. 1, the real-time stream of delivery date-specific orders can include a real-time stream of delivery date-specific orders sent by an e-commerce order processing system comprised of computer systems 6 and/or 20, for example. The e-commerce order processing system (e.g., 6/20) can be sending the real-time stream of delivery date-specific orders, wherein the real-time stream of delivery date-specific orders includes at least one order communicated by the purchaser's computer system 18.

The computer system 12 can be programmed to send a stream of real time status information to computer system 6, the information corresponding to at least some of the orders, to the order processing system. With regard to the programming, see the appendix code, which can comprise at least one computer program and which is one means for controlling the computer system to receive a real-time stream of orders for perishables, wherein there is means for controlling processing the orders, and means for controlling printing the orders. Figures and text herein illustrate other “means for” embodiments. Thus, another embodiment is a computer-readable media tangibly embodying a program of instructions executable by a computer in a system to perform the operations discussed herein. For example, the operations can include controlling the computer system to receive a real-time stream of orders for perishables from a wide area network, to process the orders, and to print the orders. The media can include at least one of a RAM, a ROM, a disk, an ASIC, and a PROM.

So, in another way of thinking, the computer system 12 can include at least one processor and at least one computer program controlling the processor to sort the orders, and in some embodiments, print the orders to facilitate shipping corresponding to the orders. The computer system 12 can be arranged to receive information in real time and locate said information into a memory, the information including a plurality of orders, wherein some of the plurality of orders are delivery date-specific orders of at least one perishable. The computer system 12 can include at least one input device located for receiving the information from a wide area network, and the computer system 12 can further include at least one, and preferably a plurality of printers 14. The computer system 12 can be arranged to send, in real time over the wide area network, status information corresponding to some of the orders. Order cancellation communication, or changes to orders can also be communicated and processed, e.g., in accordance with the programming.

For example, the computer system 12 can be adapted for processing delivery date-specific orders, such that the provider computer system 12 is programmed to respond to a real-time stream of delivery date-specific orders, received from an e-commerce system 6/20, by facilitating shipment of some, but not all, of the orders. If there is no intervention by the e-commerce system 6/20 in fulfillment of one of the orders, the provider computer system 6/20 defaults to facilitate a shipment corresponding to the one of the orders; if there is intervention by the e-commerce system 6/20 in fulfillment of the one of the orders, the provider computer system 12 system does not facilitate a shipment corresponding to the one of the orders. Preferably the provider computer system 12 communicates status information for the orders, in real time, to the e-commerce system 6/20.

The foregoing represents various embodiments that can be used to carry out methods of use, such as receiving, from a wide area network, a real-time stream of delivery date-specific orders, and shipping to fulfill at least some of the orders. The shipping can be optimized for respective deliveries according to said date-specific orders but need not be optimized for warehouse efficiency. The receiving can receiving a real-time stream of cancellations and/or order updates for a plurality of the orders, e.g., from an e-commerce order processing system 6/20. The method can include sending a real-time stream of status information to the e-commerce order processing system 6/20.

Embodiments herein pertain to suppliers, especially growers or producers of perishable items such as flowers, but as used herein, references to a “Grower System” encompasses order fulfillment, generally applicable to suppliers, though there is particular utility and nuance in connection with perishables, which can be delivery-date sensitive. Embodiments enable the grower or producer (“Grower”), on location at its end 8, to receive and process orders for such as that which is produced, from an e-commerce or fulfillment system 6/20. The e-commerce system 6/20 can be such as an Internet vendor, herein exemplified as an “Order Fulfillment Service”. Information about the status of these orders is maintained and used by both the Grower and Order Fulfillment Service system 6/20 administration, at its end 2.

Now consider a more detailed embodiment

Business Processes

New order or modified order by a user of computer system 18.

Order details are inserted into a grower database (“db”) at the Order Fulfillment Service server 20.

One of a plurality of Growers at end 8 receives a stream of orders in real time.

Order details are specific to each of a plurality of the growers and are downloaded to each grower's local data store.

The representative Grower at end 8 reviews and prints orders to be fulfilled with shipments.

The representative Grower at end 8 prints reports for settlements with the Order Fulfillment System 6/20 at its end 2.

The representative Grower at end 8 sends details of re-route order(s) to the Order Fulfillment Service 6/20 and deletes those orders from the Grower data store.

User Needs Matrix

| NO | NEED\USERS | IT | GROWER |
|---|---|---|---|
| 1 | ORDER | | |
| | DOWNLOADS | | |
| 2 | ORDER | | |
| | MANAGEMENT | | |
| 3 | PRINTING | | |
| 4 | REPORTS | | |

In a more detailed manner of teaching embodiments herein, and corresponding “means for”, order details specific to a particular grower are downloaded to a particular grower's local data store. That grower can do any of: reviewing the orders, printing the orders to be shipped, generating reports corresponding to settlement(s), sending details of re-route order(s) via cooperation with the administration, and deleting those and cancelled orders from their data store.

Depending on the embodiment desired, the grower can view orders assigned to it by the administration system (herein referenced, in this embodiment, as part of computer system 6), and these orders can be viewed in different groups and different sort orders. Then the grower can select a set of orders and print them. The printing can be distributed across printers based on intelligent routing. That is, a grower system can allow configuring printers (adding or removing), setting defaults, setting default views etc. A grower system 12 can do data archiving and a cleaning up operation on a pre-defined interval.

There can be a local module (in the present example, a “grower module) having any or all of the:

Ability to display data over a date range grouped by day;

Group data by product/carrier/region(sort)/status (new/updated/printed);

Performance to handle, for example, perhaps about 100K orders for a 7 day span;

Capability to download data on demand;

Ability to generate following reports over specified date range:
Products shipped;
Accessories shipped;
Deleted orders;
Products/Shipper/Region;
Future products—by shipper/region;
Future Accessories;

Capability to print/export reports and product summary data;

Capability to print singe order/selected orders/selected product(s);

Capability to print top pre-specified orders from large selections;

Capability to print batch of orders scanned via bar code scanner;

Option to choose printer for selection or go with default mechanism;

Order—search, delete, mark as new or printed;

Configuration setup.

There can be a printing module having any or all of the abilities for:

Single form printing;

Group/batch printing;

Printing (any of the above) on specified printer;

Smart printing—spread a printing job over multiple printers for large group printing;

Printing a log per day/printer;

Printer a log containing a job identification assigned by the printer for each label;

Designing new labels and datamap;

Configuring printer settings.

There can be a download module having any or all of the abilities for:

Download of supplier-specific data from the administration system at 6;

Change status of this order as downloaded at the administration system;

Store downloaded order data into local datastore;

Store/Merge configuration information;

Invoke maintenance module for upgrade/rollback. There can be a maintenance module having any or all of the abilities for:

Archiving the old data (older than predefined number of days); and

Cleaning up/Removing old files (older than predefined number of days).

Upgrading the local (herein, e.g., grower) application can be downloaded from the administration system at 6 and installed at the Grower system 12 and the user presented with the option to use new version.

Turning now more particularly, in the teaching herein, there can be the following actors:

1. Grower—A person representing the grower who interacts with the system 12 to process orders for their business.

2. Grower System—The system 12 itself, especially when triggering automated processes.

3. Administration System at 6—The Fulfillment system, in this embodiment, as a portion of a program running at the Administration server 6 or 6/20, as may be preferred.

4. Administration Admin—A member of the Administration staff who administers the system at 6 and fulfillment process from end 2.

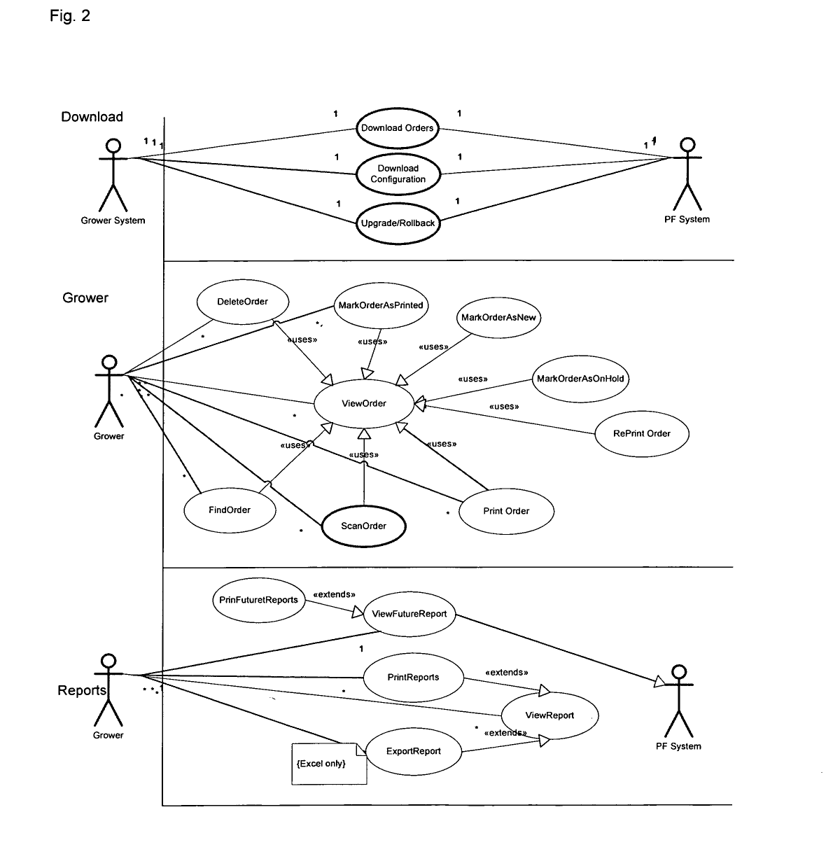

These actors implement in accordance with, for example, a case diagram of FIG. 2.

One of many ways to carry out such as a case diagram is for the Grower system 12 to download orders to process, with at least the downloading done in an automated way via a connection between Grower system 12 and Administration system at 6, e.g., via the Internet. Orders are saved to Grower data store, and order status is updated on Administration system at 6.

Consider an exemplary Grower system 12 and Administration system at 6 scenario:

1. Administration system at 6 sends the orders to the Grower system 12;

2. Grower system 12 saves orders to local data store;

3. Grower system 12 sends the status to Administration system at 6; and

4. Administration system at 6 updates status.

The Administration system at 6 sends the configuration information to the Grower system 12 via a connection between Grower system 12 and Administration system at 6 via a wide area network, e.g., the Internet, dial in, etc. Configuration information is saved to Grower data store.

Consider another exemplary scenario involving the Grower system 12 and Administration system at 6. The Administration system at 6 sends the configuration information to the Grower system 12, and the Grower system 12 saves the configuration information to a local data store.

Now consider the Administration System at 6 sending Upgrade/Rollback information to the Grower system 12 via a connection between Grower system 12 and Administration system at 6, such as a connection by the means exemplified above. Upgrade/Rollback respectively refers to a:

1. Grower application upgraded to a newer version

2. Grower application rolled back to an older version

As an exemplary scenario involving the Grower system 12 and Administration system at 6:

1. Administration system at 6 sends the upgrade information to the Grower system 12;

2. Grower system 12 downloads the upgrade of software; and

3. Grower system 12 upgrades itself to the newer version.

As another exemplary scenario involving the Grower system 12 and Administration system at 6:

1. Administration system at 6 sends the Rollback information to the Grower system 12; and

2. Grower system 12 rollsback to the older version of software.

Note that manual intervention can be included for the rollback.

As an exemplary scenario involving the Grower and Grower System 12, the Grower can view the orders from the local data store, group and sort them based on various dates, for example, as follows:

1. Grower starts the application;

2. Grower selects the date; and

3. Grower system displays all the orders for that day.

As may be preferred in one embodiment or another, the order(s) for the day can be displayed when the application starts.

Orders are printed on, or in connection with, shipping labels for processing. Labels can include box end labels indicative of shipping mode. Depending on the requirements of individual growers, orders may be sorted and separated based on criteria relevant to that grower's business.

As another exemplary scenario involving the Grower and Grower System 12:

1. Grower selects a group (one or more) orders to be printed;

2. Grower prints orders;

3. Status of orders is changed accordingly; and

4. A daily log to record all orders sent to various printers can be created and can be stored in local folder.

The configuration can be setup to allow setting days to retain these logs for historical purpose and all logs older than this set day can be removed by the system 12.

The Grower can delete the order, and it is marked as ‘deleted’ from the system 12, for example as follows:

1. Grower selects a group (one or more) orders to be deleted;

2. Grower deletes orders; and

3. Removes deleted orders from the display.

The orders marked as deleted need not actually be removed from data store.

The Grower can also mark the order as new, for example, as follows:

1. Grower selects a group (one or more) orders to be marked as New;

2. Status of the order is changed to New in the data store; and

3. Grower sees the new status.

The Grower can mark the order as printed already, e.g., as follows:

1. Grower selects a group (one or more) orders to be marked as printed;

2. Status of the order is changed to Printed in the data store; and

3. Grower sees the changed status.

The Grower can mark the order as OnHold (Pending some decision), e.g., as follows:

1. Grower selects a group (one or more) orders to be marked as On Hold.

2. Status of the order is changed to OnHold in the data store

3. Grower sees the changed status.

It is possible to locate an order based on certain criteria such as SKU (StockKeeping Unit: a retailer-defined coding system used to distinguish individual items within a retailer's accounting, warehousing, and point-of-sale systems), order or tracking number, e.g., as follows:

1. Grower selects to find an Order;

2. Grower System presents an input screen;

3. Grower enters selection criteria; and

4. Grower System displays order(s) that meet the criteria.

The Grower can also mark an order already marked as printed to be resent to the printer, e.g., as follows:

1. Do MarkOrderAsNew use case; and

2. Do PrintOrder use case.

An alternative scenario can be as follows:

1. Grower specifies print Job identification information and range of orders in the batch; and

2. Grower System reprints the specified print job.

An alternative scenario can be as follows:

1. Grower selects to run the last print job; and

2. Grower System reprints the last print job.

The Grower can scan one or more the labels to input the tracking number using a scanner and print those orders again.

A representative scenario can be as follows:

1. Grower inputs Tracking number;

2. Grower system shows the corresponding orders; and

3. Grower prints the order.

The Grower scan can result in a tracking number in another application. The operator can input that Tracking number to Grower system 12.

The Grower can also select one or more reports to b e generated, for example, as follows:

1. Grower selects a date;

2. Grower selects type of report to be viewed; and

3. Grower System generates and displays selected report.

Representative report can include Orders, Accessories, Deleted orders, Future orders/accessories, and shipper reports, though particular reports can reflect needs of one application or another. Addressing an interface for reports on future orders/accessories can be carried out by many approaches, for example, by providing a web interface that talks to the database and extracts the results to be presented in the browser.

As another representative scenario, consider the following example:

1. Grower performs a View Reports use case;

2. Grower selects a report to print; and

3. Grower System prints selected report on designated report printer.

As yet another representative scenario, consider the following example:

1. Grower selects Future report;

2. Grower system requests Administration system for information;

3. Administration system sends the required information; and

4. Grower system displays the information.

As still yet another representative scenario, consider the following example:

1. Extends ViewFutureReport;

2. Grower selects to print future report; and

3. Grower system prints the report in the designated printer.

As a further representative scenario, consider the following example:

1. Grower performs a ViewReports user case;

2. Grower selects which format to export to (e.g., Excel); and

3. Grower System exports report to format selected.

The Grower can also set client options and preferences for view, print, do maintenance, etc., for example, as follows:

1. Grower selects Setup Configuration;

2. Grower System displays current Configuration;

3. Grower changes options to desired values;

4. Grower selects to save the configuration; and

5. Grower System saves options.

The Grower can then use a View Configuration use case, for example, as follows.

1. Grower selects Setup Configuration;

2. Grower System displays current Configuration;

3. Grower adds or removes printer;

4. Grower configures the selected printer (report printer or default printer);

5. Grower selects to save the configuration; and

6. Grower System saves options.

Next the Grower can use the View Configuration use case, for example, as follows:

1. Grower selects Setup Configuration;

2. Grower System displays current Configuration;

3. Grower set up archive parameters;

4. Grower selects to save the configuration; and

5. Grower System saves options.

Another possibility is for the Grower to use the View Configuration use case, for example, as follows:

1. Grower selects Setup Configuration;

2. Grower System displays current Configuration;

3. Grower set up User Interface related parameters;

4. Grower selects to save the configuration; and

5. Grower System saves options.

The Grower system can handle archiving of old data, for example, as follows:

1. Grower System checks the archive information; and

2. Grower System does the archiving operation.

The Grower system can clean up old files (i.e., files older than pre-defined date), for example, as follows:

1. Grower System checks the Cleanup information; and

2. Grower System deletes the old files created for printing purpose.

Authentication and encryption may be required for communication with Administration system at 6. The grower application at 12 can support one, but preferably two levels of security: one to cater to regular users, and the other to address needs for admin users. The administrative user can have rights to manipulate data from the db tables to troubleshoot problems. The regular users on the other hand can have access to db via application only.

The performance for the grower application at 12 can be useful for peak period operations. Downloading orders to grower application User Interface can be adapted for performance, e.g., when there are around 300K orders in the system, e.g., to attain average performance at or less than 5 seconds.

Printing of orders to printer in large batch can also be useful for support during peak period operations. The application preferably ensures fast performance to upload orders to printers and preferably can have intelligent distribution of orders across printer.

As a representative architectural framework to implement the foregoing, there are many alternatives that depend on the application of interest. In one example, there can be four modules designed for the grower system 12, e.g., Grower module: This can be the main tool for a Grower that can be used to view, sort, print orders, and generate various reports.

Printing module: This module can be responsible for printing labels which includes creating data files per the data map, generating efficient printer queue based on the options selected, marking the orders as being printed and generating printing log.

Download module: This module is the link between grower and Administration. This module can be responsible to communicate with to the Administration System to get grower-specific order details for specified dates into grower's local data store. This module can send the status of upload back to the Administration System system. This module looks for latest updates to software/database and activate the process that updates the software before continuing the download.

Maintenance module: This module can be responsible for archiving data into historical tables to keep system running efficiently. This module can also provide mechanism for downloading software from Administration system's ftp server at 6 and upgrading the Grower software.

The grower system 12 can use .NET and modules as described above. The Grower module can be developed using third party grid control on Windows Forms for faster performance. The system 12 can allow a Grower to view orders in a most natural hierarchy and can allow flexibility to sort on various key columns for views orders in the specific group suitable for their purpose. It can also provide facility to generate useful reports that can be used to get overall idea of the task at hand and also for claiming bills for the products handled. The native database for .NET (Microsoft Developer Edition) can be used to make system implementation simple.

The download module can be developed with support of Sonic Queue. This queue can reside in the server at 6 and is grower specific. When the grower client is connected, it pushes a header information and a message body to the client. The download module on successfully retrieving the message body and storing it in the database, can return success to the server at 6. On getting a success flag, the message is removed from the sonic queue at the server at 6. Then the download module writes into another Sonic Queue at the server at 6 for status update.

Generally, Regarding Sonic queue, there can be 3 servers or server clusters. The client machine hosting the Grower applications at 12, a server cluster hosting the Sonic queues, and the servers hosting the Order Management/Fulfillment services at 6. When an order is placed, the Order Management/Fulfillment services at 6 will determine a supplier, carrier, and ship date (using the multi-carrier systems, for example) and place the result in the Sonic Queue hosted on a different server. A specific queue, dedicated to delivering messages to a specific supplier, will be used. The Grower application at 12 at that grower will then pull the message from the queue and for insertion into the grower database. The message can be a cancellation or update. For sending status messages back, the same thing happens but in reverse.

The print module can be responsible for printing labels for the order(s) identified to be printed. The print module can interact with the data access utilities to gather all order related information and can prepare the data file to be sent to the printer 14. It can also implement algorithm to take care of popular options for printing batch orders to support heavy load during busy seasons.

The Maintenance utility program can provide utilities for various maintenance tasks such as db upgrade, db backup, db archiving, purging print log, software upgrade and any other tasks needs to be done for book keeping.

The Administration System can place information that growers need into a grower specific sonic queue. The Administration System at 6 can provide software updates via secure ftp site that Grower's application can access to perform automatic software updates. Also, Administration System at 6 hosts the future order report information to the Grower.

Grower system 12 Download module's sonic client connects to the Sonic Queue at the Administration System server. On detecting the connection, the Sonic Queue pushes the Message header and the body to the sonic client. The header can have information about configuration update or prompting for software upgrade or order information.

Based on the message header, the download module can handle differently. For configuration update, it can update the config setting of the grower system. For software upgrade, it can prompt the Maintenance module to start the upgradation process. This module can insert or update order information into the database Microsoft Developer's Edition.

The data used by the display User Interface can be placed in the orderdetails table and the complete details of order are saved as a serialized xml in the same table (as a value in the column). This can make loading and managing the data in UI much faster.

The Grower User Interface can be the main user interface grower can use to manage orders they handle. This module can contain a database module which can be responsible for interacting with the database tables and return all the requested data in form of datasets. Specific datasets can be created for each use, for example; OrderHeaderDS, OrderDetailDS, OrderDeletedDS, ReportDS, PrinterSettingDS, ConfigDS etc. The database layer can also provide functionality that can be used to move old (configurable) processed orders to historical tables to keep tables used by presentation layer, printer and download module at smallest possible size for improved performance. Optra forms software is used for generating labels.

The presentation layer can depend on these DataSets for their data requirements for example; getAllOrders (OrderDS), getDeletedOrders(), getPrinterSettings(), getReport(report_enum), etc. A third party grid control can be .used to display dataset in flexible form and can provide facility to sort and arrange columns at run time.

Grower User Interface can contain a utility module that can be responsible for managing various configuration settings for printer module, download module and for auto update module.

A printer 14 application can be the printing machine and can provide simple interface to be used by the grower presentation layer for ex; printOrders (order named value collection by ref). This function can be responsible for getting all order related data from the DAL and can be responsible for making sure that the orders listed in the collection can be printed. It can provide the status back to the calling function for orders (printed or failure to print and in that case can provide the error message). The printer application can implement smart printing logic to print batch orders on single printer 14 or spread it across multiple printers 14 depending on batch size and the configuration settings. Printer 14 application can also use DAL (data access layer) to mark the order as being printed in appropriate table.

Maintenance application—This is an application can be used to keep entire implementation up-to-date. It can use sonic client auto update information to keep grower system in sync with most recent version available at the Administration System at 6. It can take care of updates of various application modules, database table upgrades, label (compiled styles) updates. These utilities can also provide module that can allow data archiving of historical data to keep size of main database to minimum.

Consider another embodiment and way of viewing teachings herein, with reference to a “PRVDFulfillmentSystem.” A PRVDFulfillmentSystem, is a part of an Order Fulfillment Service application at computer 12, which provides functionality of Downloading, viewing orders, Printing labels for selected orders, Generate reports on specific Orders, Purging labels and log files, downloading and installing (AutoUpgrade) of new versions of PRVDFulfillmentSystem.

This System is broadly divided in to the following components:

1. PRVDFulfillmentSystem, which is part of the grower system 12. The Main Features:

To view daily order data in customizable different forms to efficiently handle daily shipment of orders:

Allow users to select orders to change status and view those changes

Flexibility to print selected orders or subset of selected orders

Flexibility to print orders in batches

Intelligent distribution of printing job over multiple available printers.

To print useful summary reports

Log print jobs to database to allow reprints of previous print jobs

Create daily print product summary log file

Manage Configuration parameters of PRVDFulfillmentSystem

Manage (add printers, edit printers, make printer as active/inactive)

2. PRVDMessagingService

This is a window service which acts as a link between Grower and Order Fulfillment Service. Main Features:

Load growers local data store with new, updated (New Orders or Cancelled Orders)orders, Configuration parameters from Order Fulfillment Service Server

Send the confirmation of status message back to Order Fulfillment Service Server, for each successful download of orders.

3. PRVDFulfillmentSystemMaintenance

This application is responsible for doing maintenance tasks for PRVDFulfillmentSystem Main Features:

Automatic upgrades of the PRVDFulfillmentSystem from Order Fulfillment Service server

Ability to purge database backup files, log files (label data text files and print product summary log files) older than specified days.

By way of a general description:

PRVDMessagingService application is a windows service running a .NET remoting server in SingleCall/Server Activated object mode. This service also launches the JMS client from its Domain. JMS client is nothing but a Java Message Service that connects to Order Fulfillment Service server on tcp/ssl. Once a order arrives in the server queue to which JMS is connected to, it gets notified and the JMS looks into the header of the message. If the message satisfies the pre-defined criteria (daysout), it gets the body of the message and sends it to .NET Remoting on http/soap protocol. .NET remoting server inserts this order information/config information into the data store and returns a acknowledgement to the JMS client. On successful receipt of the acknowledgement, the JMS client acknowledges the server queue and also sends a status message back to the Status queue. All the parameters for running this service can be taken from grower's Configuration and JMS config file.

PRVDFulfillmentSystem can process and print orders, once the data reached in Grower data store (GrowerDistributionCenter). This system includes an Order display Component (with paging On/Off) which display all non-deleted orders available for different shipdates. The shipdates are generated based on configuration table parameters namely DaysBack and DaysForward. Order Summary grid, used to show a summary of orders on PRVDFulfillmentSystem. The latest orders downloaded is displaying by Ticker control. The user is able to change Configuration table entries by using configuration. Search is provided on PRVDFulfillmentSystem, to search for Orders based on different criteria. This system generates reports for specific Orders based on Products, Accessories, Deleted orders and PrintSummary.

For printing labels, the user accesses a PRVDFulfillmentSystem UI and selects those orders he/she wish to print. The user can also choose a subset of selected orders, to print. The printing of labels is implemented for two main shippers of PRVDFulfillmentSystem, namely FedEx and UPS. Orders to be print can be distributed intelligently to available printers or print can be done on default active printer(s). Product Summary report can also print along with Label printing. Reprinting of labels are implemented in Print Summary Report

PRVDFulfillmentSystemMaintenance, a user console, application implemented, to handle maintenance activities of PRVDFulfillmentSystem. This application looks for new version of PRVDFulfillmentSystem in Order Fulfillment Service server, download and upgrade into new version. PRVDFulfillmentSystemMaintenance handles purging of Labels and Logfiles by taking purging specific information from configuration table.

In general PRVDFulfillmentSystem can use the following third party components/libraries

Microsoft Application blocks Version 2.0.0;

Microsoft Application ExceptionManagement;

Component One Components for Windows;

Optra Forms for Label Design;

JMS Message Queue;

.NetApplication Updator Component; and

Microsoft Web Browser Control.

A maintenance function can, if desired, be used to get real time updates to the provider system, e.g., even over the same messaging stream as the orders. Update notices can also be conveyed to the provider/grower system.

PRVDMessagingService can:

Download supplier data using specific JMS Queue; and

Store downloaded data into Grower data store, GrowerDistributionCenter (SqlServer).

PRVDFulfillmentSystem can:

Display (view) all orders except those marked as ‘deleted’ over a date range;

Group data by day/product/Carrier/Sort//Service Type/Accessories/status (new/updated/printed);

Search Orders (Product Name, OrderID, Tracking Number, Order Status) for matching records that starts with search string from database;

Mark Order ( as new, printed , hold);

Delete Orders(Mark as deleted);

Show confirmation dialog box before deleting the orders;

Change the status as ‘Deleted’ and remove those orders from the Grid;

Performance consideration—should be able to handle about 100K orders for given days span. (Number of days to display should read from Configuration);

Ability to generate following reports over specified date range:
Products shipped;
Accessories shipped;
Deleted orders;
Products/Shipper/Region;
Future products report (data Can be available at the Order Fulfillment Service server, and need to show in a web page);
Future Accessories report (data Can be available at the Order Fulfillment Service server, and need to show in a web page);

Capability to print/export reports and product summary data;

Capability to print single order/selected orders/selected product(s);

Capability to print top pre-specified orders from large selections;

Configuration setup;

Option to choose printer for selection;

Option to use default mechanism;

Form printing;

Single Form printing;

Group/batch printing;

Capability to print on specified printer;

Smart printing—spread printing job over multiple printers for large group printing;

Printing product summary log per day;

Printer log should contain job id assigned by the printer for each label;

Log all activities, which happens on the specific printers during the day;

Save key information of given printer job to database;

Design new/modify labels and datamap for UPS;

PRVDFulfillmentSystemMaintenance can:

Purging of log files (label data text files and print product summary log files) and db files;

Purging of database; and

Back-up of the database.

The following describes details of design of the PRVDFulfillmentSystem with the help of Use Cases, Sequence diagrams, and Class diagrams in the Figures.

PRVDMessagingService is an application that acts as a link between the Grower and Order Fulfillment Service. This application is responsible for downloading data from the Order Fulfillment Service system using JMS Queue architecture and it's service.

This application can have the following.

Downloads supplier specific data using JMS Queue;

Stores downloaded data into local data store (SqlServer);

Reports any exceptions, and exception details, encountered when attempting to receive and store order data and put the order in error status within the server side database; and

Reports any exceptions encountered when attempting to request order data (time, data sent in attempting to get orders). For instance, not able to connect to the server side to download orders.

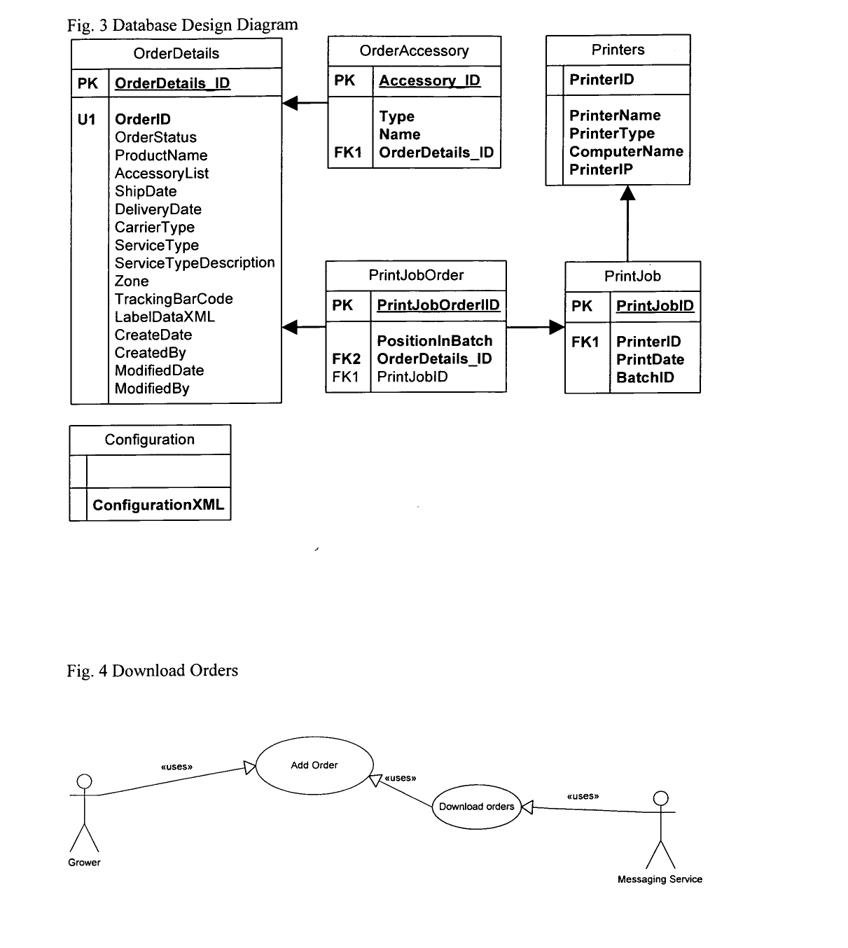

As to the flow, when the PRVDMessagingService.exe is executed, its initialization process connects to the Order Fulfillment Service System, and after connection is established, PRVDMessagingService is ready to download the orders. As soon as connection is established, a Receiver function is invoked. This function has one parameter as a callback function of the PRVDMessagingService. A receiver function can look in to the JMS Message queue for the new message. If it finds new message (there are separate queue for each Grower and it is identified by the Queue Name, application can get the Queue name from the db) it can pass the message to the callback function. All messages can be processed asynchronously and callback function can be called by spawning a new thread from the thread pool. Because a message contains the dataset (string version of the dataset in xml doc format), this callback function can process the message and insert the data into the grower db (GrowerDistributionCenter). Once the data update is successful, PRVDMessagingService can call a Sender function with new dataset for status update. The Sender can place the message in Status message queue for status update. The above process continues for each order downloaded. See FIGS. 3-4 for Download Orders.

PRVDFulfillmentSystem is the main application and has a UI and the following:

Grid for Displaying Orders;

Paging for showing certain number of records on Grid;

Previous and Next links for Navigating between Pages;

Tabs for selecting Dates (Number of tabs created based on Daysback and DaysForward in configuration);

Search functionality for searching orders from the database;

Find Button functionality finding specific orders from the Database;

Delete functionality for deleting Orders;

Print functionality for printing labels and reports; and

Configuration functionality for configuring printer and other settings.

As to the flow, when PRVDFulfillmentSystem.exe executes, the user is presented with a screen and is shown the grid with dynamically created tabpages (gets Daysback and DaysForward from Configuration and generating tabpages) with a tab heading. For example, Date for selecting the date, and by default focus can be on the today's date, and data can be populated from the local database. All other tabs data can be populated when user selects/clicks the respective tabs. Paging is also allowed on the grid, and the user can navigate between pages using navigation (Previous and Next links) buttons.

The user clicks on any one of the Tabs to view data for that date. The Application looks into the local data store and loads the data for the selected tab for that tab's date. If data is found then application retrieves the Order data(Active orders) from the db for the selected date and displays to the user.

PRVDMessagingService (which includes the JMS client) can be running 24×7 so that whenever there is new data, the data can be downloaded to the PRVDFulfillmentSystem. When Order data has been loaded, user is able to:

Group data by Product/Carrier/Sort/ServiceType/Accessory;

Display Criteria for new/updated/printed/Hold orders;

View includes Product, Accessory, carrier, service level, and sort, ordered columns;

Find the particular order using a Search;

Mark the orders for Printing/Deleting/New/Hold;

Print/export reports and print product summary data;

Print Labels for single order/selected orders/selected product(s);

Print top pre-specified orders from large selections (allow block selections from the group views);

Delete orders (a confirmation can be taken before deleting the Order);

Order management i.e., the application displays the counts of unprinted orders(New/Updated), orders on hold and Printed orders;

Prepare counts for all orders whose shipdate is within the selected day should display order totals (unprinted orders, hold orders, printed orders, and total orders);

Count for unprinted, hold, printed and total counts of orders are displayed for each viewable taxonomy level;

Refresh the orders within the order taxonomy to see new orders and also it maintain it's state or structure;

Export reports to Microsoft Excel in a readable format;

Print reports grid;

Mark individual orders or a group of orders as New, Printed and OnHold;

When orders are being viewed in an expanded view in terms of the taxonomy, if there are duplicate counts shown, it should be apparent which order totals are being counted toward the overall total;

Reprint labels from printsummarygid, which displays Summary of orders for selected date ranges;

The ticker control, displays orders downloaded after last refresh, indirectly remind user to refresh grid to see latest data;

User can define (set) colwidths for each columns displaying on grid by resizing columns; and

Search (Like Search) orders based on Product Name/OrderID/Status/Tracking Number.

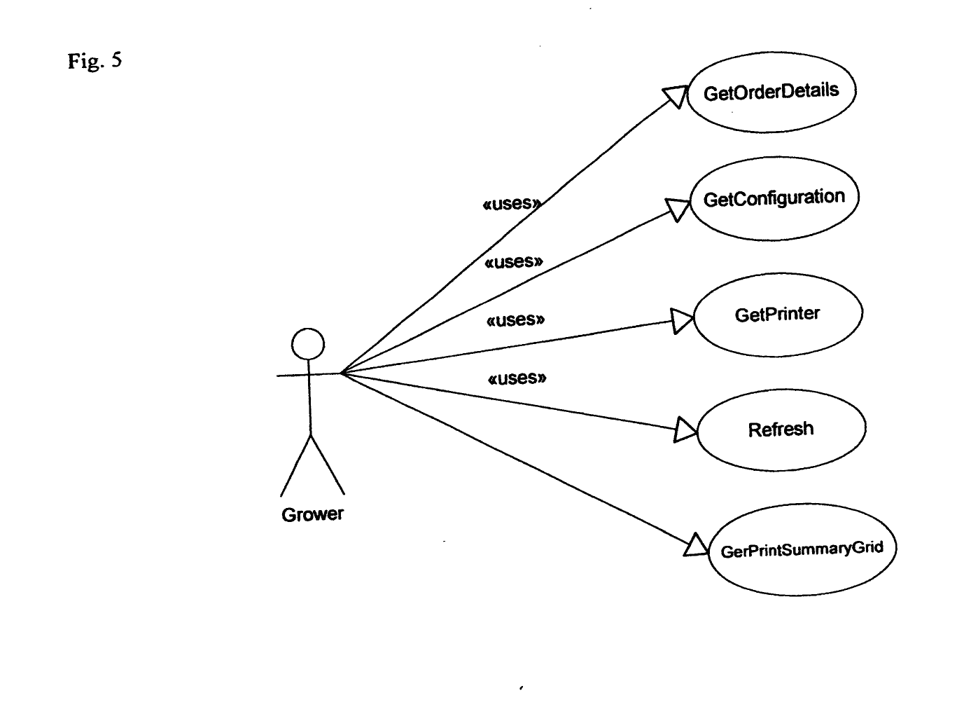

See FIG. 5.

To get order details, GetOrderDetails retrieves orders for a specific date from local datastore and does following:

Display Orders;

Shows Summaries (Subtotals) on orders;

Shows certain number of records on page and navigation buttons for pages (based on paging is on/off in configuration); and

Merge columns (based on merging is on/off in configuration).

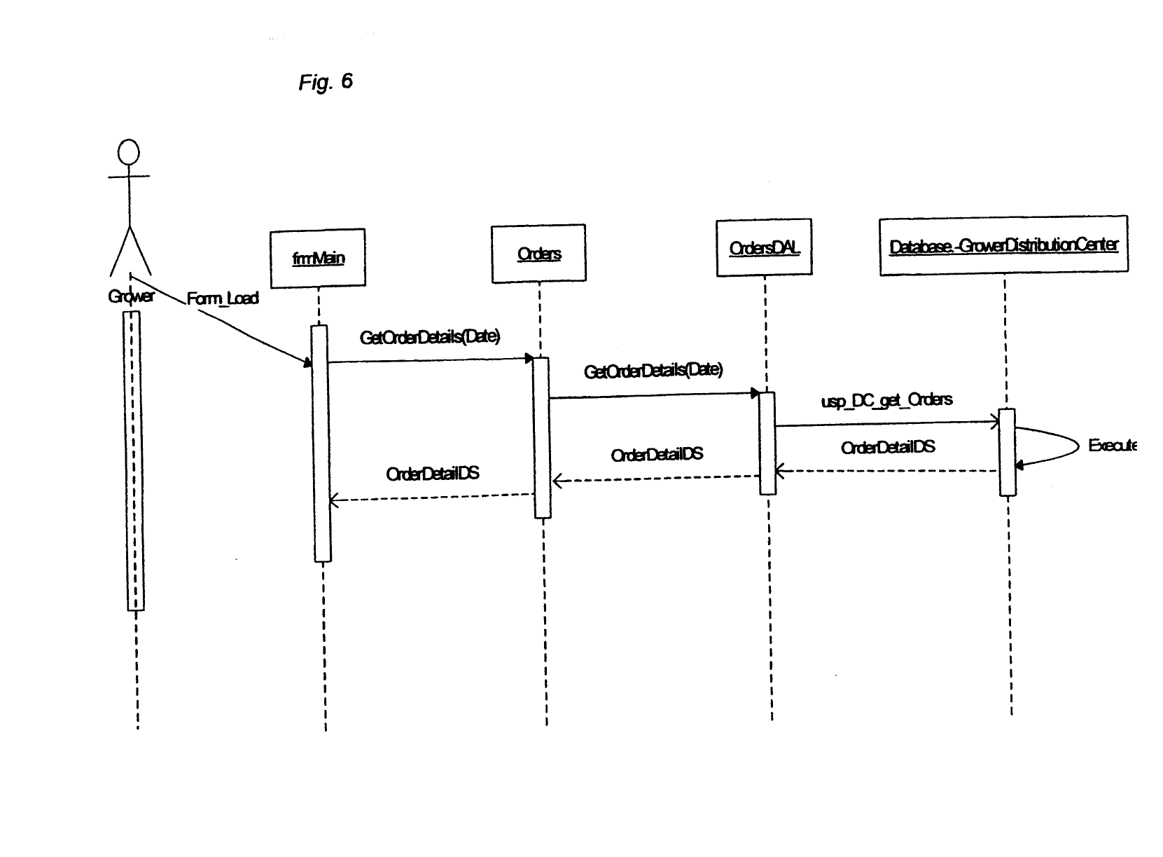

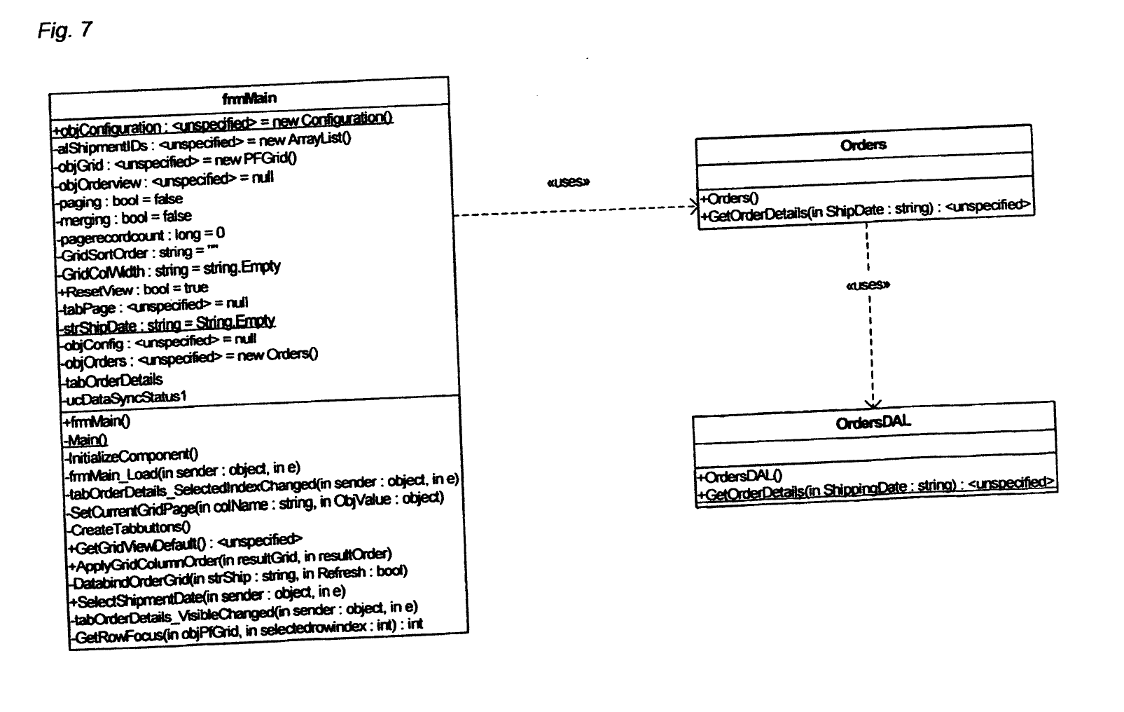

See FIGS. 6-7.

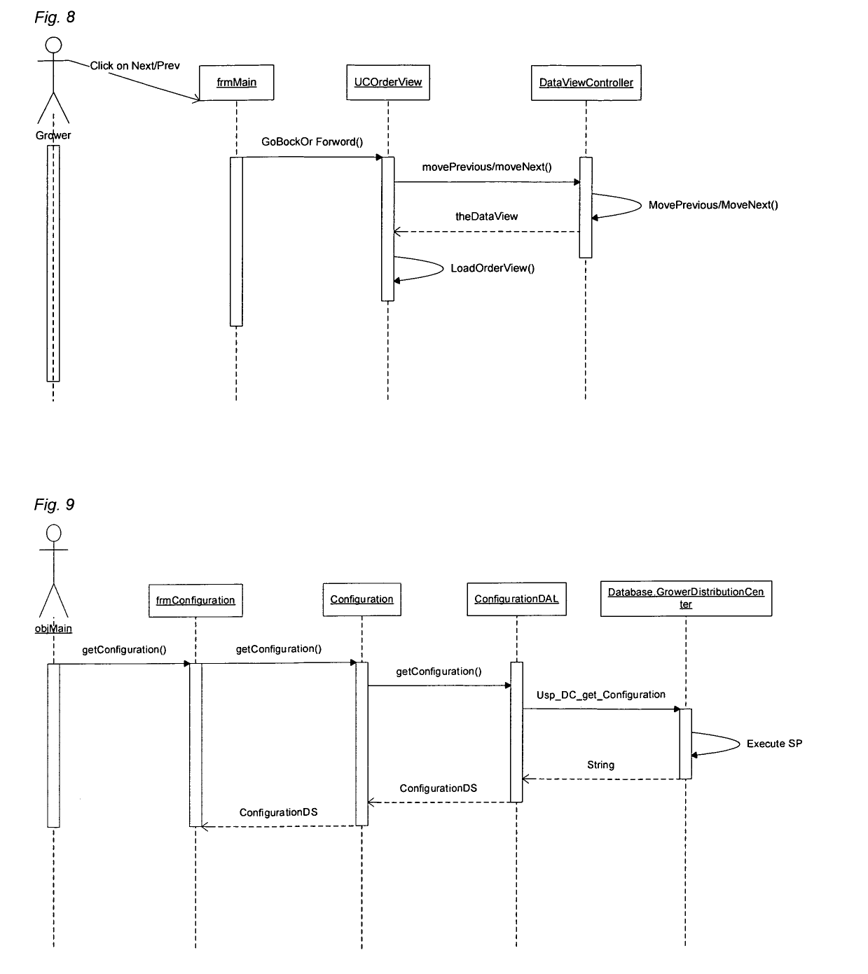

Paging Description: Allows paging on Grid if user set Allowpaging is true in Configuration. Paging shows Link buttons to navigate between pages. See FIG. 8.

Get Configuration Description: GetConfiguration, retrieves Configuration details for PRVDFulfillmentSystem from local datastore. This information defines: PRVDFulfillmentSystem's UI settings such as:
Number of tabs in order grid;
Paging and page record count; and
Allow merging.

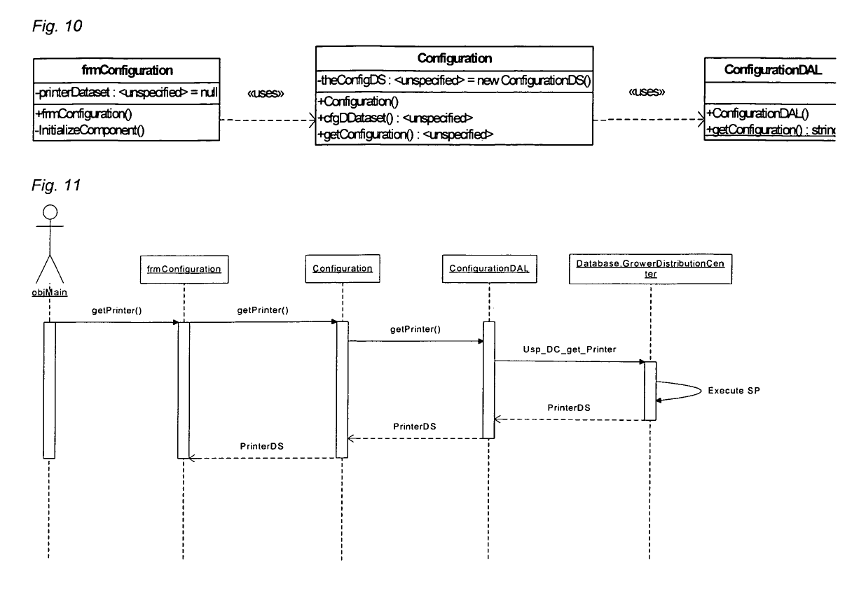

Consider now information used for printing (Last PrintJobID, Label information, etc.) Information used for purging files, Futurereports, Messaging Service, etc. See FIGS. 9-10.

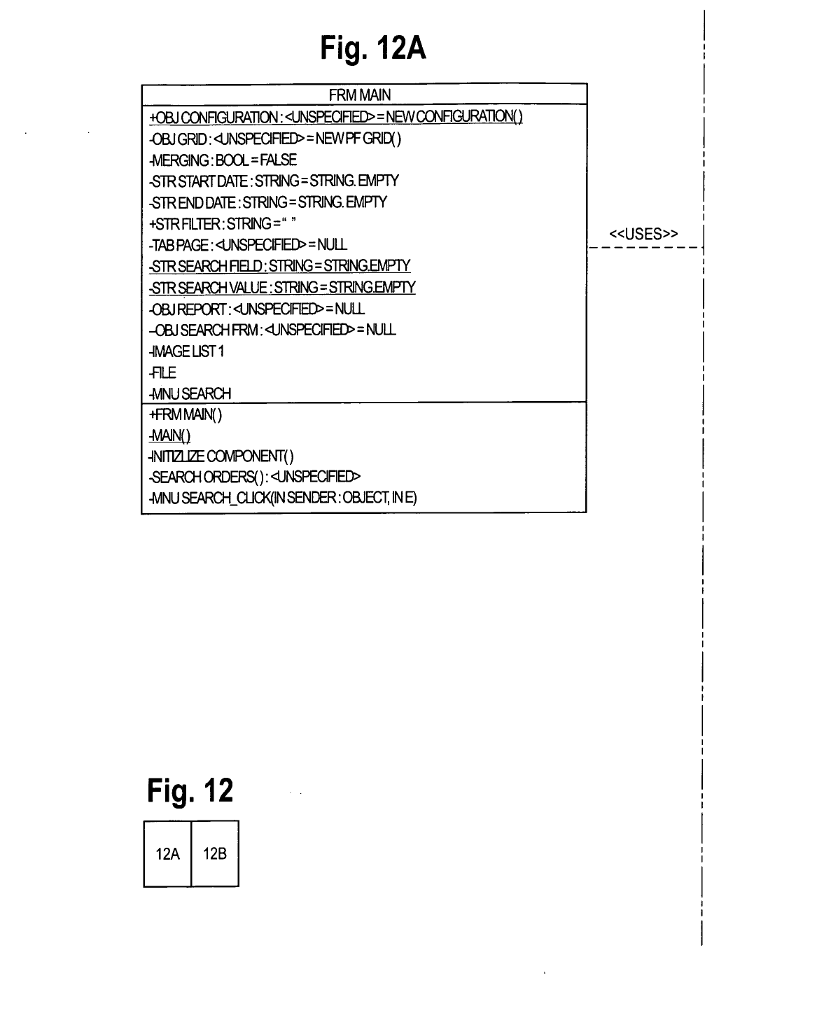

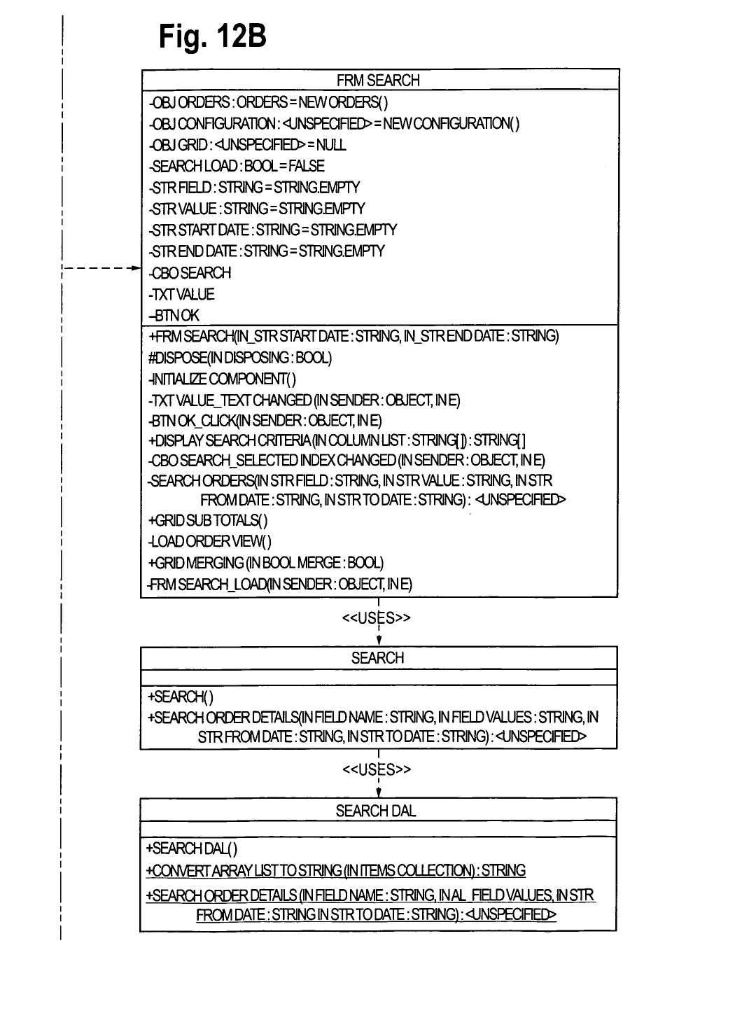

Get Printer Description: GetPrinter, retrieves Printer details from local datastore. This information used in Printer Grid on Configuration UI. To display printer details, for editing printer details such as selecting(marking) Report/Label printer, make status of printer active/inactive, etc. See FIGS. 11-12.

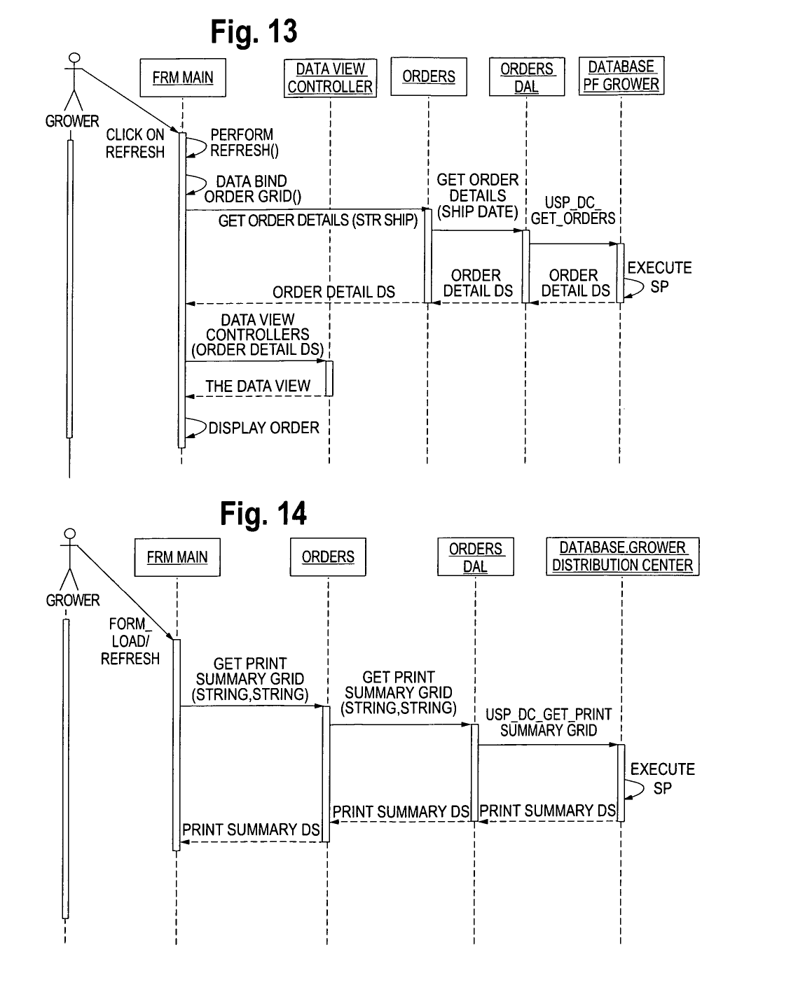

Refresh Description: Refresh can take latest data from local datastore, for the displaying order grid or report and printsummary grid. See FIG. 13.

GetPrintSummaryGrid Description: GetPrintSummaryGrid, gets order summary details for selected tab ship dates, from local data store. GetPrintSummaryGrid gives summary information of following order types:

New;

Updated;

Printed; and

Deleted.

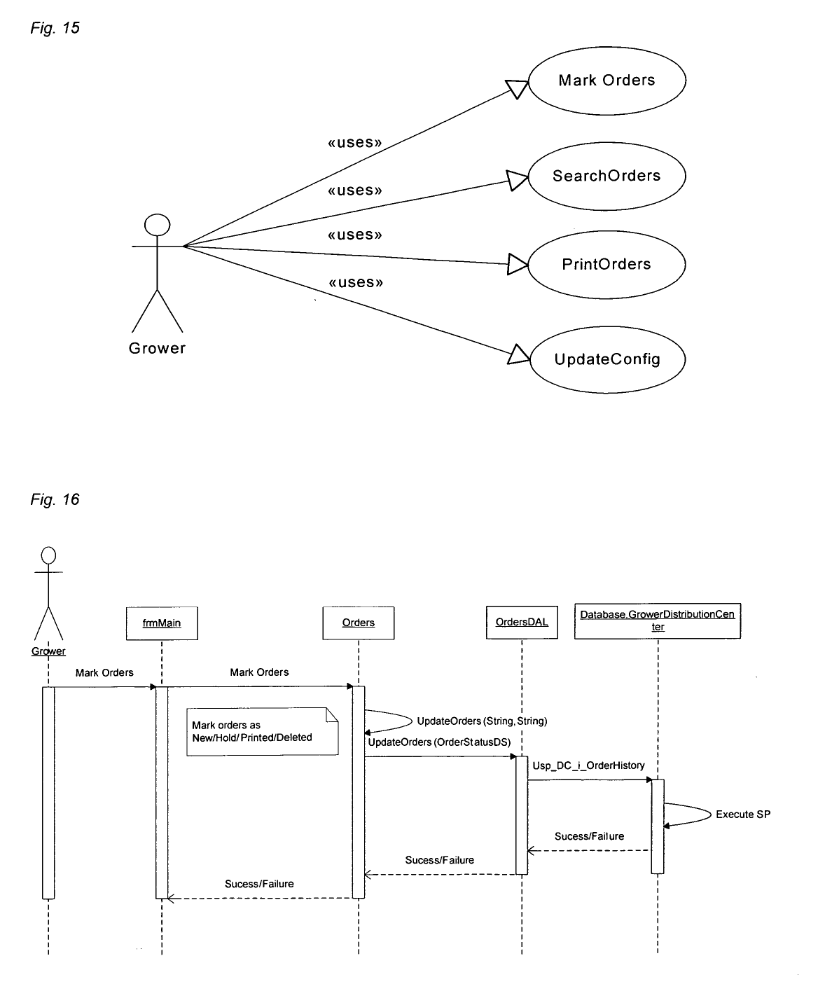

See FIGS. 14-15.

Mark Orders Description: Mark Orders, changes status of selected order(s) in UI and local datastore. Mark Orders can change following status of orders in PRVDFulfillmentSystem:

New;

Hold;

Printed; and

Deleted.

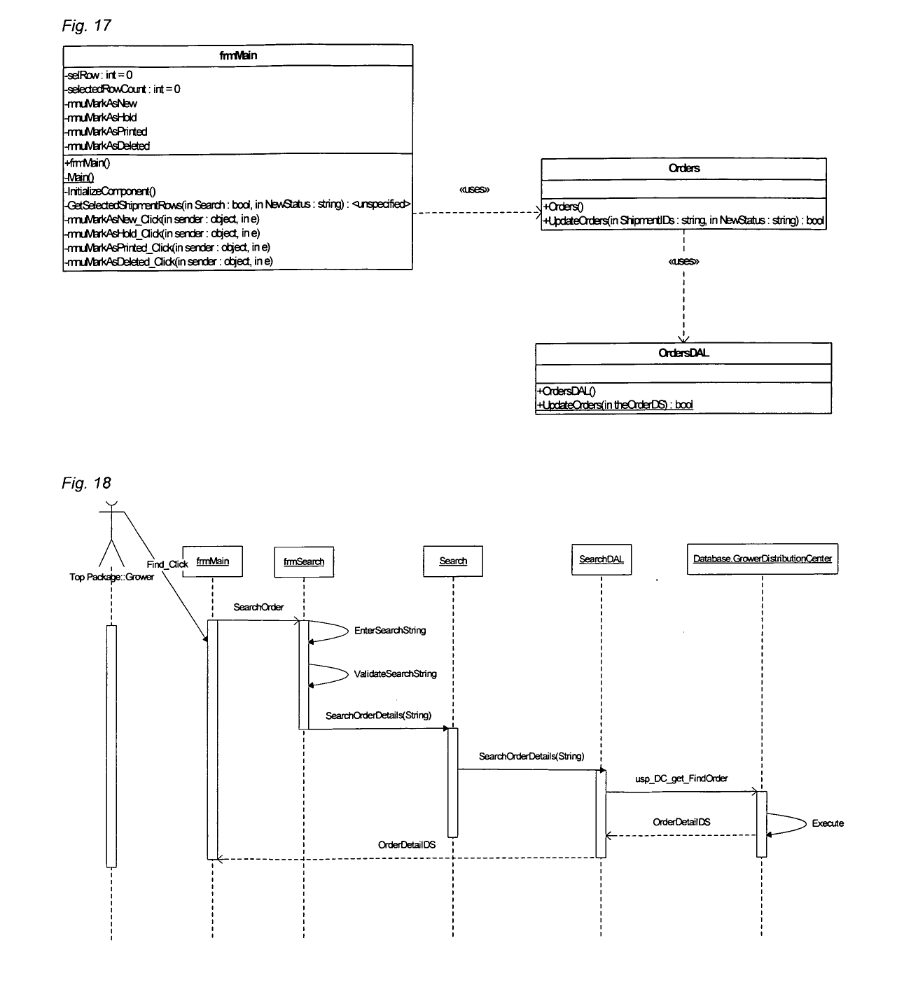

See FIGS. 16-17.

Search orders Description: Search Orders, search order(s) on local datastore and populates in search UI. Search orders uses search criteria and value for doing search. Search criteria for search as follows:

Product Name;

OrderID;

Tracking Number;

Order Status;

See FIG. 18.

Print Orders Description: This is the class responsible for printing selected orders and reports. PrintOrders does following tasks:

Form printing;

Single Form printing;

Group/batch printing;

Print on specified printer;

Smart printing—spread printing job over multiple printers for large group printing;

Create print product summary log per day; and

Save logs by day with a visually recognizable date with standard format like “printproductsummary_date.log” for e.g.: PrintSummary_{—}10-27-04.log As to the flow, when a user wants to print orders:

List of configured printer is retrieved from the database and shown to user specific to Report and Labels;

User selects one of the printer from the list; and

Reports can be printed by sending proper data to the report printer.

In case of Labels, files can be uploaded to the printer using print spooler and then printer prints the labels. Label Printing:

Collect all details of selected orders from the order/order details and create a formatted text file for each batch; and

Save this file with unique name with standard format like: “JobID_PrinterName_BatchID.txt” for e.g.: 50_Lexmark T632_{—}3.txt and stored in specified location, which is taken from database.

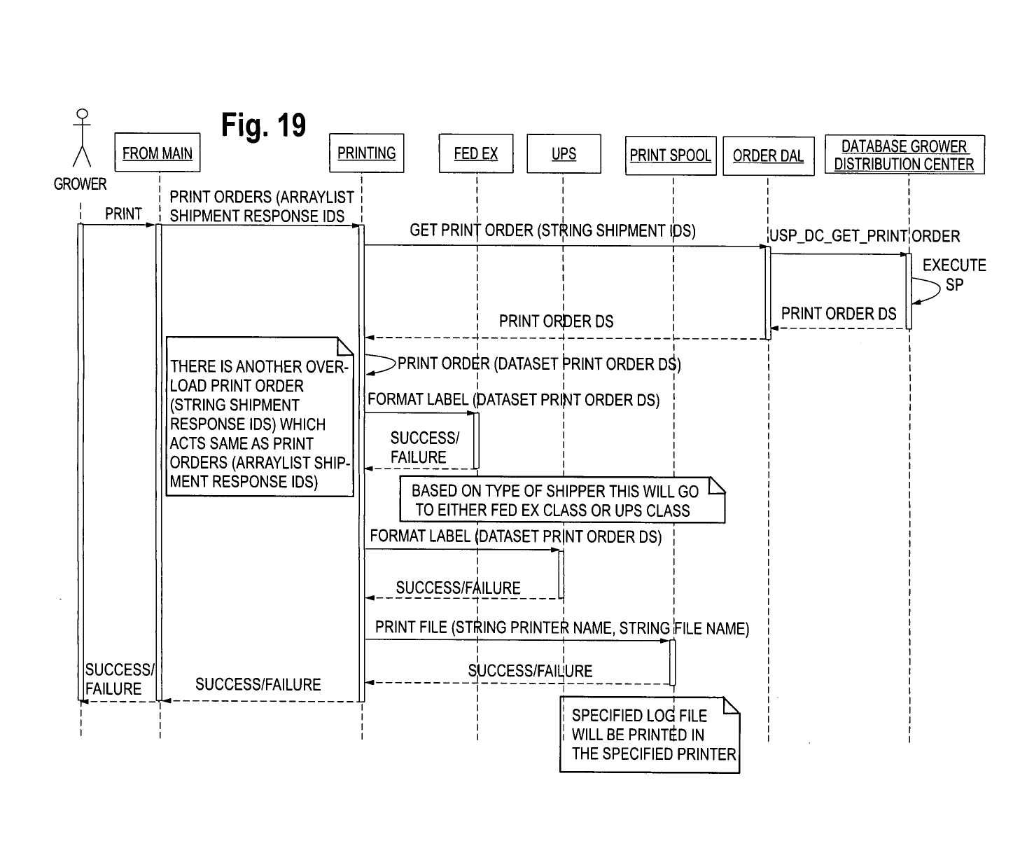

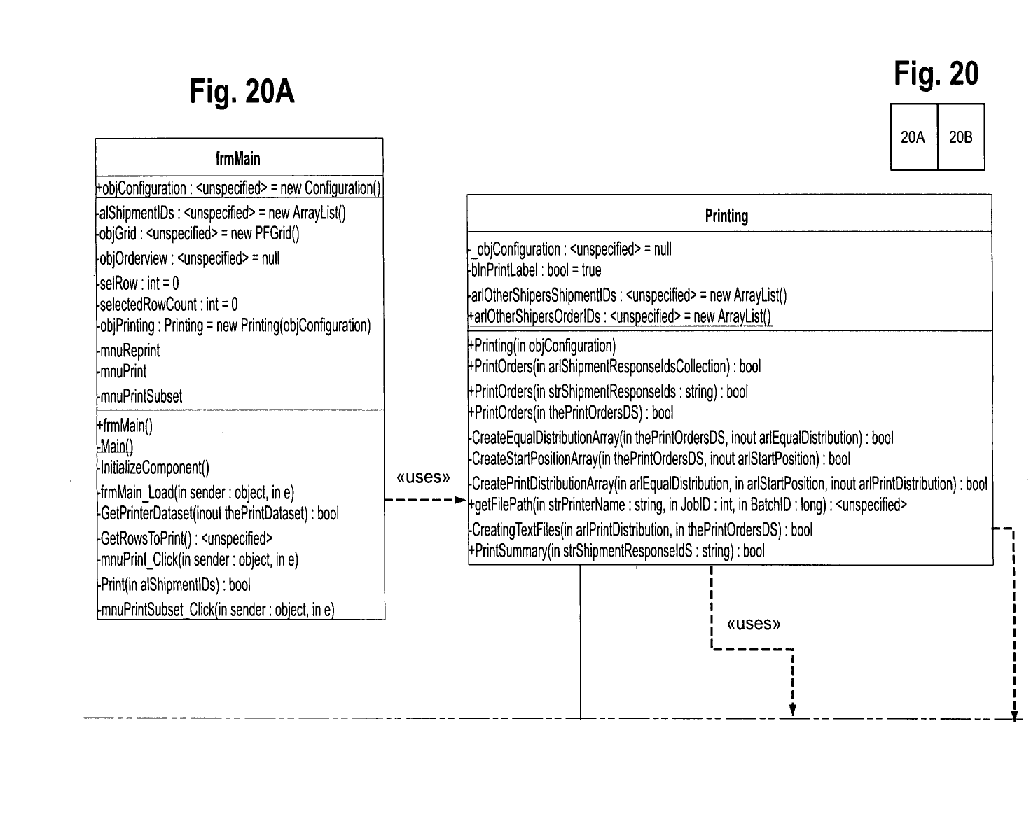

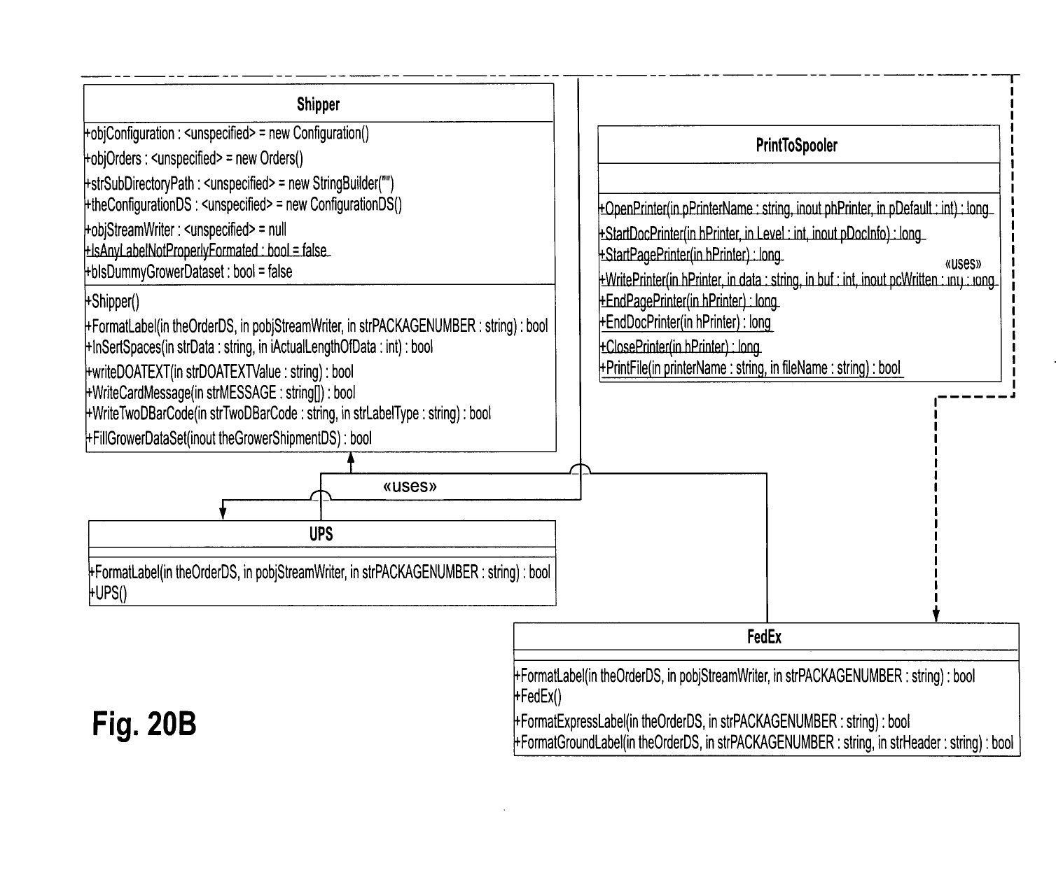

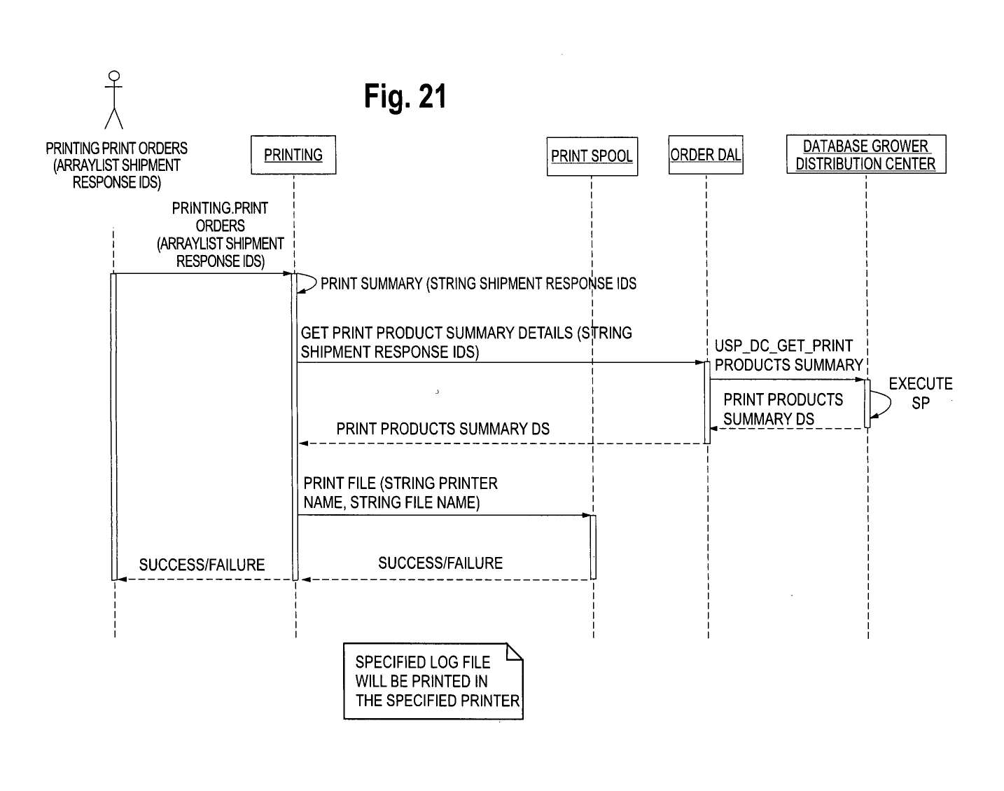

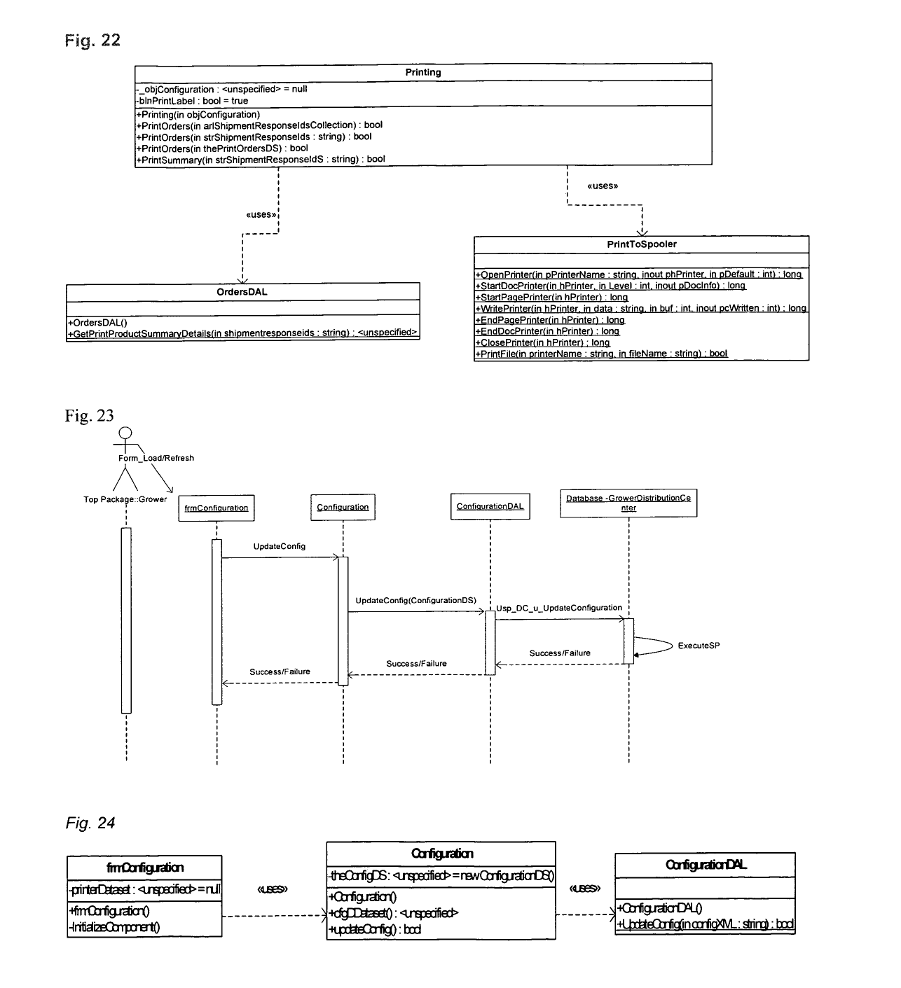

There can be 3 folders: one is for Database Backups, one for Label text files, and another is for print product summary details. A Label folder can have folders with dates in which generated text files can be stored. Upload this file using print spooler to e.g., a Lexmark printer to print the labels. With regard to Distribution of Order printing on the various printers, printing of labels is called a job and every job is divided in to several batches. See FIGS. 19-20. With regard to Create Print Product Summary Log File per day, see FIGS. 21-22.

Update Configuration: Update Configuration, updates configuration details in local datastore. See FIGS. 23-24.

Update Printer: Update printer, updates printer details local datastore. Update printer, updates printer details in following cases:

When a new printer added; and

When a change is done in existing printer.

With regard to the flow, a user can configure following:

1. Add Printer to Print table from OS: Update Printer (by clicking on Save button) when a user clicks on the Printer Configuration Button/Menu on the PRVDFulfillmentSystem.

2. Add Printers For Label and(or) Report:

Display all available printers (from OS) to grower, Grower picks one from the list and marks that as a label or report printer:

Mark printer as Active or inactive

Mark that printer as a default printer (optional) for selected type (report/label). (User can select only one default printer for reports and one default printer for labels, marking a printer as default can remove default flag from previously marked default printer.)

3. Update Printer information in local data store

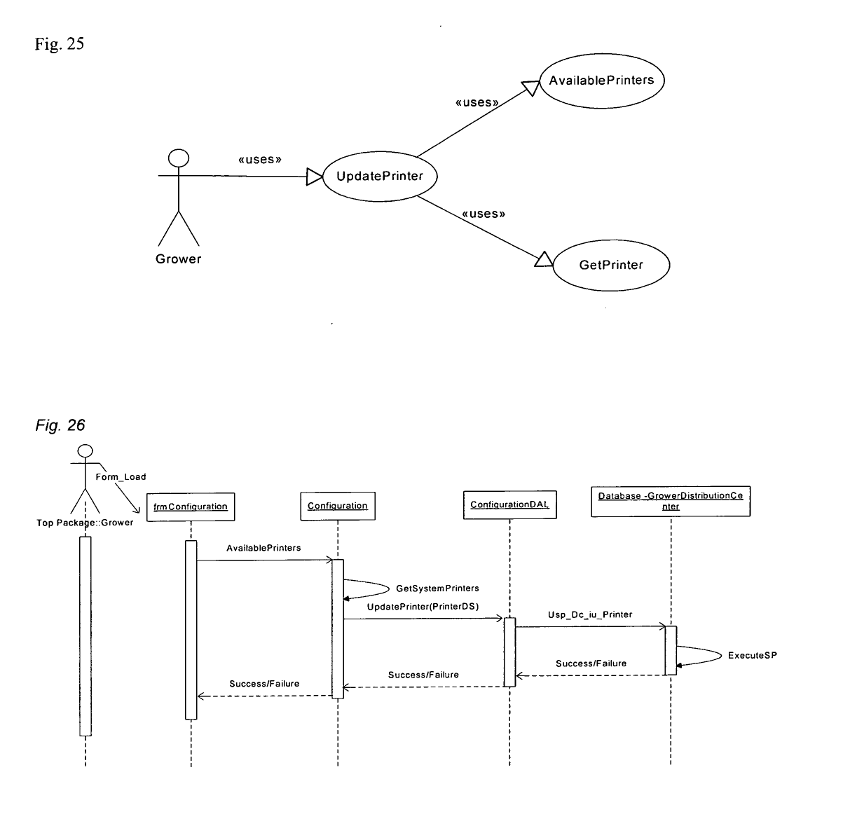

See FIGS. 25-26.

Reports: PRVDFulfillmentSystem uses following reports to display order specific information to users.

1. Order Reports

Products;

Accessories;

Deleted Orders; and

Print Summary Orders.

2. Future Order Reports

Future Accessories; and

Future Products.

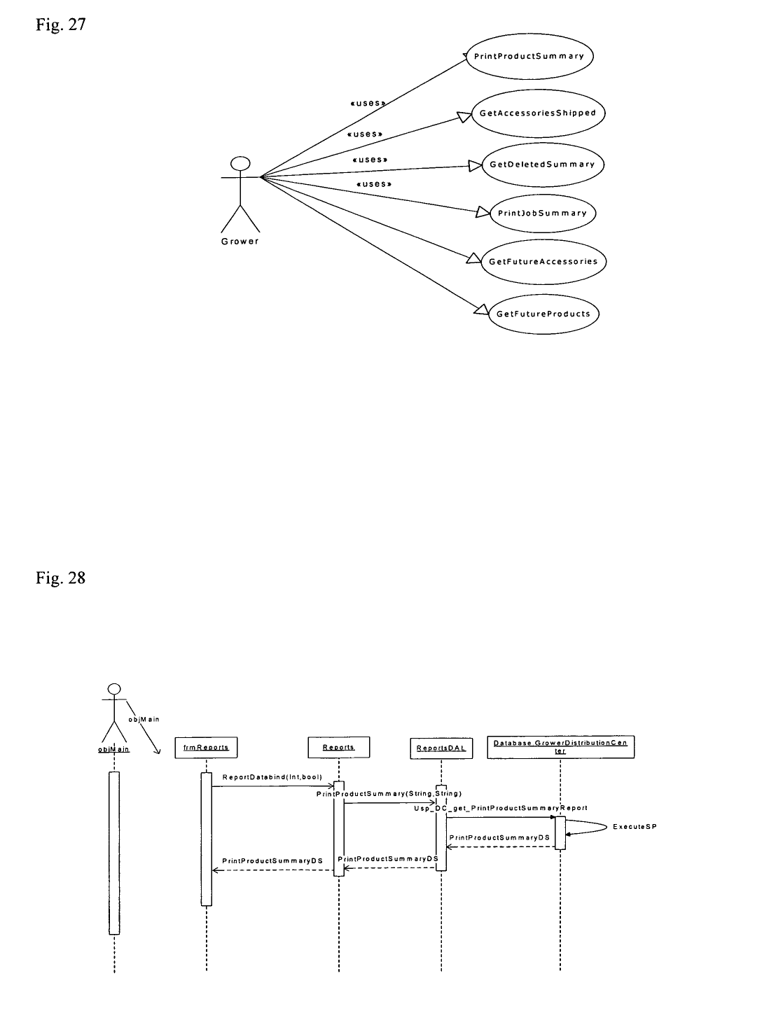

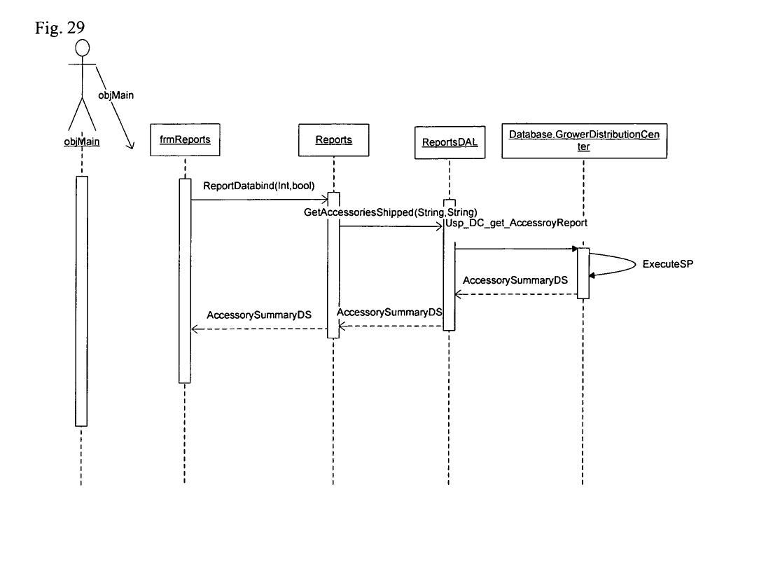

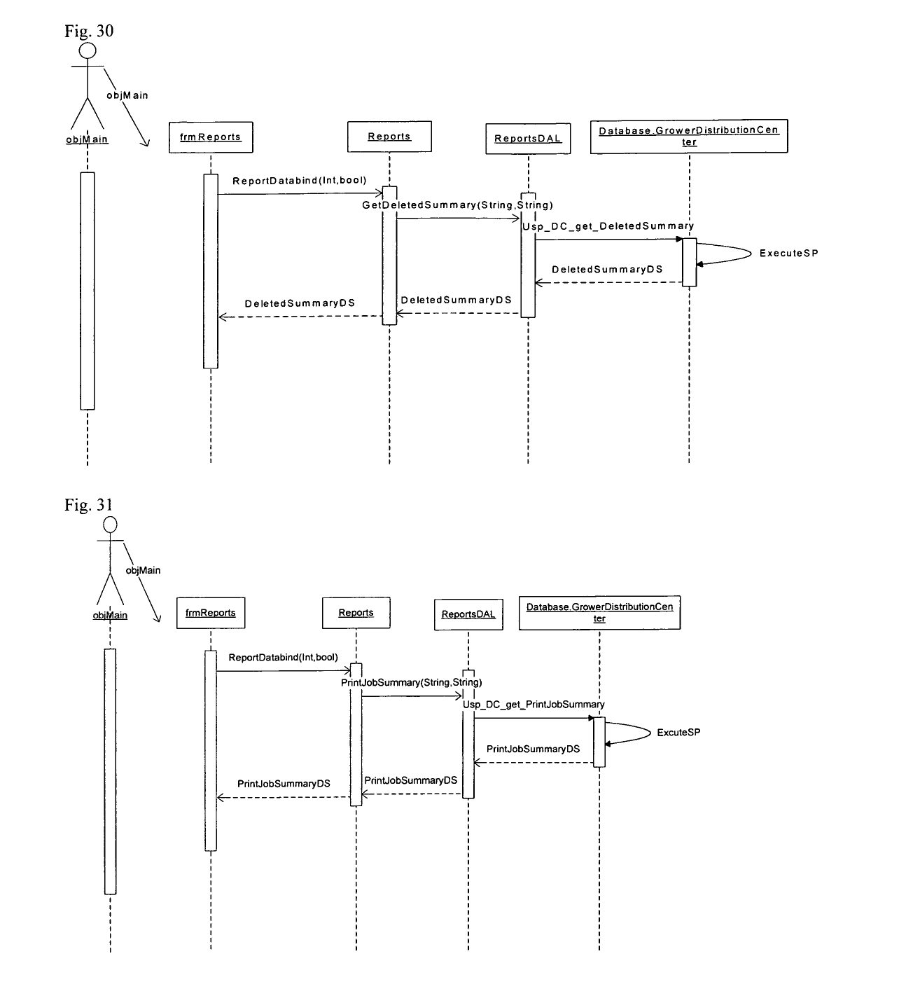

See FIGS. 27-30 regarding this and Products, Accessories, Deleted Orders, and Print Summary Orders.

On reports, the user can:

ExportToExcel;

User can export the report data to an excel file; and

Print.

The user can print report grid as it views to users:

Reprint (only for Print Summary Report); and

User can print labels(already printed) from PrintSummaryReport, by choosing Reprint option. Reprint, make use of Printorders, for printing labels.

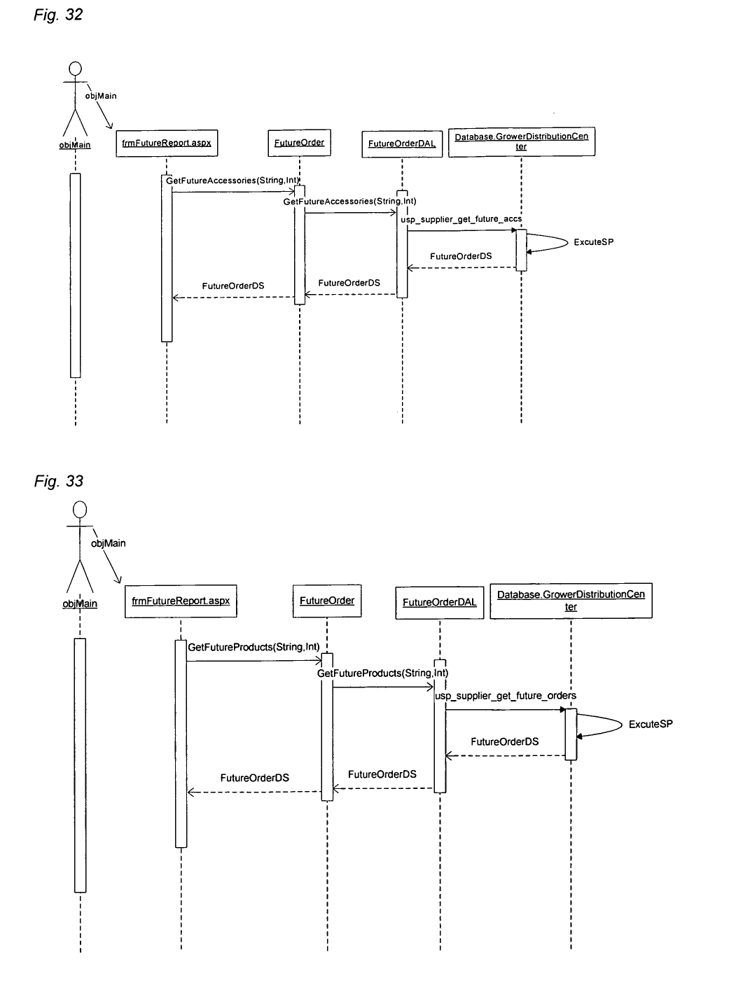

A Future Accessories Report shows Future accessories for a specific grower, for a given number of days (this value reads from Configuration): Shows Future products for a specific grower, for a given number of days(this value reads from Configuration). See FIGS. 31-33.

PRVDFulfillmentSystemMaintenance: These are separate exes which execute in scheduled time, e.g., automatic upgrades of the PRVDFulfillmentSystem software from Order Fulfillment Service system.

This concerns an ability to purge label files, log files (label data text files and print product summary log files) older than specified days for both database base files and log files. This is an exe, which can be scheduled to run daily or periodically. It takes the specified days for both database base files and log files form the database and purges all database backup files, log files (label data text files and Print product summary log files) created older than specified days for both database base files and log files in specified location, which is taken from database.

As to the flow, in scheduled time it performs the following.

1. Takes specified days from the database for label data text files and Print product summary log files and also takes the location of these files from database;

2. Purges all folders (which consists label data text files) whose created date is older then the specified days, which is taken from database; and

3. Purges all print product summary files whose created date is older than the specified days, which is taken from database.

Consider now a representative functional perspective of a specification embodiment.

The grower system 12 gets order information from a Order Fulfillment Service system at 6 and stores the information in a local data store. The grower system 12 allows the grower to view these orders in different groups and different sort order. Then the grower can select set of orders and print them. The printing will be distributed across printers based on intelligent routing.

The grower system 12 allows configuring printers (adding or removing), setting defaults, setting default views, etc., and does data archiving and cleaning up operation on a pre-defined interval.

In an embodiment, there can be a Grower module:

Ability to display data over a date range grouped by day;

Group data by product/carrier/region(sort)/status (new/updated/printed);

Performance consideration—should be able to handle about 100K orders for 7 day span;

Capability to download data on demand;

Ability to generate following reports over specified date range:
Products shipped;
Accessories shipped;
Deleted orders;
Products/Shipper/Region;
Future products—may be by shipper/region; and
Future Accessories;

Capability to print/export reports and product summary data;

Capability to print singe order/selected orders/selected product(s);

Capability to print top pre-specified orders from large selections;

Capability to print batch of orders scanned via bar code scanner;

Option to choose printer for selection or go with default mechanism;

Order—search, delete, mark as new or printed;

Configuration setup;

There can be a Printing module:

Single form printing;

Group/batch printing;

Capability to print on specified printer;

Smart printing—spread printing job over multiple printers for large group printing;

Printing log per day/printer;

Printer log should contain job id assigned by the printer for each label.

Design new labels and datamap; and

Printer configuration settings.

There can be a Download module:

Download supplier specific data from Order Fulfillment Service system;

Change status of this order as downloaded at the Order Fulfillment Service system;

Store downloaded order data into local datastore;

Store/Merge configuration information; and

Invoke maintenance module for upgrade/rollback.

There can be a Maintenance module:

Archiving the old data (older than predefined number of days);

Cleaning up/Remove the old files (older than predefined number of days); and

Upgrades of the grower application need to be downloaded from the Order Fulfillment Service system at 6 and installed at the Grower system 12 and the user presented with the option to use new version.

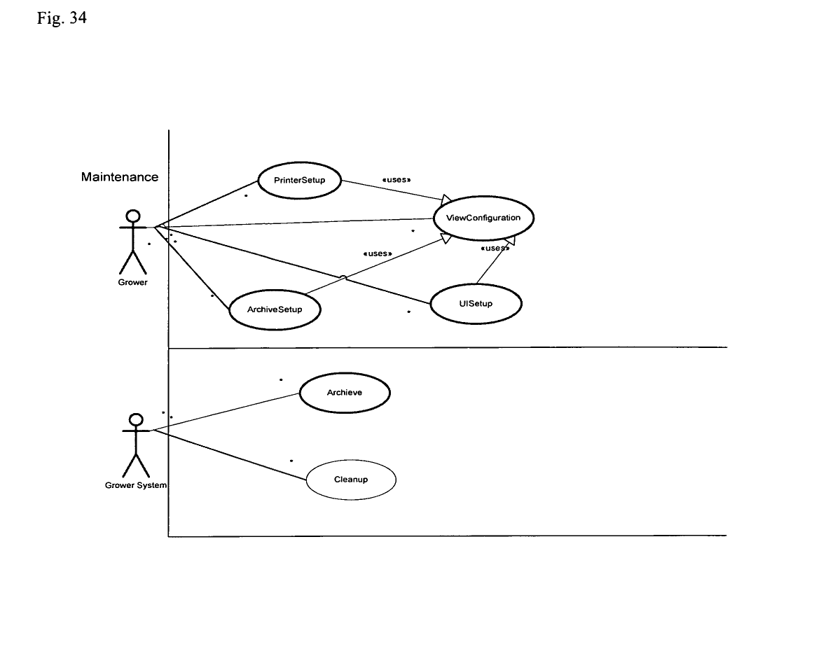

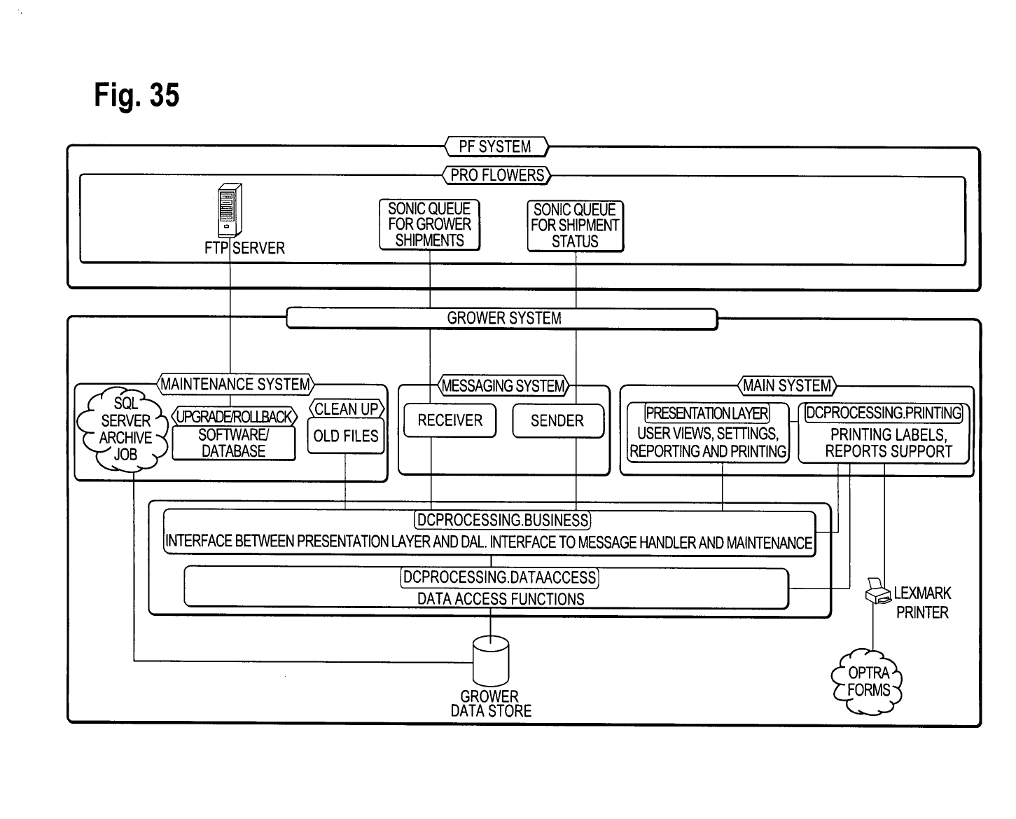

For a Use Case diagram covering most cases, see FIGS. 34-35.

Use Case DownloadOrder: The Grower system 12 downloads orders to process them, preferably in an automated way, using a connection between Grower system 12 and the Order Fulfillment Service system at 6, e.g., at least in part over a wide area network, such as the Internet.

Use Case Post-conditions:

1. Orders saved to Grower data store; and

2. Order status updated on Order Fulfillment Service system at 6.

Scenario:

Primary Actor: Grower system 12 and Order Fulfillment Service system at 6

1. Order Fulfillment Service system at 6 sends the orders to the Grower system 12;

2. Grower system 12saves orders to local data store;

3. Grower system 12sends the status to Order Fulfillment Service system at 6; and

4. Order Fulfillment Service system at 6 updates status.

Use Case DownloadConfiguration: The Order Fulfillment Service System at 6 sends the configuration information to the Grower system 12.

Use Case Pre-conditions:

1. Connection between Grower system 12 and Order Fulfillment Service system at 6.

Use Case Post-conditions:

1. Configuration information saved to Grower data store.

Scenario:

Primary Actor: Grower system 12 and Order Fulfillment Service system at 6;

Order Fulfillment Service system at 6 sends the configuration information to the Grower system 12; and

Grower system 12 saves to local data store.

Use Case Upgrade/Rollback: The Order Fulfillment Service System at 6 sends the Upgrade/Rollback information to the Grower system 12.

Use Case Pre-conditions:

1. Connection between Grower system 12 and Order Fulfillment Service system at 6.

Use Case Post-conditions:

1. Grower application upgraded to newer version.

Use Case Post-conditions (Alternate)

1. Grower application rolled back to older version.

Scenario:

Primary Actor: Grower system 12 and Order Fulfillment Service system at 6.

1. Order Fulfillment Service system at 6sends the upgrade information to the Grower system 12;

2. Grower system 12 downloads the upgrade of software; and

3. Grower system 12 upgrades itself to the newer version.

Scenario (Alternate):

Primary Actor: Grower system 12 and Order Fulfillment Service system at 6.

1. Order Fulfillment Service system at 6 sends the Rollback information to the Grower system 12; and

2. Grower system 12 rollsback to the older version of software. Note: This may involve manual intervention for the data rollback.

Use Case ViewOrder: the Grower can view the orders from the local data store, group and sort them based on various dates.

Scenario:

Primary Actor: Grower.

1. Grower starts the application;

2. Grower selects the date; and

3. Grower system displays all the orders for that day.

Note: as a default, today's order can be displayed when the application starts.

Use Case PrintOrder. Orders are printed on shipping labels for processing. Depending on the requirements of individual growers, orders may be sorted and separated based on criteria relevant to that grower's business

Scenario:

Primary Actor: Grower and Grower System 12.

1. Grower selects a group (one or more) orders to be printed;

2. Grower prints orders;

3. Status of orders is changed accordingly; and

4. A daily log to record all orders sent to various printers will be created and will be stored in local folder.

Note: A configuration setup can allow user to set days to retain these logs for historical purpose and all logs older than this set days will be removed by the system 12.

Use Case DeleteOrder: Grower deletes the order and it is marked as ‘deleted’ from the system.

Scenario:

Primary Actor: Grower.

1. Grower selects a group (one or more) orders to be deleted;

2. Grower deletes orders; and

3. Remove deleted orders from the display.

Note: The orders can be marked as deleted, but not actually removed from data store.

Use Case MarkOrderAsNew: Grower marks the order as new.

Scenario:

Primary Actor: Grower.

1. Grower selects a group (one or more) orders to be marked as New;

2. Status of the order is changed to New in the data store; and

3. Grower sees the new status.

Use Case MarkOrderAsPrinted: Grower marks the order as printed already.

Scenario:

Primary Actor: Grower.

1. Grower selects a group (one or more) orders to be marked as printed.

2. Status of the order is changed to Printed in the data store; and

3. Grower sees the changed status.

Use Case MarkOrderAsOnHold: Grower marks the order as OnHold (Pending some decision).

Scenario:

Primary Actor: Grower.

1. Grower selects a group (one or more) orders to be marked as On Hold;

2. Status of the order is changed to OnHold in the data store; and

3. Grower sees the changed status.

Use Case FindOrder: A user locates an order based on certain criteria such as SKU, order or Tracking number.

Scenario:

Primary Actor: Grower.

1. Grower selects to find an Order;

2. Grower System presents an input screen;

3. Grower enters selection criteria; and

4. Grower System displays order(s) that meet the criteria.

Use Case ReprintOrders: Order already marked as printed are resent to printer.

Scenario:

Primary Actor: Grower

1. Do MarkOrderAsNew use case; and

2. Do PrintOrder use case.

Alternate Scenario:

1. Grower specifies print Job identification information and range of orders in the batch; and

2. Grower System reprints the specified print job

Alternate Scenario:

1. Grower selects to run the last print job; and

2. Grower System reprints the last print job.

Use Case ScanOrder: Grower scans the labels to input the tracking number using a scanner and want to print those orders again.

Scenario:

Primary Actor: Grower.

1. Grower inputs Tracking number;

2. Grower system shows the corresponding orders; and

3. Grower prints the order.

Note: The Grower scan will result in a tracking number in another application. The user will input that Tracking number to Grower system 12.

Alternate Scenario: Use Case ViewReports

Grower selects to view various reports.

Scenario:

Primary Actor: Grower.

1. Grower selects a date;

2. Grower selects type of report to be viewed; and

3. Grower System generates and displays selected report.

Note: Reports available are Order, Accessories, Deleted orders, Furture orders/accessories and shipper reports

Scenario:

Primary Actor: Grower.

1. Grower performs ViewReports use case;

2. Grower selects to print; and

3. Grower System prints selected report on designated report printer.

Use Case ViewFutureReport:

Scenario:

Primary Actor: Grower

1. Grower selects Future report;

2. Grower system requests Order Fulfillment Service system at 6 for information;

3. Order Fulfillment Service system at 6 sends the information; and

4. Grower system 12 displays the information. Use Case PrintFutureReport

Scenario:

Primary Actor: Grower.

1. Extends ViewFutureReport;

2. Grower selects to print future report; and

3. Grower system prints the report in the designated printer.

Use Case ExportReport

Scenario:

Primary Actor: Grower.

1. Grower performs ViewReports user case;

2. Grower selects which format to export to (currently only Excel is available); and

3. Grower System exports report to format selected.

Alternate Scenario: Use Case ViewConfiguration

Grower sets client options and preferences for view, print, maintenance etc.

Scenario:

Primary Actor: Grower.

1. Grower selects Setup Configuration;

2. Grower System displays current Configuration;

3. Grower changes options to desired values;

4. Grower selects to save the configuration; and

5. Grower System saves options.

Use Case PrinterSetup: Uses ViewConfiguaration usecase.

Scenario:

Primary Actor: Grower.

1. Grower selects Setup Configuration;

2. Grower System displays current Configuration;

3. Grower adds or removes printer;

4. Grower configures the selected printer (report printer or default printer);

5. Grower selects to save the configuration; and

6. Grower System saves options.

Use Case ArchiveSetup: Uses ViewConfiguaration usecase.

Scenario:

Primary Actor: Grower.

1. Grower selects Setup Configuration;

2. Grower System displays current Configuration;

3. Grower set up archive parameters;

4. Grower selects to save the configuration; and

5. Grower System saves options.

Use Case UISetup: Uses ViewConfiguaration usecase.

Scenario:

Primary Actor: Grower.

1. Grower selects Setup Configuration;

2. Grower System displays current Configuration;

3. Grower set up UI related parameters;

4. Grower selects to save the configuration; and

5. Grower System saves options.

Use Case Archive: Grower system 12 does the archiving of old data

Scenario:

Primary Actor: Grower System 12.

1. Grower System 12 checks the archive information; and

2. Grower System 12 does the archiving operation.

Use Case CleanUp: Grower system 12 clean up the old files older than pre-defined date.

Scenario:

Primary Actor: Grower System.

1. Grower System checks the Cleanup information; and

2. Grower System deletes the old files created for printing purpose.

Consider now, network security and system(s) security. Authentication and encryption may be used for communication with Order Fulfillment Service system at 6. As to customer or purchaser information security and privacy, the grower application should support two levels of security. One to cater to regular users and the other to address needs for admin users. The admin user will have rights to manipulate data from the db tables to troubleshoot problems. The regular users on the other hand will have access to db via application only.

Optionally, consideration can be given to non-functional aspects, such as performance, third party integration, etc. The performance for the grower application is noteworthy for peak period operations. Downloading orders to grower application UI can be evaluated for performance when there are around 300K orders in the system 12. The expected performance should be close to 5 sec.

Printing of orders to printer 14 in large batch can also be used for proper support during peak period. It is wise in most embodiments to ensure fast performance to upload orders to printers, and it can also be wise to utilize intelligent distribution of orders across printer 14, e.g., to maintain integrity of a wave of orders, and in defining the wave, e.g., with a sort or other mode of detection.

Note, in addressing reports on future orders/accessories—one approach is to provide a web interface that talks extracts the results from order and fulfillment data stores.

Turn now to consideration of a representative framework to be used for implementing some or all of the functionality described herein.

There can be, as mentioned above, four major modules to be designed for the grower system 12, and these are:

Grower module: This will be the main tool grower will be using to view, sort, print orders and generate various reports;

Printing module: This module will be responsible for printing labels which includes creating data files per the data map, generating efficient printer queue based on the options selected, marking the orders as being printed and generating printing log;

Download module: This module is the link between Grower and Order Fulfillment Service. It will be responsible to communicate with Order Fulfillment Service's system to get grower specific order details for specified dates into grower's local data store. It will send the status of upload back to the Order Fulfillment Service's system. This module looks for latest updates to software/database and activate the process that updates the software before continuing the download; and

Maintenance module: This module will be responsible for archiving data into historical tables to keep system running efficiently. This will also provide mechanism for downloading software from Order Fulfillment Service's ftp server and upgrading the Grower software.

The grower system 12 can be developed using .NET and can utilize the modules as described above. The Grower module can be developed using third party grid control on Windows Forms for faster performance. The system 12 can allow grower to view orders in most natural hierarchy and will allow flexibility to sort on various columns for views orders in the specific group suitable for their purpose. It will also provide facility to generate useful reports that can be used to get overall idea of the task at hand and also for claiming bills for the products handled. The native database for .NET (MSDE) will be used to make system 12 implementation simple.

The download module can be developed with support of a messaging queue (currently provided by Sonic). This queue resides in the server at 6 and is grower specific. Header information and the message body is placed into this queue by the order and fulfillment management services residing on server at 20. When the client is connected, header information and the message body is sent to the client at 12. The download module on successfully retrieving the message body and storing it in the database, will return success to the queue on the server at 6. On getting success flag the message is removed from the queue at the server at 6 by the fulfillment management services residing on the server at 20. ”

The print module can be responsible for printing labels for the order(s) identified to be printed. It will interact with the data access utilities to gather all order related information and will prepare the data file to be sent to the printer 14. It will also implement options for printing batch orders to support heavy load during busy seasons.

Maintenance utility program will provide utilities for various maintenance tasks such as db upgrade, db backup, db archiving, purging print log, software upgrade and any other tasks needs to be done for book keeping.

Representatively, there can be one or more Order Fulfillment Service Systems:

Order Fulfillment Service system at 6 can place information that growers need into a grower specific sonic queue. The Order Fulfillment Service system at 6 can provide software updates via secure ftp site that Grower's application can access to perform automatic software updates. Also, Order Fulfillment Service system at 6 hosts the future order report information to the Grower.

There can be one or more Grower Systems:

Grower system can utilize a download module's sonic client for connecting to the Sonic Queue at the Order Fulfillment Service System server at 6. On detecting the connection, the Sonic Queue pushes the Message header and the body to the sonic client. The header can have information about configuration update or prompting for software upgrade or order information.

Based on the message header, the download module can handle differently. For configuration update, it can update the config setting of the grower system 12. For a software upgrade, it can prompt the Maintenance module to start the upgradation process. For order information, it will insert or update it into the database(MSDE).

The data used by the display UI will be placed in the orderdetails table and the complete details of order are saved as a serialized xml in the same table (as a value in the column). This will make loading and managing the data in UI much faster.

Grower UI is the main user interface grower can use to manage orders they handle. This module can contain a database module which can be responsible for interacting with the database tables and return all the requested data in form of datasets. Specific datasets can be created for each use, for example; OrderHeaderDS, OrderDetailDS, OrderDeletedDS, ReportDS, PrinterSettingDS, ConfigDS etc. The database layer can also provide functionality that can be used to move old (configurable) processed orders to historical tables to keep tables used by presentation layer, printer and download module at smallest possible size for improved performance. Optra forms software is used for generating labels.

The presentation layer can depend on these DataSets for their data requirements for example; getAllOrders (OrderDS), getDeletedOrders(), getPrinterSettings(), getReport(report_enum), etc. A third party grid control can be used to display dataset in flexible form and can provide facility to sort and arrange columns at run time.

Grower UI can contain a utility module that can be responsible for managing various configuration settings for printer module, download module and for auto update module.

Printer 14 application can be the printing machine 14 and can provide simple interface to be used by the grower presentation layer for ex; printOrders (order named value collection by ref). This function can be responsible for getting all order related data from the DAL and can be responsible for making sure that the orders listed in the collection can be printed. It can provide the status back to the calling function for orders (printed or failure to print and in that case can provide the error message). The printer application can implement smart printing logic to print batch orders on single printer or spread it across multiple printers 14 depending on batch size and the configuration settings. Printer application can also use DAL to mark the order as being printed in appropriate table.

Maintenance application—This is an application used to keep entire implementation up-to-date. It can use sonic client auto update information to keep grower system in sync with most recent version available at Order Fulfillment Service at 6. It can take care of updates of various application modules, database table upgrades, label (compiled styles) updates. These utilities can also provide module that can allow data archiving of historical data to keep size of main database to minimum.

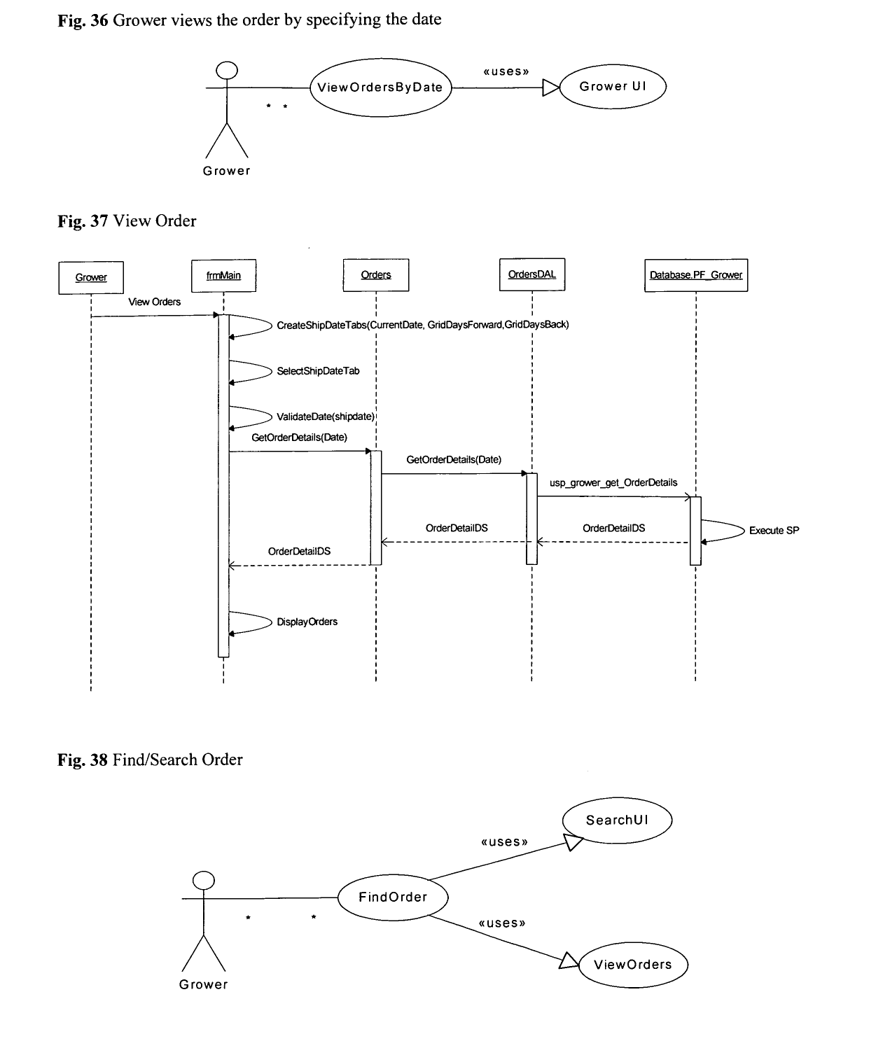

Architecture for a representative system or systems can be understood from a static view and dynamic view. A static view illustrates the structure of system and dynamic view defines the interactions of components. First, though, recall the context of system. In case of trading or e-commerce system, a grower system 12 can be defined as external to the e-commerce system, preferably with a fulfillment system intermediate the e-commerce and grower systems. See FIG. 36.

One approach is to follow a 3 tier architectural layer of presentation (web services/windows forms), business and data access. Following Order Fulfillment Service namespace specifications for .NET components, e.g., refer to ‘Namespace Reorganization.doc’.

All .NET modules can use MS application blocks for exception standards and data base access. Exception handling and publishing can need to be handled appropriately at each layer.

The presentation layer can have the following:

1. Download component:

2. Grower Application:

3. Printing Application:

4. Maintenance Application:

Business logic layer

Pickup and Delivery classes encapsulate the business logic to validate inputs and initiate the database access layer to update data.

Data access logic layer

Follow Order Fulfillment Service at 6 standards to access database tables using stored procedures and Microsoft's application blocks components to access the tables.

Third Party Tools and Package options

| | Maps Architecture | | |
|---|---|---|---|
| Component/Package | Component | Quantity | Cost ($) |
| Component one | .NET Grid component | 1 | |

As to the functionality and design of the Grower System 12, it can be viewed ass a part of the Order Fulfillment Service application, which provides functionality of Downloading, viewing and Printing labels/reports of shipments. There can be the following components:

1. Grower Application: This is the main application that grower can use most of the time. Main Features:

To view daily order data in customizable different forms to efficiently handle daily shipment of orders.

For selective printing of Labels (Order and Order details).

To print useful summary reports

2. Download Orders Application: This is a window service which acts as a link between Grower and Order Fulfillment Service. Main Features:

Load growers local data store with new and updated orders from Order Fulfillment Service fulfillment system

Send the confirmation of status message back to Order Fulfillment Service system.

3. Printer Application: This is the printing tool and responsible for printing selected order(s). Main Features:

Flexibility to print job (orders) in batches.

Intelligent distribution of printing job over multiple available printers.

Log print jobs to database to allow reprints of previous print jobs

Create daily log file

Manage (add remove etc) printers

4. Maintenance Application

This application is responsible for doing maintenance tasks. Main Features:

Automatic upgrades of the grower software from Order Fulfillment Service system

Ability to rollback the grower software version to previous versions.

Ability to archive data older than 30 days

Handle any other automatic maintenance activity.

More particularly, the Grower System 12 can encompass following components:

Grower Application (UI)

Order Display Component

Sort and Search/Find

Download Orders

Download Order specified by Date

Store in a local Database

Print Orders (Batch Printing)

Batch Printing

Distribute Print Job, when more than one printer available

Printer log to facilitate redo/reprint previous jobs

Create log file

Maintenance application (Background Process)

Archiving of data
Upgrade of the software
Upgrade of the configuration settings
Rollback to older/previous versions.

This design can also make use of following major components of the Order Fulfillment Service's (at 6) architecture and third party,

CommonTechnology.configuration

CommonTechnology.Utility

Sonic Queue

TFTP

Component Grid

MS Application blocs 2.0

Optra Forms

FTP (for software upgrade downloads)

Grower Application can be adapted to:

Display (view) all orders except those marked as ‘deleted’ over a date range

Group data by day/product/shipper/region/hub/status (new/updated/printed)

Search Orders (Product Name, ProductID, Tracking number) in the database

Mark Order (as new, printed, deleted etc)

Delete Orders.

Show confirmation dialog box before deleting the orders.

Change the status as ‘Deleted’ and remove those orders from the Grid

Performance consideration—should be able to handle about 100K orders for 7 days span.

Ability to generate following reports over specified date range:
Products shipped
Accessories shipped
Deleted orders
Products/Shipper/Region
Future products report (data Can be available at the Order Fulfillment Service server, and need to show in a web page)
Future Accessories report (data Can be available at the Order Fulfillment Service server, and need to show in a web page)

Capability to print/export reports and product summary data

Capability to print single order/selected orders/selected product(s)

Capability to print top pre-specified orders from large selections.

Capability to search and print batch of orders scanned via bar code scanner (Phase 2—need software interface of the scanner to grower system)

Configuration setup

Option to choose printer for selection

Option to use default mechanism.

Download Application can be adapted to:

Download supplier data using specific Sonic Queue

Store downloaded data into local data store MSDE

If a product name includes a “with”, everything after the “with” should be put in the accessories field. If a product name includes an “and” after a “with” the and is separating accessories, and the accessories should be separated as such on the label.

Printing Application can be adapted to handle:

Form printing

Single Form printing

Group/batch printing

Capability to print on specified printer.

Smart printing—spread printing job over multiple printers for large group printing.

Printing log per day/printer.

Printer log should contain job id assigned by the printer for each label

Log all activities, which happens on the specific printers during the day

Save key information of given printer job to database

Design new/modify labels and datamap for UPS

Maintenance Application can be adapted to:

Database cleanup/archive of old data

Software upgrades

Configuration resets/changes

Rollback mechanisms

Consider now the Grower system 12 Use Cases, Sequence diagrams and Class diagrams. Grower Application: This application has following,

Grid for Displaying Orders

Tabs for selecting the Dates (Today−1 to Today+5)

Search functionality for searching orders from the database

Find Button functionality finding specific orders from the Database

Delete functionality for deleting Orders

Print functionality for printing Orders and reports

Configuration functionality for configuring printer and other settings

User is shown the grid with Seven tabs with tab heading as Today−1 to Today+5 for selecting the date and by default focus can be on the today's date and data can be populated from the local database. All other tabs data can be populated when user selects/clicks the respective tabs. User clicks on any one of the Tab to view data for that date. The Application looks into the local data store (MSDE) and loads the data for the selected tab for that tabs date. If data is found then application retrieves the Order data from the MSDE for the selected date and display to the user, enabling:

Group data by day/product/shipper/region/hub/status

Display Criteria for new/updated/printed orders

View includes Product, Accessory, carrier, shipper type, service level, and sort, ordered columns

Find the particular order using Find Button

Mark the orders for Printing/Deleting

Print/export reports and product summary data

Print single order/selected orders/selected product(s)

Print top pre-specified orders from large selections (allow block selections from the group views).

Delete the orders. (A confirmation can be taken before deleting the Order)

Order management i.e., the application displays the counts of unprinted orders, orders on hold and deleted orders

Counts for all orders whose shipdate is within the selected day should display order totals (unprinted orders, hold orders, printed orders, and total orders)

Count for unprinted, hold, printed and total counts of orders are displayed for each viewable taxonomy level

Refresh the orders within the order taxonomy to see new orders and also it maintain it's state or structure

Export reports to Microsoft Excel in a readable format.

Mark individual orders or a group of orders as New, Printed and OnHold

When orders are being viewed in an expanded view in terms of the taxonomy, if there are duplicate counts shown, it should be apparent which order totals are being counted toward the overall total. If user selects all the Orders for the selected date then user is shown click through warning (kind of acknowledgement).

As to the Application Level: The application maintains the default data sorting settings when it is closed or opened. Users with Administrative privilege define the factory settings(logged as admin in windows) can:

Recover and redo print jobs by printer and batch number allowing to reprint an entire batch on a printer

Redo the entire last print Job

Print a subset of the orders selected within a single SKU within the taxonomy

Reprint orders whose shipdate is greater than 7 days ago

Recover and redo print jobs by printer and the subset range within a batch. Allowing them to redo a print job from label “X” through label “Y” within a print job on a certain printer

Log errors uploading data to the printers (printer, print time, number within printed subset (by printer), total number in printer subset (by printer), print job number, orderid)

Data archived for the given date range or periodic archive

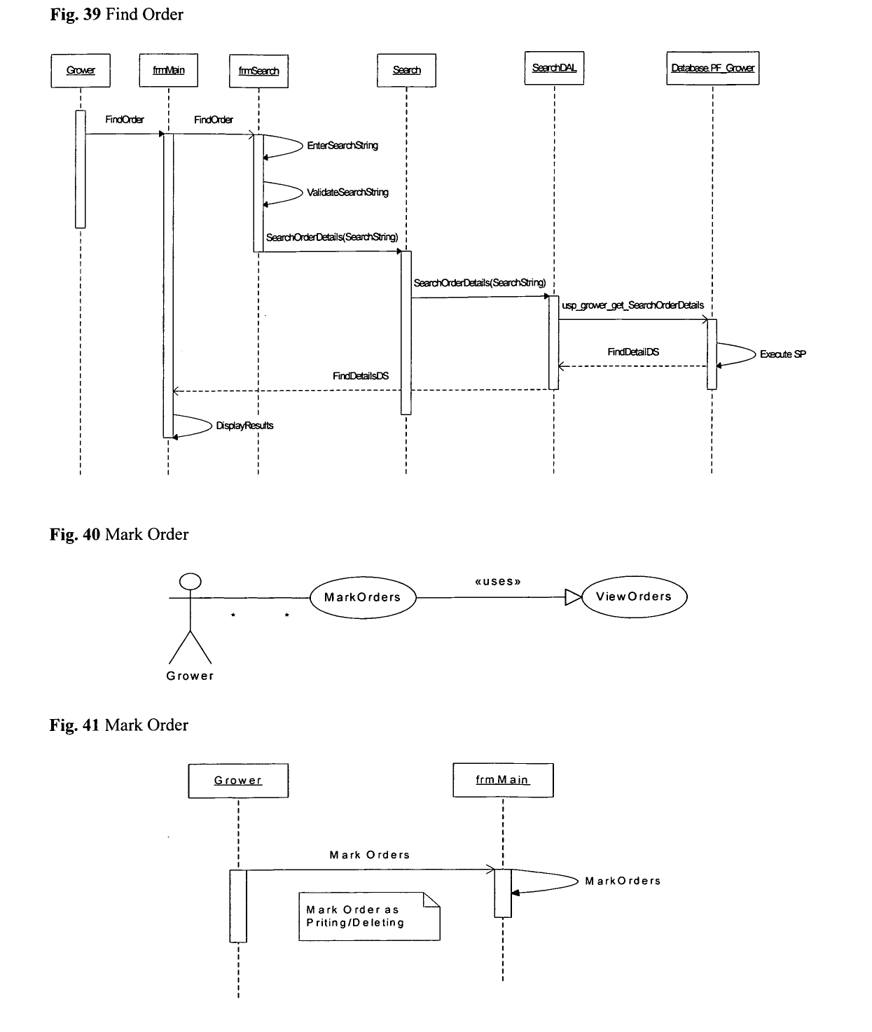

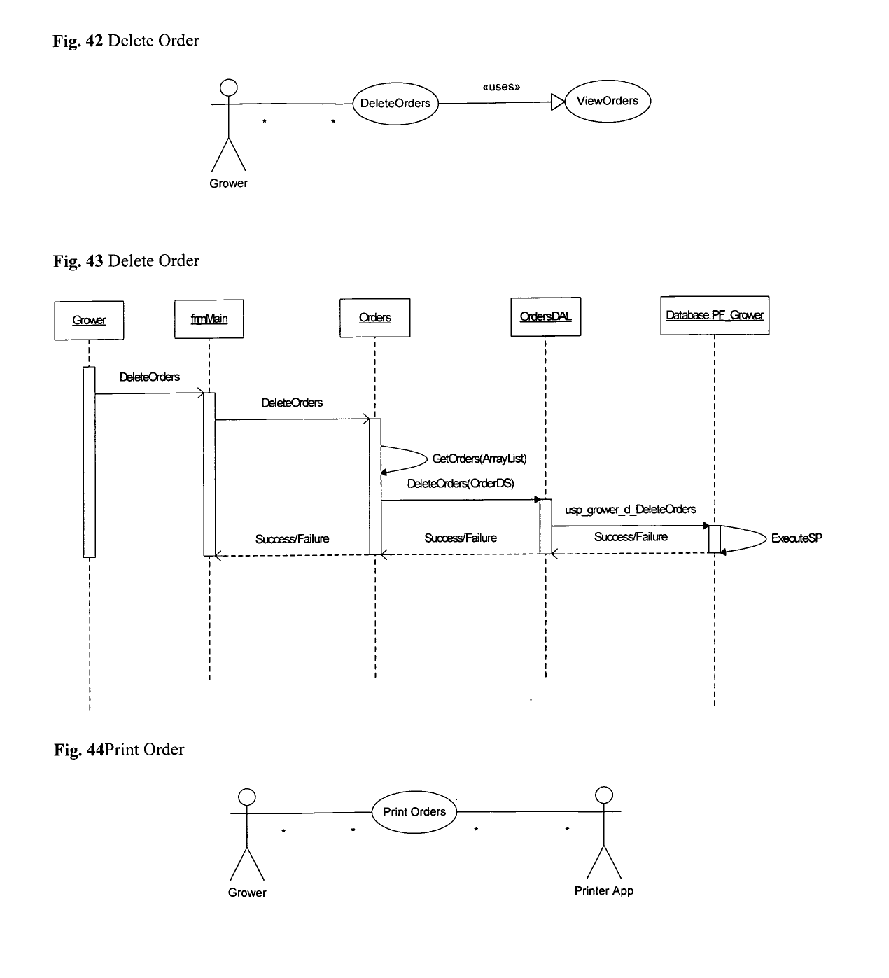

For case sequence diagrams see FIGS. 37-45.

As to flow, a User can configure following:

1. Add Printer: When user clicks on the Printer Configuration via button or menu on the Grower Application.

2. Select/Add Printers For Label and Report: Display all available printers (from OS) to grower, Grower picks one from the list and marks that as a label or report printer 14; Mark printer 14 as Enabled or disabled; Configuration is stored in local data store.

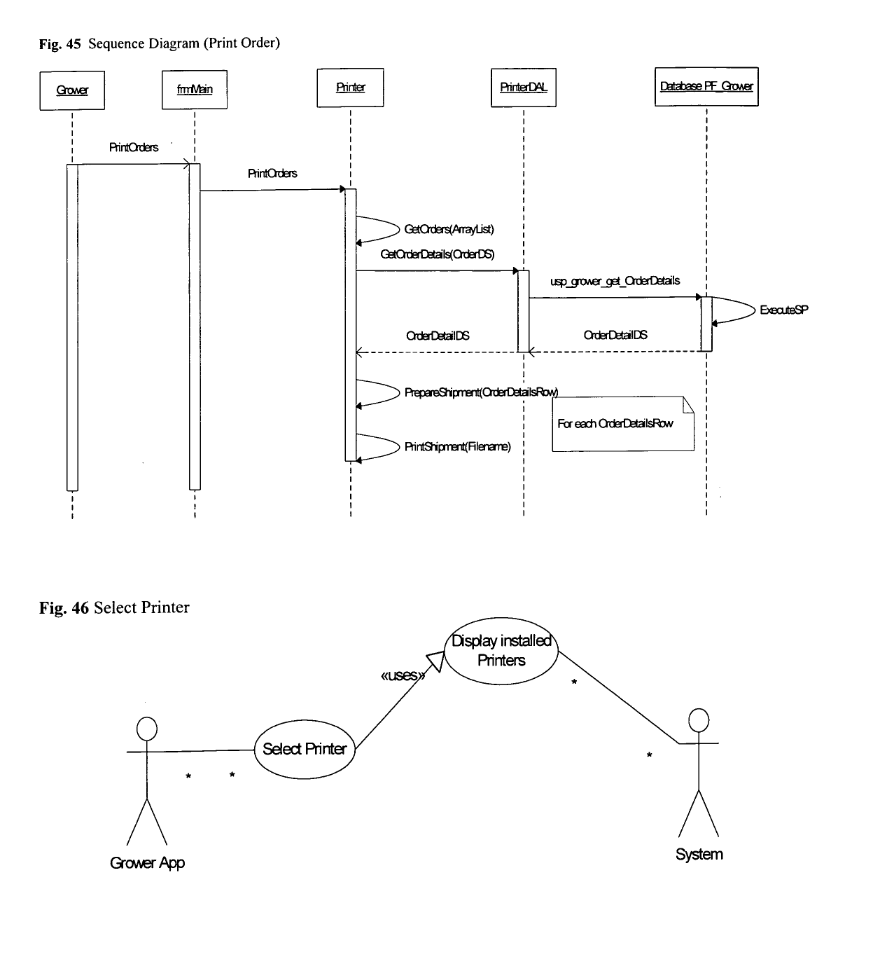

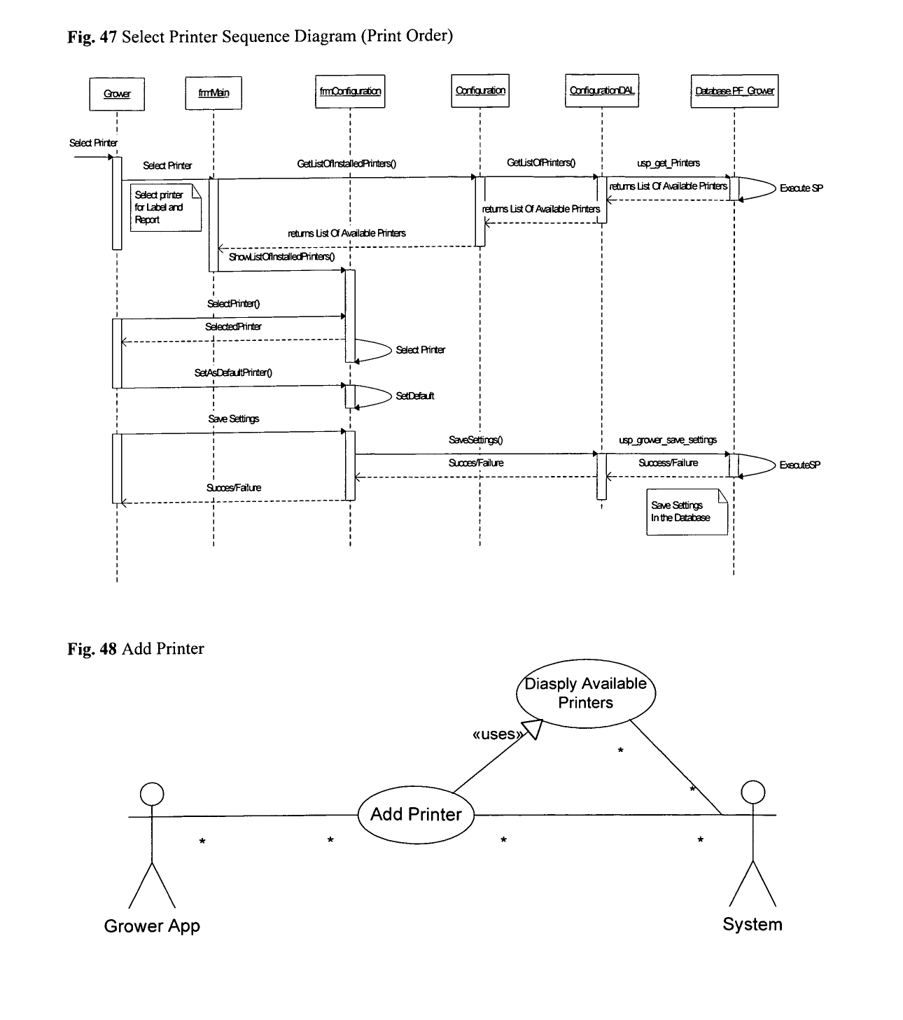

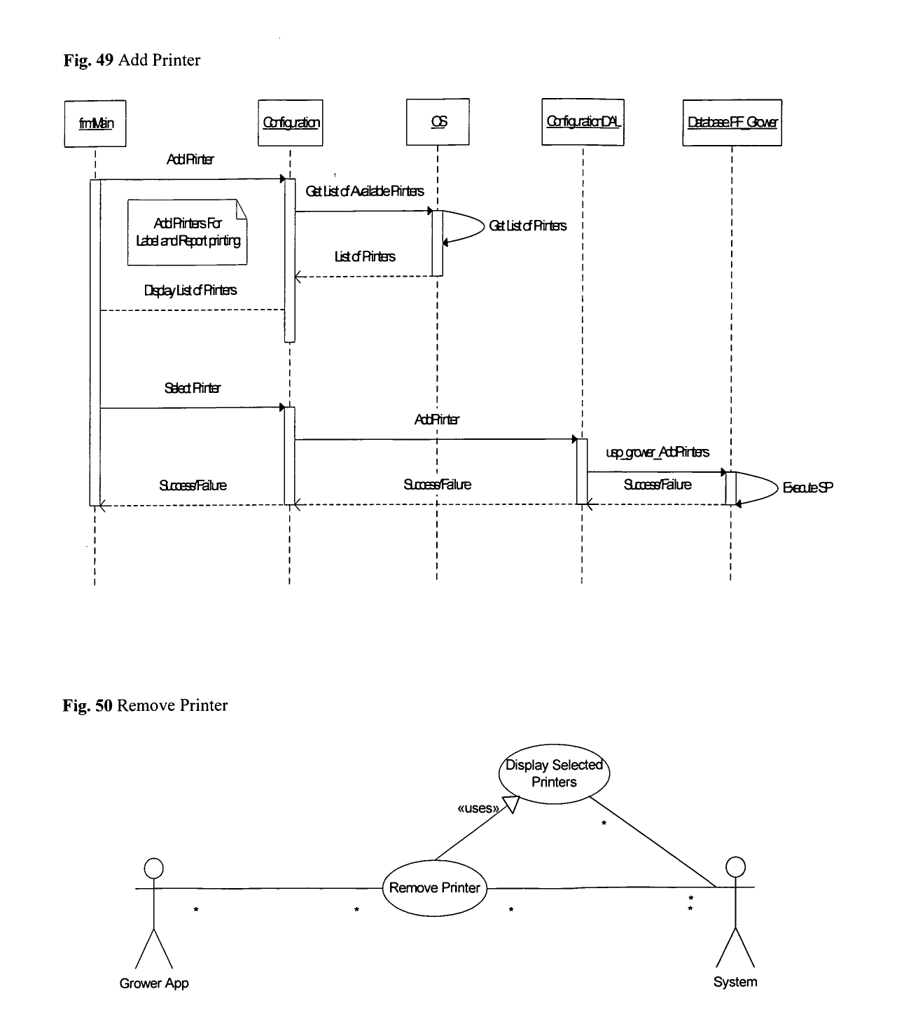

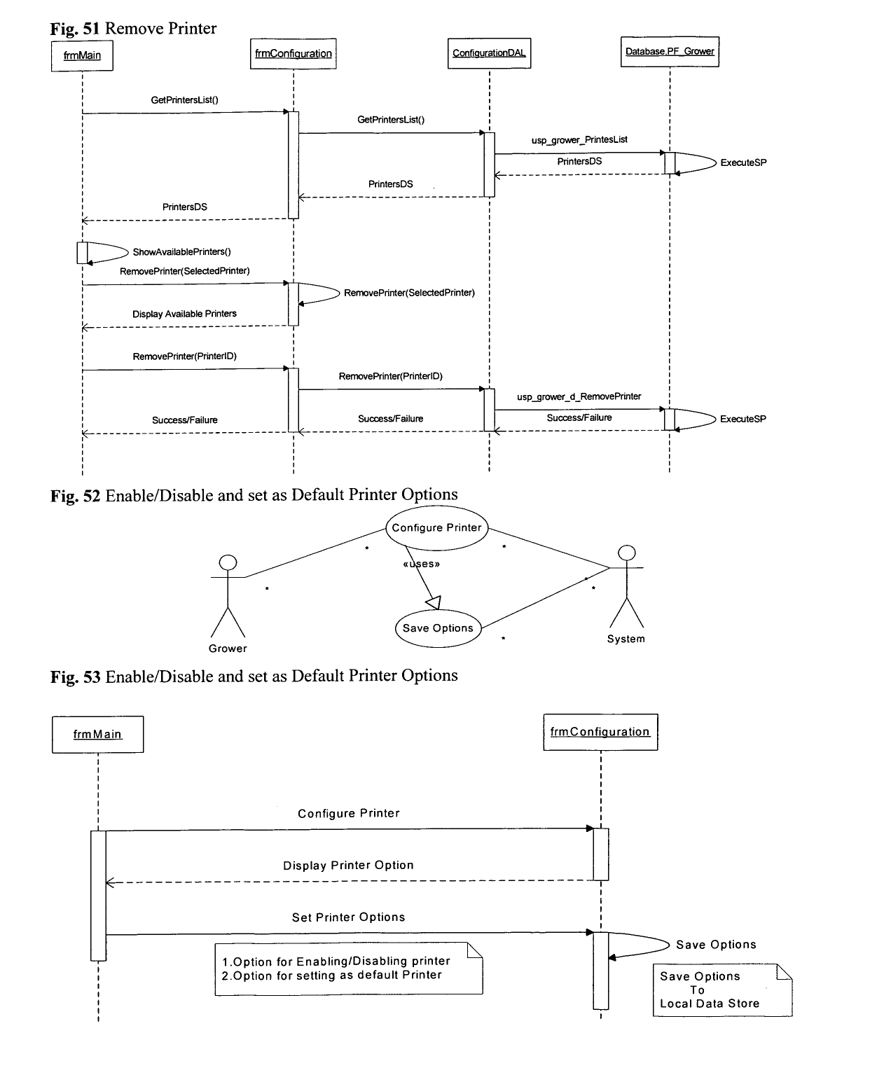

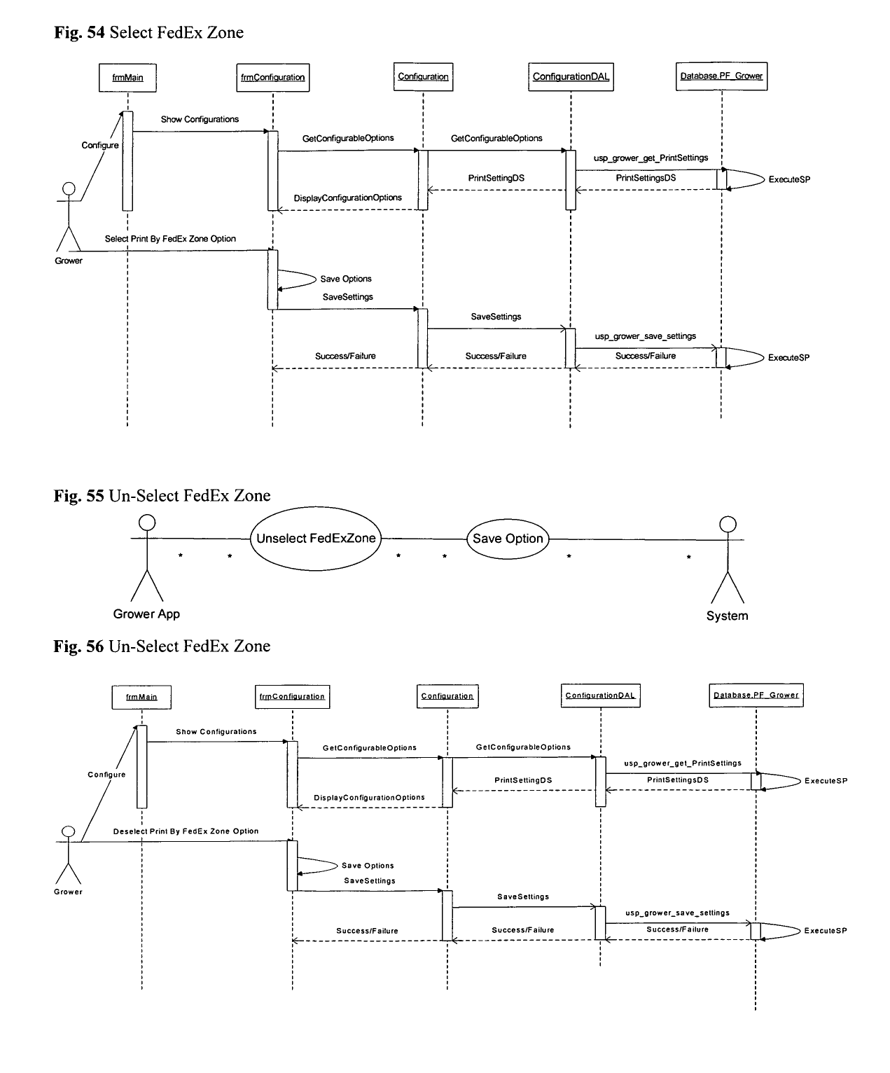

See FIGS. 46-56.

As to the download application, it acts as a link between Grower system 12 and Order Fulfillment Service at 6. This application is responsible for downloading data from the Order Fulfillment Service system at 6 using Sonic Queue architecture and it's service/scheduled job.

This application has following:

Downloads supplier specific data using Sonic Queue

Stores downloaded data into local data store MSDE

If a product name includes “with”, everything after the “with” can be put in the accessories field.

If a product name includes an “and” after a “with” the and is separating accessories, and the accessories can be separated as such on the label

Database cleanup/archive of old data

This application also reports any exceptions, and exception details, encountered when attempting to receive and store order data and put the order in error status within the server side database.

Reports any exceptions encountered when attempting to request order data (time, data sent in attempting to get orders). For instance, not able to connect to the server side to download orders.

With regard to flow, when a connection is established over the WAN, the download application is ready to download the orders. As soon as connection is established, a receiver function is invoked. This function has one parameter as a callback function of the download application. A receiver function can look in to the Sonic Message queue for the new message; If it finds new message (there are separate queue for each Grower and it is identified by the Queue Name, application can get the Queue name from the registry/db settings) it can pass it to the callback function. (This is a wrapper function in receiver class to convert the message into dataset and then call the dcprocessing.business layer function saveorder( )). All messages can be processed asynchronously and callback function can be called by spawning a new thread form the thread pool. Note: MSDE supports max 32767 connection.

Because message contains the dataset (string version of the dataset in xml doc format), this callback function can process it, inserts the data into the grower db (MSDE). Once data update is successful, download app can call a Sender function with new dataset for status update correct. The Sender can place the message in Status message queue for status update. There can be a similar sonic client at the Order Fulfillment Service System at 6, which can pick up this message and update the status. The above process can continue till the Sonic Client is active and it can be running as long as the machine is on.

Whenever Grower is connected to the Internet, Download Application can be invoked.

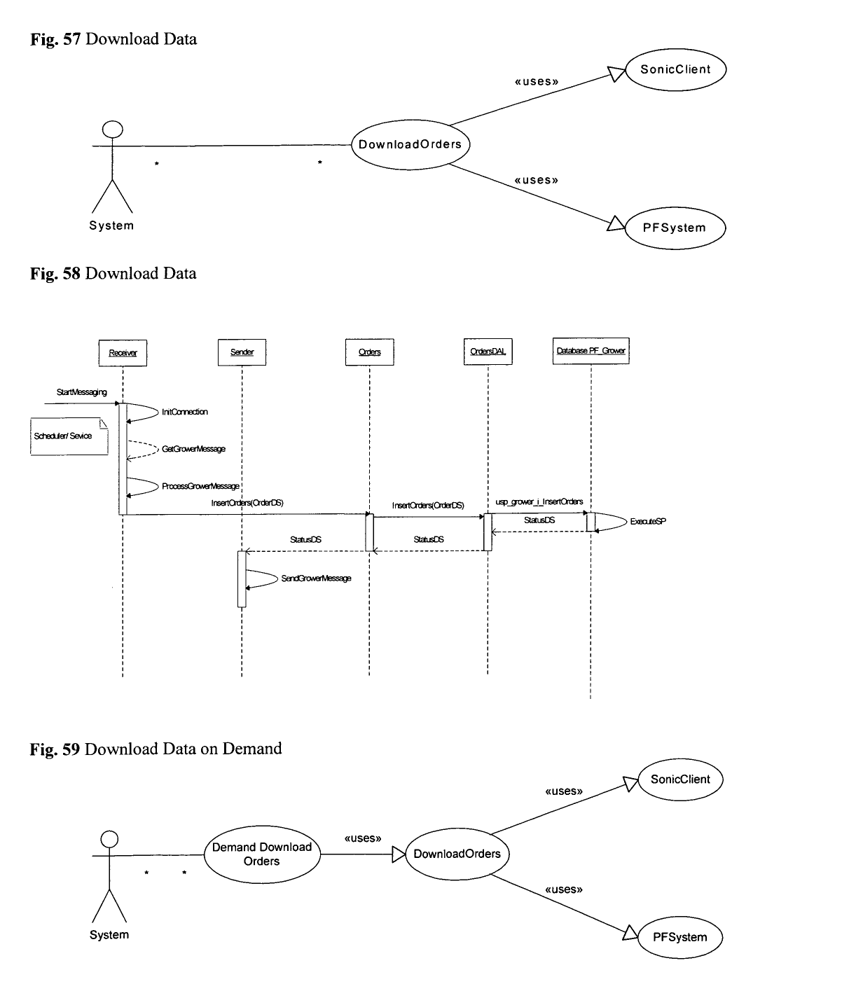

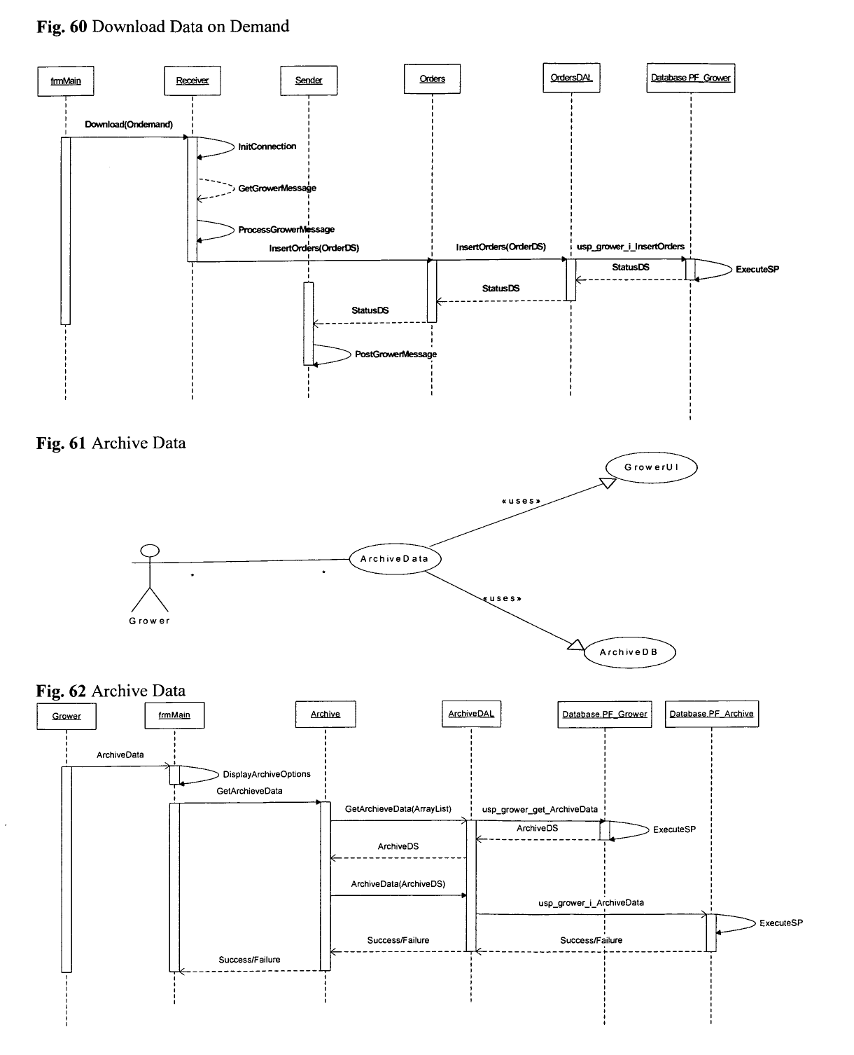

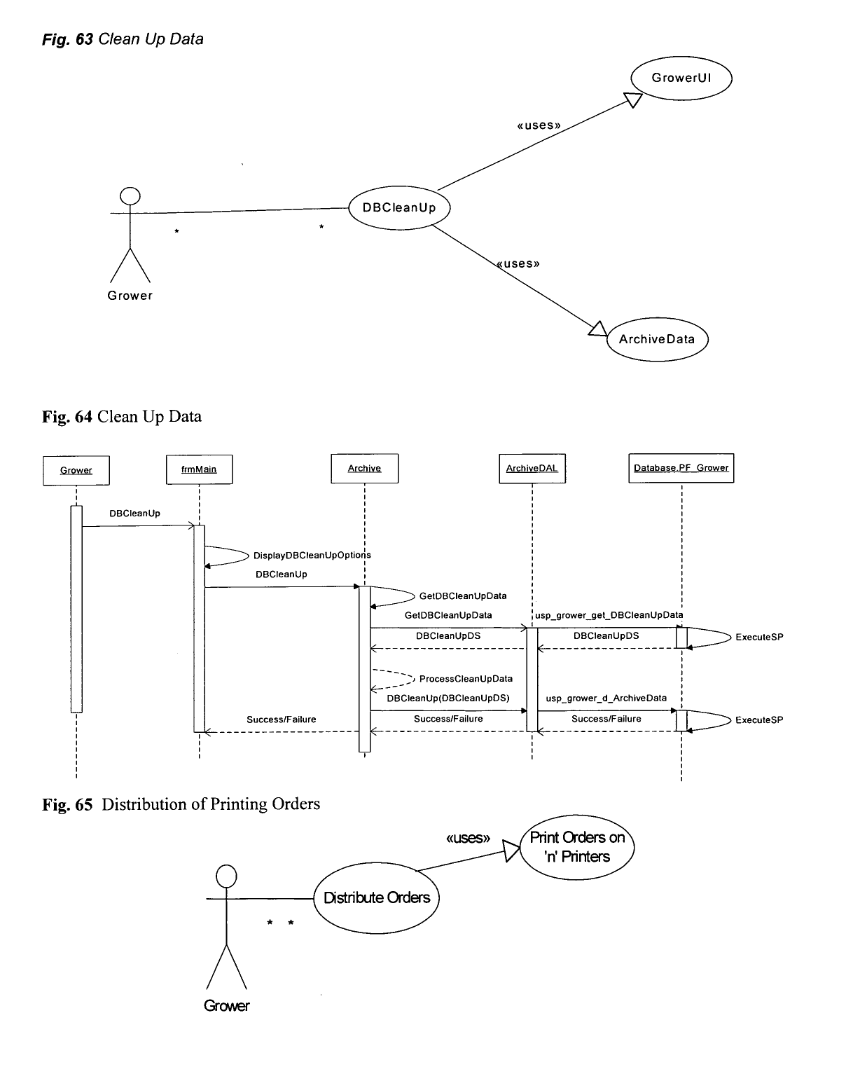

See FIGS. 57-64.

The printing application is for printing selected orders and reports, and this application has following:

Form printing

Single Form printing

Group/batch printing

Print on specified printer.

Smart printing—spread printing job over multiple printers for large group printing.

Create log per day/printer.

Save logs by day with a visually recognizable date

Log all activities, which happens on the specific printers during the day

Save key information of given printer job to database

Generate log file with following information:

Printer Name, Print time, Number within printed subset (by printer), Total number in printer subset (by printer), Print job number and ordered??(extracted from PPT presentation).

With regard to flow, when a user wants to print orders:

List of configured printer is retrieved from the database and shown to user specific to Report and Labels.

User selects one of the printer from the list

Reports can be printed by sending proper data to the report printer

In the case of Labels, files can be uploaded to the printer using TFTP and then printer prints the labels

Label Printing:

Collect all details of selected orders from the order/order details and create a formatted text file.

Save this file with unique name (TBD)

Upload this file using TFTP (trivial FTP) to Lexmark printer to print the labels

Distribution of Order printing on the various printer

Note: Printing of labels is called a job and every job is divided in to several batches, but alternatively small batches can be presented or sent to multiple printers.

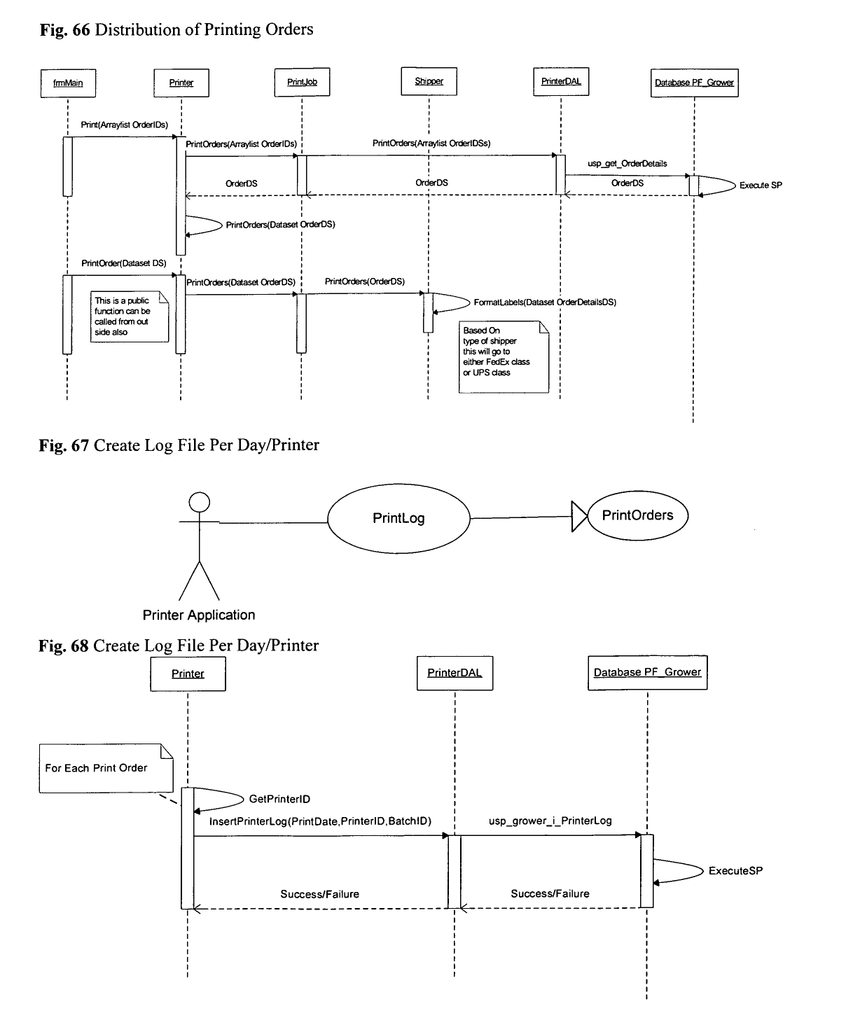

See FIGS. 65-66.

The following Unified Modeling Language (UML) class diagram represents the object model and gives an overview of the Grower System classes and their relations. See FIG. 67. For the Grower Application classes and related information, see the table below.

| | | | | |
|---|---|---|---|---|
| | Function | | | |
| Function Name | Scope | Arguments | Return Value | Description |

Class Name: GrowerUI
Namespace: Order Fulfillment Service.Application.Windows.DCProcessing

| | | | | |
|---|---|---|---|---|
| DoMerging | Public | NA | Void | Merging cells |
| | | | | displayed on |
| | | | | GrowerUI. |
| DoSubtotals | Public | NA | Void | Shows the |
| | | | | Summaries of |
| | | | | Orders on the Grid |
| | | | | for Products, |
| | | | | Shippers, Zone, |
| | | | | New, Updated etc. |
| DoSorting | Public | NA | Void | Sort orders |
| | | | | dynamically when |
| | | | | user clicks on the |
| | | | | column header. It |
| | | | | gives Ascending and |
| | | | | Descending sort. |
| GetOrders | Public | NA | Array List | Get selected orders |
| | | | | from GrowerUI as an |
| | | | | array list. |
| ValidateDate | Public | Date | Boolean | Validating date to |
| | | | | check whether its in |
| | | | | proper format. |
| | | | | Returns ‘True’ if its in |
| | | | | proper date string or |
| | | | | ‘False’ if not. |
| ValidateSearchString | Public | String | Boolean | Validating search |
| | | | | string entered. |
| | | | | Return ‘True’ if its in |
| | | | | proper format and |
| | | | | ‘False’ else |
| CreateShipDateTabs | Public | CurrentDate, | Void | Creating Tabs on |
| | | GridDaysForward, | | Grid by taking value |
| | | GridDaysBack | | of GridDaysForward |
| | | | | and GridDaysBack |
| | | | | from config file. |

Class Name: GrowerBL
Namespace: Order Fulfillment Service.BusinessProcess.DCProcessing.Business

| | | | | |
|---|---|---|---|---|
| GetOrders | Public | Array List | OrderDS | This function take |
| | | | | Array List as |
| | | | | parameter, properly |
| | | | | convert into OrderDS |
| InsertOrders | Public | OrderDetailDS | Boolean | This function Inserts |
| | | | | orders downloaded |
| | | | | from Order Fulfillment |
| | | | | Service into |
| | | | | GrowerDB |
| UpdateOrders | Public | | Void | [TBD] |
| DeleteOrders | Public | OrderDS | Boolean | This function |
| | | | | delete(mark as |
| | | | | ‘deleted’ and Delete |
| | | | | Orders from |
| | | | | GrowerDB) selected |
| | | | | orders (not yet |
| | | | | decided whether to |
| | | | | delete from |
| | | | | GrowerUI) |
| GetConfigurations | Public | NA | ConfigDS | This function returns |
| | | | | the configuration |
| | | | | details for |
| | | | | GrowerSystem as a |
| | | | | DataSet. |
| UpdateConfigurations | Public | ConfigDS | Boolean | This function updates |
| | | | | Grower specific |
| | | | | configuration |
| | | | | settings in to Grower |
| | | | | DB |
| GetOrdersFromPrintLog | Public | PrintDate | OrderDS | This function takes |
| | | | | PrintDate as |
| | | | | parameter and get |
| | | | | OrderDS |
| MarkOrders | Public | OrderDS | Boolean | This function marks |
| | | | | the status of Orders |
| | | | | to specified value |
| ArchiveData | Public | ArchiveDS | Boolean | This function Archive |
| | | | | Grower data into |
| | | | | Archive Database |
| GetOrderDetails | Public | OrderDS | OrderDetailDS | This function gets the |
| | | | | Order details from |
| | | | | GrowerDB by passing |
| | | | | OrderDS |
| GetArchiveData | Public | Array list (we | ArchiveDS | This function gets |
| | | can pass | | data to archive from |
| | | Tables to | | GrowerDB |
| | | Archieve in | | |
| | | Array list) | | |

Class Name: PrinterBL
Namespace: Order Fulfillment Service.BusinessProcess.DCProcessing.Printer

| | | | | |
|---|---|---|---|---|
| GetPrinters | Public | | PrintersDS | This function gets the list of |
| | | | | Printers from GrowerDB. |
| AddPrinter | Public | PrinterDS | Boolean | This function adds a new |
| | | | | printer into GrowerDB |
| UpdatePrinter | Public | PrinterDS | Boolean | This function updates |
| | | | | printer in GrowerDB |
| DeletePrinter | Public | PrinterID | Boolean | This function deletes the |
| | | | | selected printer from |
| | | | | ‘GrowerDB’ |
| GetPrinterBatch | Public | OrderDS | PrinterBatchDS | This function gets the |
| | | | | batches for printing. |
| AddPrinterBatch | Public | | | [TBD] |
| DeletePrinterBatch | Public | | | [TBD] |
| UpdatePrinterBatch | Public | | | [TBD] |
| InsertPrinterLog | Public | PrinterID, | Boolean | This function inserts print |
| | | PrintDate, | | log into GrowerDB |
| | | BatchID, | | |
| | | PrintJobID | | |

Class Name: MessagingBL
Namespace: Order Fulfillment Service.BusinessProcess.DCProcessing.Messaging

| | | | |
|---|---|---|---|
| Connect | Public | NA | NA |
| Disconnect | Public | NA | NA |
| Post | Public | NA | NA |
| Get | Public | NA | NA |

Class Name: ReceiverBL
Namespace: Order Fulfillment Service.BusinessProcess.DCProcessing.Messaging.Receiver

| | | | |
|---|---|---|---|
| GetGrowerMessage | Public | NA | String |

Class Name: SenderBL
Namespace: Order Fulfillment Service.BusinessProcess.DCProcessing.Messaging.Sender

| | | | |
|---|---|---|---|
| PostGrowerMessage | Public | StatusDS | Boolean |

Class Name: GrowerDAL
Namespace: Order Fulfillment Service.BusinessProcess.DCProcessing.DataAccess

| | | | | |
|---|---|---|---|---|
| InsertOrders | Public | OrderDetailDS | Void | This function calls |
| | | | | usp_grower_i_insertOrders |
| | | | | to save orders |
| | | | | into GrowerDB |
| UpdateOrders | Public | NA | Void | [TBD] |
| DeleteOrders | Public | OrderDS | Boolean | This function |
| | | | | Calls |
| | | | | ‘usp_grower_d_Delete |
| | | | | Orders’ in DB to |
| | | | | delete selected |
| GetConfigurations | Public | NA | ConfigDS | This function |
| | | | | Calls |
| | | | | ‘usp_grower_get_Configurations’ |
| | | | | in |
| | | | | GrowerDB to get |
| | | | | Config. details |
| UpdateConfigurations | Public | ConfigDS | Boolean | This function |
| | | | | Calls |
| | | | | ‘usp_grower_u_Update |
| | | | | Configurations’ in |
| | | | | GrowerDB to |
| | | | | update Config. |
| | | | | Details |
| GetOrdersFromPrintLog | Public | PrintDate | OrderDS | This function |
| | | | | Calls |
| | | | | ‘usp_grower_get_Orders |
| | | | | FromPrinting' in |
| | | | | GrowerDB to get |
| | | | | Printed orders. |
| MarkOrders | Public | OrderDS | Boolean | This function |
| | | | | Calls |
| | | | | ‘usp_grower_MarkOrders’ |
| | | | | in GrowerDB to |
| | | | | mark ‘Status’ into a |
| | | | | specified value. |
| ArchiveData | Public | ArchiveDS | Boolean | This function calls |
| | | | | usp_grower_i_Archive |
| | | | | Data |
| GetOrderDetails | Public | OrderDS | OrderDetailDS | This function calls |
| | | | | usp_grower_get_Order |
| | | | | Details in GrowerDB |
| GetPrinters | Public | | PrintersDS | This function calls |
| | | | | usp_grower_get_Printers |
| | | | | in GrowerDB |
| AddPrinter | Public | PrinterDS | Boolean | This function calls |
| | | | | usp_grower_i_AddPrinter |
| | | | | in GrowerDB |
| UpdatePrinter | Public | PrinterDS | Boolean | This function calls |
| | | | | usp_grower_u_Update |
| | | | | Printer in GrowerDB |
| DeletePrinter | Public | PrinterID | | This function calls |
| | | | | usp_grower_d_Delete |
| | | | | Printer in GrowerDB |

Table Name: OrderHeader
Description:

Describes the Header for Orders. This table Contains the information relevant to shipped Orders. ‘GrowerUI’ uses this table to display Order information to its Users.

Table Name: OrderDetails

Description:

This table carries the detailed information about the Orders shipped. This table used when User want to get more specific information for an order. This table used to get details of Orders for printing Labels.

Table Name: OrderAccessory

Description:

This table stores the Accessories associated with an order. This is used when we want to display Orders or Print Orders based on Accessories.

Table Name: Printers

Description:

Stores the information related to printers. This table used to display printers available for Order/Report Printing.

Table Name: PrintLogHeader

Description:

Used to save the LogHeader when ever a print is done on grower system. This can store the information related to a print log.

Table Name: PrintLogDetails

Description:

Stores detail information of PrintLog, for a print job.

Table Name: Configuration

Description:

Stores the entire system 12 settings for Grower application. Any changes can be done on Grower application that need to update in Configuration table.

| Object Type | File Name | Object Name | Parameters | Returns | Description |
|---|---|---|---|---|---|
| Stored | Dbo.usp_grower_i_insertOrders | usp_grower_i_insertOrder | | | |
| Procedure | | | | | |
| Stored | Dbo.usp_grower_d_DeleteOrders | usp_grower_d_DeleteOrders | | | |
| Procedure | | | | | |
| Stored | Dbo.usp_grower_get_Configurations | usp_grower_get_Configurations | | | |
| Procedure | | | | | |
| Stored | Dbo.usp_grower_u_UpdateConfigurations | usp_grower_u_UpdateConfigurations | | | |
| Procedure | | | | | |
| Stored | Dbo.usp_grower_get_OrdersFromPrinting | usp_grower_get_OrdersFromPrinting | | | |
| Procedure | | | | | |
| Stored | Dbo.usp_grower_MarkOrders | usp_grower_MarkOrders | | | |
| Procedure | | | | | |
| Stored | Dbo.usp_grower_i_ArchiveData | usp_grower_i_ArchiveData | | | |
| Procedure | | | | | |
| Stored | Dbo.usp_grower_get_ArchiveData | usp_grower_get_ArchiveData | | | |
| Procedure | | | | | |
| Stored | Dbo.usp_grower_get_OrderDetail | usp_grower_get_OrderDetails | | | |
| Procedure | | | | | |
| Stored | Dbo.usp_grower_get_Printers | usp_grower_get_Printers | | | |
| Procedure | | | | | |
| Stored | Dbo.usp_grower_i_AddPrinter | usp_grower_i_AddPrinter | | | |
| Procedure | | | | | |
| Stored | Dbo.usp_grower_u_UpdatePrinter | usp_grower_u_UpdatePrinter | | | |
| Procedure | | | | | |
| Stored | Dbo.usp_grower_d_DeletePrinter | usp_grower_d_DeletePrinter | | | |
| Procedure | | | | | |
| Stored | Dbo.usp_grower_i_PrinterLog | usp_grower_i_PrinterLog | | | |
| Procedure | | | | | |

Followings point are some further design considerations.

Tabs for selecting the Dates (Today−1 to Today+5)

Dates are configurable items and can be read from the configuration file

Find Orders:

Searching over different columns—productname, ‘orderID’ in the grid

Delete Order: Decision to be taken on to remove the row from the grid

Grower.exe could be a service that keep on running and closing simply places it in the task bar as an icon.

Label Printing: It is a intelligent distribution of labels across available printers 14 and not to force printing it to single printer at 14. The approach is to spread printing across different printers 14 for intelligent printing. For example, when all orders for single products are selected for printing, or when multiple products are picked, then it sends all orders for the product(s) to same printer or subset of printers to prints according to product/printer.

Report Printing: Simply dumps the grid that displays report to the printer 14. Grid has the printing facility and it can be used.

Download Application: This is asynchronous operation so if there are “n” message then a number of threads can be invoked from thread pool and each thread can have a DB Connection. Once data is inserted successfully, DB connection can be released and thread can call Sender function to update the Status then thread can be destroyed.

Consider deployment of the Grower system 12. For a first-time deployment:

| | |
|---|---|
| CREATE NEW | CREATE FOLLOWING DIRECTORY STRUCTURE ON |
| DIRECTORIES | C:\MSSQL\GROWERDISTRIBUTIONCENTER\DBDATA |
| | C:\MSSQL\GROWERDISTRIBUTIONCENTER\DBLOGS |
| ENVIRONMENT | JAVA BIN DIRECTORY SHOULD BE INCLUDED IN ENVIRONMENT |
| VARIABLES | VARIABLES. |
| | FOR EXAMPLE PATH=C:\J2SDK1.4.2_04\BIN; SHOULD BE |
| | AVAILABLE IN ENVIRONMENT VARIABLES SETTINGS. |

Database Deployment

| | |
|---|---|
| GROWERDISTRIBUTIONCENTER | THE FOLLOWING SCRIPTS NEED TO BE RUN IN THIS DB |
| COPY DATA FILE | FROM |
| | DEV.NET\STUDIO2003_COMPATBILE\ |
| | SRC_UPSINTEGRATION\ORDER FULFILLMENT SERVICE\ |
| | DATABASES\ORDER FULFILLMENT SERVICE GROWER\ |
| | TO: |
| | C:\TEMP OF GROWER COMPUTER |
| | NOTE: CREATE C:\TEMP IF IT DOES NOT EXIST ON THE |
| | GROWER COMPUTER |
| EXECUTE ORDER | OPEN COMMAND WINDOW AND CHANGE DIR TO C:\ |
| FULFILLMENT SERVICE | TEMP\ORDER FULFILLMENT SERVICE GROWER\ |
| GROWER.CMD | TYPE “ORDER FULFILLMENT SERVICE GROWER.CMD” |
| | (LOCAL) GROWERDISTRIBUTIONCENTER |

Grower DownLoad component and UI Application:
Copy Deploy.Net\Src_UPSIntegration\Grower_QA1\DownLoadMessagesJava to C:\
C:\VSS Checkout\Deploy.Net\Src_UPSIntegration\Grower_QA1\DownLoadMessagesNET to C:\
C:\VSS Checkout\Deploy.Net\Src_UPSIntegration\Grower_QA1\GrowerApplication to C:\
Open C:\DownLoadMessagesJava folder
Open App.config file
Change the parameters (This is for Sonic Server Queue and Remoting server url)
Close this file.
For testing, Open log.prop file and
log4j.rootLogger=DEBUG, A1
#log4j.rootLogger=ERROR, A1
-Uncomment second line and comment third line. Create log file with debug information.
9. Save, Close the file and the folder.
10. Open C:DownLoadMessagesNet folder
Open Application.WindowsServices.DCProcessing.Messaging.MessagingServer.exe.config” file
Verify the values in the config file (If you have copied the DownLoadMessagesJava to C:\ you need not change anything)
Close this file and folder
Open command prompt and go to C:\DownloadMessageNet folder and run
DownloadMessagesNET.bat file. This can install the service and start it also.
Open C:\GrowerApplication folder
Check Application.Windows.DCProcessing.exe.config for the db connection information.
Run “Application.Windows.DCProcessing.exe”.
Integraton with Fulfillment Sustem

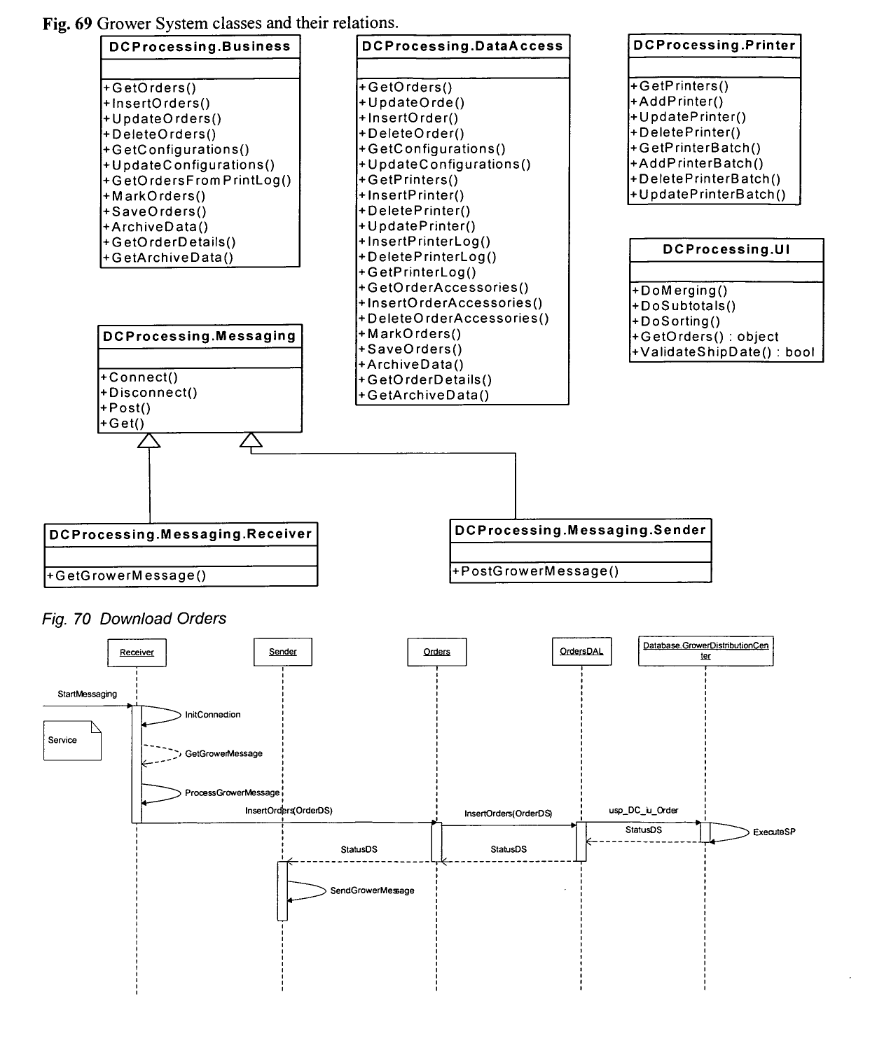

See FIGS. 68-70 and the code in the appendix.

PRVDFulfillmentSystem classes

| | | | | |
|---|---|---|---|---|
| | Function | | | |
| Function Name | Scope | Arguments | Return Value | Description |

Class Name: GrowerUI
Namespace: Order Fulfillment Service.Application.Windows.DCProcessing

| | | | | |
|---|---|---|---|---|
| DoMerging | Public | NA | Void | Merging cells displayed on |
| | | | | GrowerUI. |
| DoSubtotals | Public | NA | Void | Shows the Summaries of |
| | | | | Orders on the Grid for |
| | | | | Products, Shippers, Zone, |
| | | | | New, Updated etc. |
| DoSorting | Public | NA | Void | Sort orders dynamically |
| | | | | when user clicks on the |
| | | | | column header. It gives |
| | | | | Ascending and |
| | | | | Descending sort. |
| GetOrders | Public | NA | Array List | Get selected orders from |
| | | | | GrowerUI as an array list. |
| ValidateDate | Public | Date | Boolean | Validating date to |
| | | | | check whether its in |
| | | | | proper format. Returns |
| | | | | ‘True’ if its in proper date |
| | | | | string or ‘False’ if not. |
| ValidateSearchString | Public | String | Boolean | Validating search string |
| | | | | entered. Return ‘True’ if its |
| | | | | in proper format and |
| | | | | ‘False’ else |
| CreateShipDateTabs | Public | CurrentDate, | Void | Creating Tabs on Grid by |
| | | GridDaysForward, | | taking value of |
| | | GridDaysBack | | GridDaysForward and |
| | | | | GridDaysBack from config |
| | | | | file. |

Class Name: Configuration.cs
Namespace: Order Fulfillment Service.BusinessProcess.DCProcessing.Business

| | | | | |
|---|---|---|---|---|
| getConfiguration | Public | NA | ConfigurationDS | This function calls |
| | | | | getConfiguration( ) method |
| | | | | of ConfigurationDAL. |
| getNoOfLabelPrinters | Public | NA | Integer | This function calls |
| | | | | getNoOfLabelPrinters( ) |
| | | | | method of |
| | | | | ConfigurationDAL. |
| getPrinter | Public | NA | PrinterDs | This function calls |
| | | | | getPrinter( ) method of |
| | | | | ConfigurationDAL. |
| getSystemPrinters | Public | NA | Arraylist | This function retrieves |
| | | | | system Printers (Installed |
| | | | | printers from OS) |
| updateConfig | Public | NA | Boolean | This function calls |
| | | | | UpdateConfig( ) method of |
| | | | | ConfigurationDAL. |
| UpdatePrinter | Public | PrinterDS | Boolean | This function calls |
| | | | | UpdatePrinter( ) method of |
| | | | | ConfigurationDAL. |
| IsUserwithAdminRights | Public | NA | Boolean | This function determines |
| | | | | whether the current user is |
| | | | | administrator or not. |
| UpdateJMSConfig | Public | String, | Boolean | |
| | | String | | |

Class Name: FutureOrder.cs
Namespace: Order Fulfillment Service.BusinessProcess.DCProcessing.Business

| | | | | |
|---|---|---|---|---|
| GetFutureProducts | Public | String, Integer | FutureOrderDS | This function calls |
| | | | | GetFutureProducts( ) |
| | | | | method of |
| | | | | FutureOrderDAL. |
| GetFutureAccessories | Public | String, Integer | FutureOrderDS | This function calls |
| | | | | GetFutureAccessories( ) |
| | | | | method of |
| | | | | FutureOrderDAL. |

Class Name: JmsListener.cs
Namespace: Order Fulfillment Service.BusinessProcess.DCProcessing.Business

| | | | |
|---|---|---|---|
| Start | Public | NA | Void |
| Stop | Public | NA | Void |
| jmsProcess_Exited | Public | Object, EventArgs | Void |

Class Name: MessageReceiver.cs
Namespace: Order Fulfillment Service.BusinessProcess.DCProcessing.Business

| | | | |
|---|---|---|---|
| GetReturnMessageXml | Public | String, String, String, | String |
| | | String String, String, | |
| | | String, String, String | |
| GetReturnMessageXml | Public | String, String, String, | String |
| | | String, String, String | |
| | | String, String | |
| OnMessage | Public | String | String |
| UpdateJMSConfig | Public | String, String | Boolean |

Class Name: Orders.cs
Namespace: Order Fulfillment Service.BusinessProcess.DCProcessing.Business

| | | | | |
|---|---|---|---|---|
| AddOrder | Public | GrowerShipmentDataSet | Boolean | This function calls |
| | | | | AddOrder( ) method of |
| | | | | OrdersDAL. |
| DeleteOrder | Public | Integer | Boolean | This function calls |
| | | | | DeleteOrder( ) method |
| | | | | of OrdersDAL. |
| GenerateAccessoryType | Private | Arraylist | Arraylist | This function |
| | | | | Generates |
| | | | | AccessoryTypes for |
| | | | | given Accessories, |
| | | | | which are embedded |
| | | | | with product name.. |
| GetOrder | Public | Integer | OrderDataset | This function calls |
| | | | | GetOrder( ) method of |
| | | | | OrdersDAL. |
| GetOrderDetails | Public | String | OrderDetailDS | This function calls |
| | | | | GetOrderDetails( ) |
| | | | | method of |
| | | | | OrdersDAL. |
| GetOrders | Public | Integer | OrderDataset | This function calls |
| | | | | GetOrders( ) method |
| | | | | of OrdersDAL. |
| GetOrders | Public | String | OrderDataset | This function calls |
| | | | | GetOrders( ) method |
| | | | | of OrdersDAL. |
| GetPrintOrder | Public | String | PrintOrderDS | This function calls |
| | | | | GetPrintOrder( ) |
| | | | | method of |
| | | | | OrdersDAL. |
| GetPrintSummaryGrid | Public | String, String | PrintSummaryDS | This function calls |
| | | | | GetPrintSummaryGrid( ) |
| | | | | method of |
| | | | | OrdersDAL. |
| GetSortedAccessories | Private | GrowerShipmentDataSet | DataView | This function returns |
| | | | | sorted accessories |
| | | | | from |
| | | | | GrowerShipmentData |
| | | | | set and |
| | | | | parseproductlist. |
| ParseProductList | Public | String | Arraylist | This function accepts |
| | | | | product name as |
| | | | | parameter and |
| | | | | returns accessories |
| | | | | embedded with |
| | | | | product name as |
| | | | | arraylist. |
| UpdateOrder | Public | Integer, String | Boolean | This function calls |
| | | | | UpdateOrder( ) |
| | | | | method of |
| | | | | OrdersDAL. |
| UpdateOrders | Public | OrderStatusDS | Boolean | This function calls |
| | | | | UpdateOrders( ) |
| | | | | method of |
| | | | | OrdersDAL. |
| UpdateOrders | Public | String, String | Boolean | This function calls |
| | | | | UpdateOrders( ) |
| | | | | method of |
| | | | | OrdersDAL. |
| getOrders | Public | String | PrintOrderDS | This function calls |
| | | | | getOrders( ) method |
| | | | | of OrdersDAL. |

Class Name: Reports.cs
Namespace: Order Fulfillment Service.BusinessProcess.DCProcessing.Business

| | | | | |
|---|---|---|---|---|
| GetAccessoriesShipped | Public | String, | AccessorySummaryDS | This function calls |
| | | String | | GetAccessoriesShipped( ) |
| | | | | method of |
| | | | | ReportsDAL. |
| GetDeletedSummary | Public | String, | DeletedSummaryDS | This function calls |
| | | String | | GetDeletedSummary ( ) |
| | | | | method of ReportsDAL. |
| PrintJobSummary | Public | String, | PrintJobSummaryDS | This function calls |
| | | String | | PrintJobSummary( ) |
| | | | | method of ReportsDAL. |
| PrintProductSummary | Public | String, | PrintProductSummaryDS | This function calls |
| | | String | | PrintProductSummary( ) |
| | | | | method of ReportsDAL. |

Class Name: Search.cs
Namespace: Order Fulfillment Service.BusinessProcess.DCProcessing.Business

| | | | | |
|---|---|---|---|---|
| SearchOrderDetails | Public | String, String, | OrderDetailDS | This function calls |
| | | String, String | | SearchOrderDetails( ) |
| | | | | method of |
| | | | | SearchDAL. |

Class Name: GrowerBL
Namespace: Order Fulfillment Service.BusinessProcess.DCProcessing.Business

| | | | | |
|---|---|---|---|---|
| GetOrders | Public | Array List | OrderDS | This function take |
| | | | | Array List as |
| | | | | parameter, properly |
| | | | | convert into OrderDS |
| InsertOrders | Public | OrderDetailDS | Boolean | This function Inserts |
| | | | | orders downloaded |
| | | | | from Order Fulfillment |
| | | | | Service into |
| | | | | GrowerDB |
| UpdateOrders | Public | | Void | [TBD] |
| DeleteOrders | Public | OrderDS | Boolean | This function |
| | | | | delete(mark as |
| | | | | ‘deleted’ and Delete |
| | | | | Orders from |
| | | | | GrowerDB) selected |
| | | | | orders (not yet |
| | | | | decided whether to |
| | | | | delete from |
| | | | | GrowerUI) |
| GetConfigurations | Public | NA | ConfigDS | This function returns |
| | | | | the configuration |
| | | | | details for |
| | | | | GrowerSystem as a |
| | | | | DataSet. |
| UpdateConfigurations | Public | ConfigDS | Boolean | This function updates |
| | | | | Grower specific |
| | | | | configuration |
| | | | | settings in to Grower |
| | | | | DB |
| GetOrdersFromPrintLog | Public | PrintDate | OrderDS | This function takes |
| | | | | PrintDate as |
| | | | | parameter and get |
| | | | | OrderDS |
| MarkOrders | Public | OrderDS | Boolean | This function marks |
| | | | | the status of Orders |
| | | | | to specified value |
| ArchiveData | Public | ArchiveDS | Boolean | This function Archive |
| | | | | Grower data into |
| | | | | Archive Database |
| GetOrderDetails | Public | OrderDS | OrderDetailDS | This function gets the |
| | | | | Order details from |
| | | | | GrowerDB by passing |
| | | | | OrderDS |
| GetArchiveData | Public | Array list (we | ArchiveDS | This function gets |
| | | can pass | | data to archive from |
| | | Tables to | | GrowerDB |
| | | Archieve in | | |
| | | Array list) | | |

Class Name: Printing.cs
Namespace: Order Fulfillment Service.BusinessProcess.DCProcessing.Printer

| | | | | |
|---|---|---|---|---|
| PrintOrders | Public | ArrayList | Boolean | This function prints |
| | | | | orders for given |
| | | | | ShipmentResponse- |
| | | | | Ids |
| PrintOrders | Public | String | Boolean | This function prints |
| | | | | orders for given |
| | | | | ShipmentResponse- |
| | | | | Ids, which is supplied |
| | | | | in coma separated |
| | | | | string |
| PrintOrders | Public | PrintOrderDS | Boolean | This function prints |
| | | | | orders for given |
| | | | | Dataset |
| PrintSummary | Public | String | Boolean | This function prints |
| | | | | product summary for |
| | | | | given |
| | | | | ShipmentResponse- |
| | | | | Ids, which is supplied |
| | | | | in coma separated |
| | | | | string |
| CreateEqualDistributionArray | Private | PrintOrderDS | ArrayList | This function creates |
| | | | | equal distribution |
| | | | | array, which is used |
| | | | | for distribution. |
| CreateStartPositionArray | Private | PrintOrderDS | ArrayList | This function creates |
| | | | | start position array, |
| | | | | which is used for |
| | | | | distribution. |
| CreatePrintDistributionArray | Private | PrintOrderDS | ArrayList | This function creates |
| | | | | Print distribution |
| | | | | array, which is used |
| | | | | for distribution. |
| CreatingTextFiles | Private | Arraylist, | Boolean | This function creates |
| | | PrintOrderDS | | Textfiles and prints |
| | | | | labels |

Class Name: Shipper.cs
Namespace: Order Fulfillment Service.BusinessProcess.DcProcessing.Printer

| | | | | |
|---|---|---|---|---|
| FormatLabel | Public | PrintOrderDS, | Boolean | This function formats |
| | | StreamWriter, String | | labels. |

Class Name: FedEx.cs
Namespace: Order Fulfillment Service.BusinessProcess.DCProcessing.Printer

| | | | | |
|---|---|---|---|---|
| FormatLabel | Public | PrintOrderDS, | Boolean | This function formats |
| | | StreamWriter, String | | FedEx labels. |

Class Name: UPS.cs
Namespace: Order Fulfillment Service.BusinessProcess.DCProcessing.Printer

| | | | | |
|---|---|---|---|---|
| FormatLabel | Public | PrintOrderDS, | Boolean | This function formats |
| | | StreamWriter, String | | UPS labels. |

Class Name: PrintSpool.cs
Namespace: Order Fulfillment Service.BusinessProcess.DCProcessing.Printer

| | | | | |
|---|---|---|---|---|
| PrintFile | Public | String, String | Boolean | This function prints |
| | | | | specified file to the |
| | | | | specified printer. |

Class Name: MessagingBL
Namespace: Order Fulfillment Service.BusinessProcess.DCProcessing.Messaging

| | | | |
|---|---|---|---|
| Connect | Public | NA | NA |
| Disconnect | Public | NA | NA |
| Post | Public | NA | NA |
| Get | Public | NA | NA |

Class Name: ReceiverBL
Namespace: Order Fulfillment Service.BusinessProcess.DCProcessing.Messaging.Receiver

| | | | |
|---|---|---|---|
| GetGrowerMessage | Public | NA | string |

Class Name: SenderBL
Namespace: Order Fulfillment Service.BusinessProcess.DCProcessing.Messaging.Sender

| | | | |
|---|---|---|---|
| PostGrowerMessage | Public | StatusDS | Boolean |

Class Name: ConfigurationDAL.cs
Namespace: Order Fulfillment Service.BusinessProcess.DCProcessing.DataAccess

| | | | | |
|---|---|---|---|---|
| getConfiguration | Public | NA | string | This function calls |
| | | | | Usp_DC_get_Configuration |
| | | | | stored |
| | | | | procedure to retrieve |
| | | | | configuration settings |
| | | | | from |
| | | | | GrowerDistributionCenter |
| | | | | Database. |
| getPrinter | Public | NA | PrinterDS | This function calls |
| | | | | Usp_DC_get_Printer |
| | | | | stored procedure to |
| | | | | retrieve available |
| | | | | printers from |
| | | | | GrowerDistributionCenter |
| | | | | Database. |
| getNoOfLabelPrinters | Public | NA | Integer | This function calls |
| | | | | Usp_DC_get_Printer |
| | | | | Count stored |
| | | | | procedure to get no of |
| | | | | available label |
| | | | | printers from |
| | | | | GrowerDistributionCenter |
| | | | | Database. |
| UpdateConfig | Public | String | Boolean | This function calls |
| | | | | Usp_DC_u_UpdateConfiguration |
| | | | | stored |
| | | | | procedure to update |
| | | | | configuration settings |
| | | | | into |
| | | | | GrowerDistributionCenter |
| | | | | Database. |
| UpdatePrinter | Public | PrinterDS | Boolean | This function calls |
| | | | | Usp_DC_iu_Printer |
| | | | | stored procedure to |
| | | | | update printer dataset |
| | | | | into |
| | | | | GrowerDistributionCenter |
| | | | | Database. |

Class Name: FutureOrderDAL.cs
Namespace: Order Fulfillment Service.BusinessProcess.DCProcessing.DataAccess

| | | | | |
|---|---|---|---|---|
| GetFutureProducts | Public | String, Integer | FutureOrderDS | This function calls |
| | | | | usp_supplier_get_future_orders |
| | | | | stored |
| | | | | procedure to retrieve |
| | | | | future order products |
| | | | | from |
| | | | | GrowerDistributionCenter |
| | | | | Database. |
| GetFutureAccessories | Public | String, Integer | FutureOrderDS | This function calls |
| | | | | usp_supplier_get_future_accs |
| | | | | stored |
| | | | | procedure to retrieve |
| | | | | future order |
| | | | | accessories from |
| | | | | GrowerDistributionCenter |
| | | | | Database. |

Class Name: PrinterDAL.cs
Namespace: Order Fulfillment Service.BusinessProcess.DCProcessing.DataAccess

| | | | | |
|---|---|---|---|---|
| getPrintJob | Public | Long | PrintJobDS | This function calls |
| | | | | Usp_DC_get_PrintJob |
| | | | | stored procedure to |
| | | | | retrieve print job |
| | | | | details from |
| | | | | GrowerDistributionCenter |
| | | | | Database. |
| getPrintJobOrders | Public | Long | PrintJobDS | This function calls |
| | | | | usp_DC_get_PrintJob |
| | | | | Orders stored |
| | | | | procedure to retrieve |
| | | | | all printed orders for |
| | | | | a given print jobID |
| | | | | from |
| | | | | GrowerDistributionCenter |
| | | | | Database. |
| UpdatePrinter | Public | PrinterDS | Boolean | This function calls |
| | | | | Usp_DC_u_UpdatePrinter, |
| | | | | Usp_DC_d_Printer |
| | | | | stored procedures to |
| | | | | update printers in |
| | | | | printer dataset into |
| | | | | GrowerDistributionCenter |
| | | | | Database. |
| AddPrintJob | Public | PrintJobDS | Boolean | This function calls |
| | | | | Usp_DC_i_AddPrintJob |
| | | | | stored procedure |
| | | | | to save printjob |
| | | | | details into |
| | | | | GrowerDistributionCenter |
| | | | | Database. |

Class Name: ReportsDAL.cs
Namespace: Order Fulfillment Service.BusinessProcess.DCProcessing.DataAccess

| | | | | |
|---|---|---|---|---|
| GetAccessoriesShipped | Public | String, String | AccessorySummaryDS | This function calls |
| | | | | Usp_DC_get_Accessory |
| | | | | Report stored |
| | | | | procedure to retrieve |
| | | | | Accessory summary |
| | | | | details for given |
| | | | | period from |
| | | | | GrowerDistributionCenter |
| | | | | Database. |
| GetDeletedSummary | Public | String, String | DeletedSummaryDS | This function calls |
| | | | | Usp_DC_get_Access |
| | | | | royReport stored |
| | | | | procedure to retrieve |
| | | | | deleted summary |
| | | | | details for given |
| | | | | period from |
| | | | | GrowerDistributionCenter |
| | | | | Database. |
| PrintJobSummary | Public | String, String | PrintJobSummaryDS | This function calls |
| | | | | Usp_DC_get_PrintJob |
| | | | | Summary stored |
| | | | | procedure to retrieve |
| | | | | Print job summary |
| | | | | details for given |
| | | | | period from |
| | | | | GrowerDistributionCenter |
| | | | | Database. |
| PrintProductSummary | Public | String, String | PrintProductSummaryDS | This function calls |
| | | | | Usp_DC_get_PrintProduct |
| | | | | SummaryReport |
| | | | | stored procedure to |
| | | | | retrieve print product |
| | | | | summary details for |
| | | | | given period from |
| | | | | GrowerDistributionCenter |
| | | | | Database. |

Class Name: SearchDAL.cs
Namespace: Order Fulfillment Service.BusinessProcess.DCProcessing.DataAccess

| | | | | |
|---|---|---|---|---|
| SearchOrderDetails | Public | String, | OrderDetailDS | This function calls |
| | | Arraylist, | | Usp_DC_get_FindOrder |
| | | String, | | stored procedure to retrieve |
| | | String | | Orderdetails for the given |
| | | | | filetername, filtervalues for |
| | | | | given period from |
| | | | | GrowerDistributionCenter |
| | | | | Database. |

Class Name: OrdersDAL.cs
Namespace: Order Fulfillment Service.BusinessProcess.DCProcessing.DataAccess

| | | | | |
|---|---|---|---|---|
| AddOrder | Public | OrderDataset | Boolean | This function calls |
| | | | | Usp_DC_iu_Order, |
| | | | | Usp_DC_i_AddAccessories |
| | | | | stored procedures to save new |
| | | | | Orders into the |
| | | | | GrowerDistributionCenter |
| | | | | Database. |
| DeleteOrder | Public | OrderDataset | Boolean | This function calls |
| | | | | Usp_DC_d_Order stored |
| | | | | procedure to delete specified |
| | | | | order from |
| | | | | GrowerDistributionCenter |
| | | | | Database. |
| GetOrder | Public | Integer | OrderDataset | This function calls |
| | | | | Usp_DC_get_OrderByShipment |
| | | | | ID stored procedure to |
| | | | | retrieve Orderdetails for given |
| | | | | ShipmentResponseID from |
| | | | | GrowerDistributionCenter |
| | | | | Database. |
| GetOrderDetails | Public | String | OrderDetailDS | This function calls |
| | | | | Usp_DC_get_Orders stored |
| | | | | procedure to retrieve |
| | | | | Orderdetails for specified date |
| | | | | from |
| | | | | GrowerDistributionCenter |
| | | | | Database. |
| GetOrderStatus | Public | String | OrderStatusDS | This function calls |
| | | | | Usp_DC_get_OrderStatus |
| | | | | stored procedure to retrieve |
| | | | | Orderdetails for given |
| | | | | ShipmentResponseIDs, Which |
| | | | | is supplied in coma separated |
| | | | | string. from |
| | | | | GrowerDistributionCenter |
| | | | | Database. |
| GetOrder | Public | Integer | OrderDataset | This function calls |
| | | | | Usp_DC_get_OrdersByPrintJob |
| | | | | ID stored procedure to |
| | | | | retrieve Orderdetails for given |
| | | | | PrintJobId from |
| | | | | GrowerDistributionCenter |
| | | | | Database. |
| GetOrder | Public | String | OrderDataset | This function calls |
| | | | | usp_grower_get_OrderAccDetails |
| | | | | stored procedure to |
| | | | | retrieve Orderdetails for given |
| | | | | shipdate from |
| | | | | GrowerDistributionCenter |
| | | | | Database. |
| GetOutOfSyncCount | Public | DateTime, | OutOfSyncStruct | This function calls |
| | | DateTime | | Usp_DC_get_OutOfSyncCount |
| | | | | stored procedure to retrieve |
| | | | | record count of newly |
| | | | | downloaded orders for given |
| | | | | time and shipdate. |
| GetPrintOrder | Public | string | PrintOrderDS | This function calls |
| | | | | Usp_DC_get_PrintOrder |
| | | | | stored procedure to retrieve |
| | | | | Orderdetails, which is used for |
| | | | | printing labels for given |
| | | | | ShipmentResponseIDs, Which |
| | | | | is supplied in coma separated |
| | | | | string. from |
| | | | | GrowerDistributionCenter |
| | | | | Database |
| GetPrintProductSummaryDetails | Public | string | ProductSummrayDS | This function calls |
| | | | | Usp_DC_get_PrintProductsSummary |
| | | | | stored procedure to |
| | | | | retrieve product summary for |
| | | | | given ShipmentResponseIDs, |
| | | | | Which is supplied in coma |
| | | | | separated string. from |
| | | | | GrowerDistributionCenter |
| | | | | Database |
| GetPrintSummaryGrid | Public | String, | PrintSummaryDS | This function calls |
| | | string | | Usp_DC_get_PrintSummaryGrid |
| | | | | stored procedure to retrieve |
| | | | | orders summary for given |
| | | | | period from |
| | | | | GrowerDistributionCenter |
| | | | | Database |
| UpdateOrder | Public | Integer, | Boolean | This function calls |
| | | string | | Usp_DC_u_UpdateOrderStatus |
| | | | | stored procedure to update |
| | | | | the order for given |
| | | | | shipmentResponseId with the |
| | | | | given OrderStatus into |
| | | | | GrowerDistributionCenter |
| | | | | Database |
| UpdateOrder | Public | OrderStatusDS | Boolean | This function calls |
| | | | | Usp_DC_i_OrderHistory |
| | | | | stored procedure to update the |
| | | | | order for given set of |
| | | | | shipmentResponseIds with the |
| | | | | given OrderStatuses into |
| | | | | GrowerDistributionCenter |
| | | | | Database |
| getDeletedOrders | Public | NA | OrderDataset | This function calls |
| | | | | Usp_DC_get_DeletedOrders |
| | | | | stored procedure to retrieve |
| | | | | deleted orders from |
| | | | | GrowerDistributionCenter |
| | | | | Database |
| GetPrintOrder | Public | string | PrintOrderDS | This function calls |
| | | | | Usp_DC_get_PrintOrder |
| | | | | stored procedure to retrieve |
| | | | | Orderdetails, which is used for |
| | | | | printing labels for given |
| | | | | ShipmentResponseIDs, Which |
| | | | | is supplied in coma separated |
| | | | | string. from |
| | | | | GrowerDistributionCenter |
| | | | | Database |
| getOrders | Public | Arraylist | PrintOrderDS | |
| getOrders | Public | Integer, | OrderDataset | This function calls |
| | | Integer, | | Usp_DC_get_PrintOrders |
| | | Integer, | | stored procedure to retrieve |
| | | Integer | | printed orders for given |
| | | | | JobId, BatchID and position |
| | | | | range from |
| | | | | GrowerDistributionCenter |
| | | | | Database |

PRVFulfillmentSystem DataSets
Project Name: DCProcessing.Datasets

| Dataset Name | Description |
|---|---|
| AccessorySummaryDS.xsd | It carries accessory summary information. |
| ConfigurationDS.xsd | It carries configuration information. |
| DeletedSummaryDS.xsd | It carries deleted summary information |
| FutureOrderDS.xsd | It carries future order details. |
| OrderDataset.xsd | It carries order details as well as accessory details. |
| OrderDetailDS.xsd | It carries order details for displaying purpose. |
| OrderStatusDS.xsd | It carries the status of orders. |
| PrinterDS.xsd | It carries printer details. |
| PrintJobDS.xsd | It carries print job details. |
| PrintJobSummaryDS.xsd | It carries print job summary details. |
| PrintOrderDS.xsd | It carries print orders details. |
| PrintProductSummaryDS.xsd | It carries print product summary details. |
| PrintSummaryDS.xsd | It carries print summary details. |
| ProductSummaryDS.xsd | It carries product summary details. |
| Project Name: Fulfillment.DataSets | |
| AccessoryDataSet.xsd | It carries accessories information. |
| FulfillmentDataSet.xsd | |
| FulfillmentStatusDataSet.xsd | |
| GrowerConfigurationDataSet.xsd | |
| GrowerShipmentDataSet.xsd | |
| ShipmentDataSet.xsd | |
| ShippingDataSet.xsd | |
| ShipResultDataSet.xsd | |
| TrackingResultDataSet.xsd | |
| UPSOnlineToolsTrackingSystemAccess | |
| RequestDataSet.xsd | |
| UPSOnlineToolsTrackingSystemTrackRequest | |
| DataSet.xsd | |
| UPSQuantumViewTrackingSystemAccess | |
| RequestDataSet.xsd | |
| UPSQuantumViewTrackingSystemTrack | |
| RequestDataSet.xsd | |

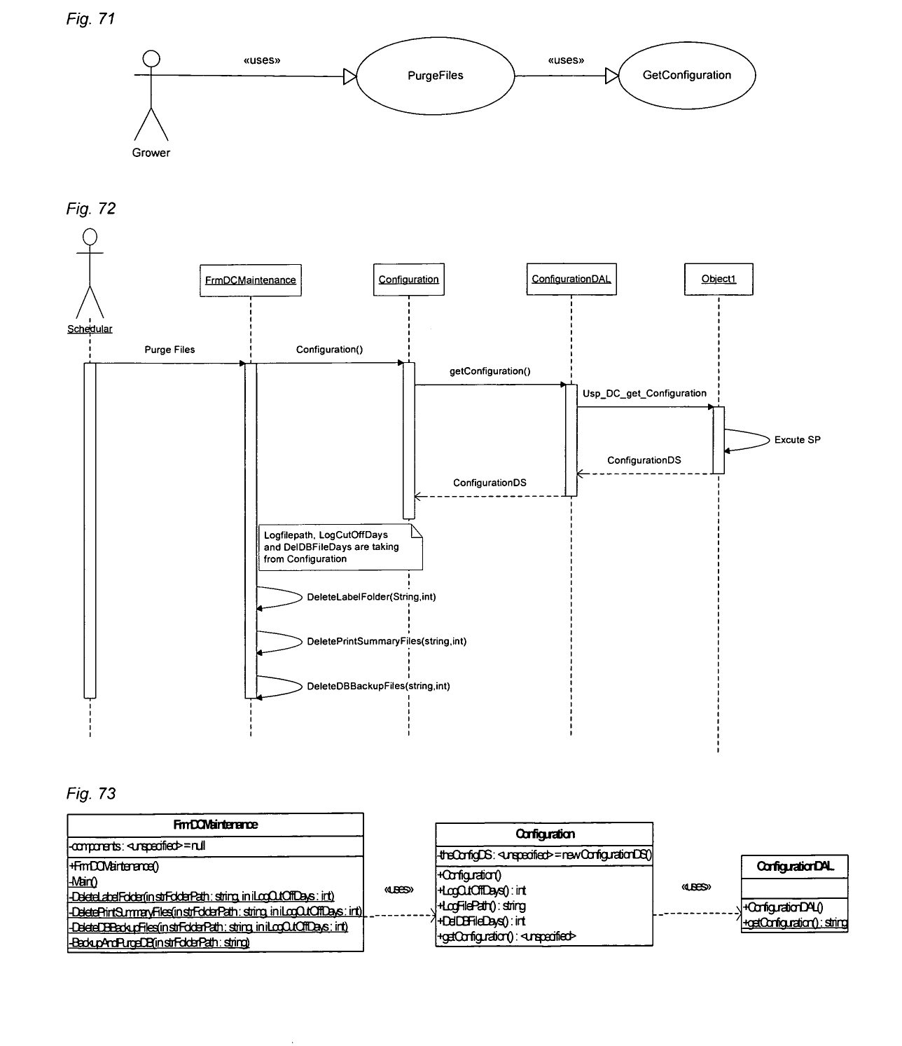

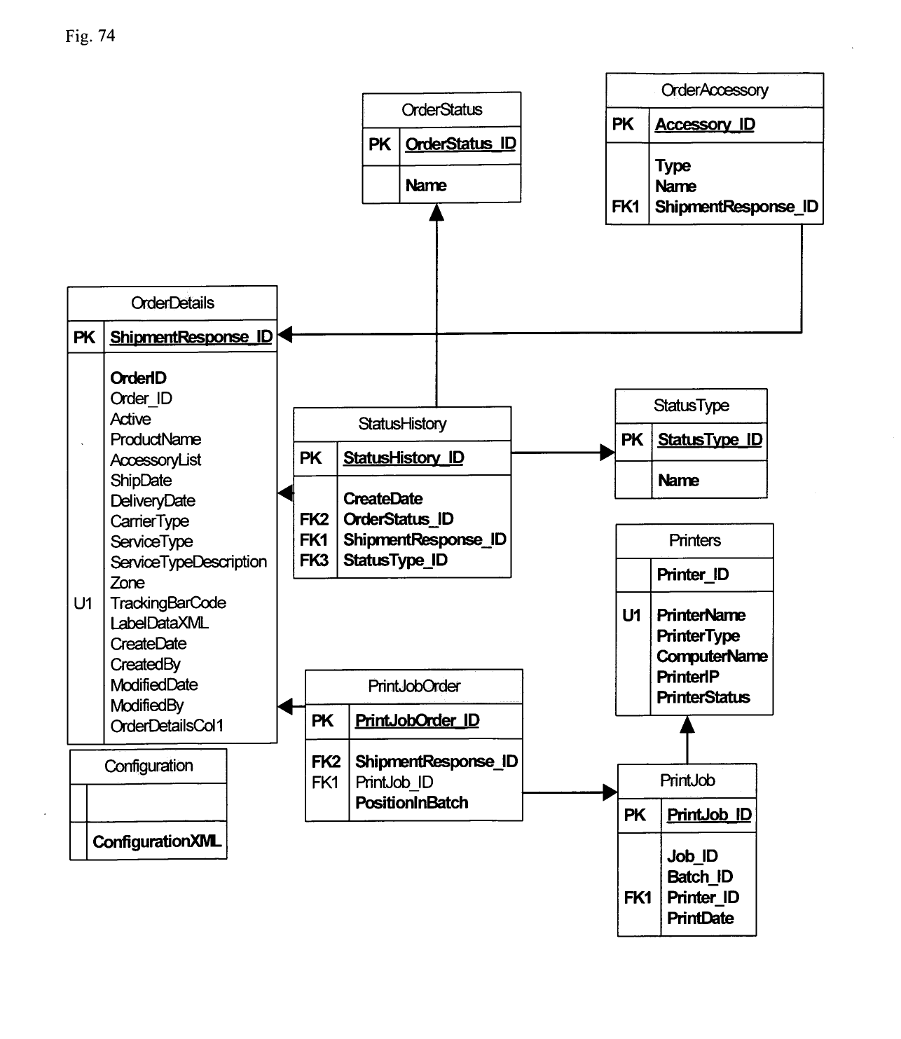

PRVDFulfillmentSystem Database Design Diagram: see FIGS. 71-74.
Table Name: OrderDetails
Description: This table carries the detailed information about the Orders shipped. This table used when User want to get more specific information for an order. This table used to get details of Orders for printing Labels.
Table Name: OrderAccessory
Description: This table stores the Accessories associated with an order. This is used when we want to display Orders or Print Orders based on Accessories.
Table Name: StatusHistory
Description: Stores the order status of each order. This table is used when we want to display orders or Printed Orders.
Table Name: OrderStatus
Description: Stores the all kinds of Order statuses. This table is used when we want to display Orders or Printed Orders.
Table Name: StatusType
Description: Stores the application name as well as id for that application. This table is used when we want to display Orders or Printed Orders.
Table Name: Printers
Description: Stores the information related to printers. This table used to display printers available for Order/Report Printing.
Table Name: PrintJob
Description: Stores the information related each print job. This table is used when we want to display Printed Orders or print summary reports.
Table Name: PrintJobOrder
Description: Stores the information related each print job Order. This table is also used when we want to display Printed Orders or Print Summary reports.
Table Name: Configuration
Description: Stores the entire system settings for PRVDFulfillmentSystem. Any changes is done on PRVDFulfillmentSystem that need to update in Configuration table.

PRVDFulfillmentSystem Database Objects

| Object Type | File Name | Object Name |
|---|---|---|
| Stored | dbo.Usp_DC_d_Order | Usp_DC_d_Order |
| Procedure | | |
| Stored | dbo.Usp_DC_d_OrderAccessories | Usp_DC_d_OrderAccessories |
| Procedure | | |
| Stored | dbo.USP_DC_get_AccessorySummary | USP_DC_get_AccessorySummary |
| Procedure | | |
| Stored | dbo.Usp_DC_get_AccessroyReport | Usp_DC_get_AccessroyReport |
| Procedure | | |
| Stored | dbo.Usp_DC_get_Archive | Usp_DC_get_Archive |
| Procedure | | |
| Stored | dbo.Usp_DC_get_Configuration | Usp_DC_get_Configuration |
| Procedure | | |
| Stored | dbo.Usp_DC_get_DeletedOrders | Usp_DC_get_DeletedOrders |
| Procedure | | |
| Stored | dbo.Usp_DC_get_DeletedSummary | Usp_DC_get_DeletedSummary |
| Procedure | | |
| Stored | dbo.Usp_DC_get_DistinctShipDates | Usp_DC_get_DistinctShipDates |
| Procedure | | |
| Stored | dbo.Usp_DC_get_FindOrder | Usp_DC_get_FindOrder |
| Procedure | | |
| Stored | dbo.Usp_DC_get_Order | Usp_DC_get_Order |
| Procedure | | |
| Stored | dbo.Usp_DC_get_Orders | Usp_DC_get_Orders |
| Procedure | | |
| Stored | dbo.Usp_DC_get_OrdersByDate | Usp_DC_get_OrdersByDate |
| Procedure | | |
| Stored | dbo.Usp_DC_get_OrdersByPrintJobID | Usp_DC_get_OrdersByPrintJobID |
| Procedure | | |
| Stored | dbo.Usp_DC_get_OrdersByShipmentID | Usp_DC_get_OrdersByShipmentID |
| Procedure | | |
| Stored | dbo.Usp_DC_get_OrderStatus | Usp_DC_get_OrdersStatus |
| Procedure | | |
| Stored | dbo.Usp_DC_get_OutOfSyncCount | Usp_DC_get_OutOfSyncCount |
| Procedure | | |
| Stored | dbo.Usp_DC_get_Printer | Usp_DC_get_Printer |
| Procedure | | |
| Stored | dbo.Usp_DC_get_PrinterCount | Usp_DC_get_PrinterCount |
| Procedure | | |
| Stored | dbo.Usp_DC_get_PrinterLogSummary | Usp_DC_get_PrinterLogSummary |
| Procedure | | |
| Stored | dbo.Usp_DC_get_PrintJob | Usp_DC_get_PrintJob |
| Procedure | | |
| Stored | dbo.Usp_DC_get_PrintJobOrders | Usp_DC_get_PrintJobOrders |
| Procedure | | |
| Stored | dbo.Usp_DC_get_PrintJobSummary | Usp_DC_get_PrintJobSummary |
| Procedure | | |
| Stored | dbo.Usp_DC_get_PrintOrder | Usp_DC_get_PrintOrder |
| Procedure | | |
| Stored | dbo.Usp_DC_get_PrintOrders | Usp_DC_get_PrintOrders |
| Procedure | | |
| Stored | dbo.Usp_DC_get_PrintProductsSummary | Usp_DC_get_PrintProductsSummary |
| Procedure | | |
| Stored | dbo.Usp_DC_get_PrintProductSummary | Usp_DC_get_PrintProductSummary |
| Procedure | | |
| Stored | dbo.Usp_DC_get_PrintProductSummaryReport | Usp_DC_get_PrintProductSummaryReport |
| Procedure | | |
| Stored | dbo.Usp_DC_get_PrintSummary | Usp_DC_get_PrintSummary |
| Procedure | | |
| Stored | dbo.Usp_DC_get_PrintSummaryGrid | Usp_DC_get_PrintSummaryGrid |
| Procedure | | |
| Stored | dbo.Usp_DC_get_ProductReport | Usp_DC_get_ProductReport |
| Procedure | | |
| Stored | dbo.Usp_DC_get_ProductSummary | Usp_DC_get_ProductSummary |
| Procedure | | |
| Stored | dbo.Usp_DC_i_AddAccessories | Usp_DC_i_AddAccessories |
| Procedure | | |
| Stored | dbo.Usp_DC_i_AddPrintJob | Usp_DC_i_AddPrintJob |
| Procedure | | |
| Stored | dbo.Usp_DC_i_AddPrintJobOrder | Usp_DC_i_AddPrintJobOrder |
| Procedure | | |
| Stored | dbo.Usp_DC_i_OrderHistory | Usp_DC_i_OrderHistory |
| Procedure | | |
| Stored | dbo.Usp_DC_iu_Order | Usp_DC_iu_Order |
| Procedure | | |
| Stored | dbo.Usp_DC_iu_Printer | Usp_DC_iu_Printer |
| Procedure | | |
| Stored | dbo.Usp_DC_u_UpdateConfiguration | Usp_DC_u_UpdateConfiguration |
| Procedure | | |
| Stored | dbo.Usp_DC_u_UpdateOrderStatus | Usp_DC_u_UpdateOrderStatus |
| Procedure | | |
| Stored | dbo.usp_sysadmin_AddLogin | usp_sysadmin_AddLogin |
| Procedure | | |
| Stored | dbo.usp_sysadmin_CreateRole_GrantPermission | usp_sysadmin_CrateRole_GrantPermission |
| Procedure | | |
| User Defined | dbo.udf_DC_getLatestActiveStatus | udf_DC_getLatestActiveStatus |
| Functions | | |
| User Defined | dbo.udf_DC_getOrderStatusFromID | udf_DC_getOrderStatusFromID |
| Functions | | |
| User Defined | dbo.udf_DC_getOrderStatusID | udf_DC_getOrderStatusID |
| Functions | | |
| User Defined | dbo.udf_DC_getStatusTypeID | udf_DC_getStatusTypeID |
| Functions | | |

| Object Type | Parameters | Returns | Description |
|---|---|---|---|
| Stored | @ShipmentResponseID | NA | |
| Procedure | int, | | |
| | @Status | | |
| | Varchar(20) | | |
| Stored | @ShipmentResponse_ID | NA | |
| Procedure | int | | |
| Stored | NA | Dataset | |
| Procedure | | | |
| Stored | @startDate | Dataset | |
| Procedure | varchar(12), | | |
| | @endDate | | |
| | varchar(12) | | |
| Stored | @ArchiveDate | Dataset | |
| Procedure | varchar(12) | | |
| Stored | NA | Dataset | |
| Procedure | | | |
| Stored | NA | Dataset | |
| Procedure | | | |
| Stored | @startDate | Dataset | |
| Procedure | varchar(12), | | |
| | @endDate | | |
| | varchar(12) | | |
| Stored | NA | Dataset | |
| Procedure | | | |
| Stored | @searchCriteria | Dataset | |
| Procedure | varchar(20), | | |
| | @searchValues | | |
| | nvarchar(4000), | | |
| | @startDate | | |
| | varchar(12), | | |
| | @endDate | | |
| | varchar(12) | | |
| Stored | @searchValues | Dataset | |
| Procedure | varchar(2000) | | |
| Stored | @shipDate | Dataset | |
| Procedure | varchar(12) | | |
| Stored | @shipDate | Dataset | |
| Procedure | varchar(12) | | |
| Stored | @PrintJobID int | Dataset | |
| Procedure | | | |
| Stored | @ShipmentID | Dataset | |
| Procedure | varchar(20) | | |
| Stored | @SEARCH | Dataset | |
| Procedure | varchar(2000) | | |
| Stored | @refreshTime | Dataset | |
| Procedure | varchar(30), | | |
| | @shipDate | | |
| | varchar(12) | | |
| Stored | NA | Dataset | |
| Procedure | | | |
| Stored | NA | Dataset | |
| Procedure | | | |
| Stored | NA | Dataset | |
| Procedure | | | |
| Stored | @PrintJobID | Dataset | |
| Procedure | bigint | | |
| Stored | @PrintJobID | Dataset | |
| Procedure | bigint | | |
| Stored | @startDate | Dataset | |
| Procedure | varchar(12), | | |
| | @endDate | | |
| | varchar(12) | | |
| Stored | @SEARCH | Dataset | |
| Procedure | varchar(2000) | | |
| Stored | @PrintJobID | Dataset | |
| Procedure | bigint, | | |
| | @BatchID int, | | |
| | @FromPos int, | | |
| | @ToPos int | | |
| Stored | @shipmentResponseIds | Dataset | |
| Procedure | varchar(2000) | | |
| Stored | NA | Dataset | |
| Procedure | | | |
| Stored | @startDate | Dataset | |
| Procedure | varchar(12), | | |
| | @endDate | | |
| | varchar(12) | | |
| Stored | NA | Dataset | |
| Procedure | | | |
| Stored | @startDate | Dataset | |
| Procedure | varchar(12), | | |
| | @endDate | | |
| | varchar(12) | | |
| Stored | NA | Dataset | |
| Procedure | | | |
| Stored | NA | Dataset | |
| Procedure | | | |
| Stored | @ShipmentResponse_ID | NA | |
| Procedure | int, | | |
| | @Type char(3), | | |
| | @Name | | |
| | varchar(100) | | |
| Stored | @PrintJob_ID int, | NA | |
| Procedure | @Job_ID bigint, | | |
| | @Batch_ID | | |
| | bigint, | | |
| | @Printer_ID | | |
| | bigint, | | |
| | @PrintDate | | |
| | datetime | | |
| Stored | @PrintJob_ID int, | NA | |
| Procedure | @PositionInBatch | | |
| | int, | | |
| | @ShipmentResponse_ID | | |
| | bigint | | |
| Stored | @ShipmentResponse_ID | NA | |
| Procedure | int, | | |
| | @Statusvarchar(20)@AppTypevarchar(20) = | | |
| | ‘DCPROCESSING’ | | |
| Stored | @ShipmentResponse_ID | NA | |
| Procedure | int, | | |
| | @OrderIDchar(12), | | |
| | @Order_ID | | |
| | int, @ProductNamearchar(255), | | |
| | @AccessoryList | | |
| | varchar(20), | | |
| | @ShipDate | | |
| | datetime, | | |
| | @DeliveryDate | | |
| | datetime, | | |
| | @CarrierType | | |
| | varchar(30), | | |
| | @ServiceType | | |
| | varchar(30), | | |
| | @ServiceTypeDescription | | |
| | varchar(32), | | |
| | @Zone char(12), | | |
| | @TrackingBarCode | | |
| | char(32), | | |
| | @LabelDataXML | | |
| | archar(4000), | | |
| | @CreateDate | | |
| | datetime, | | |
| | @CreatedBy | | |
| | varchar(30), | | |
| | @ModifiedDate | | |
| | datetime, | | |
| | @ModifiedBy | | |
| | varchar(30) | | |
| Stored | @Printer_ID | NA | |
| Procedure | Numeric, | | |
| | @PrinterName | | |
| | Varchar(100), | | |
| | @PrinterType | | |
| | Char(10), | | |
| | @ComputerName | | |
| | Varchar(50), | | |
| | @PrinterStatus | | |
| | Bit | | |
| Stored | @ConfigurationXML | NA | |
| Procedure | varchar(4000) | | |
| Stored | @ShipmentResponse_ID | NA | |
| Procedure | int, | | |
| | @OrderStatus | | |
| | char(10) | | |
| Stored | @Domain | NA | |
| Procedure | varchar(500), | | |
| | @Login | | |
| | varchar(500) | | |
| Stored | NA | NA | |
| Procedure | | | |
| User Defined | @ShipmentresponseID | OrderStatus | |
| Functions | | ID | |
| User Defined | @StatusID | Status | |
| Functions | | Name | |
| User Defined | @OrderStatusName | Order | |
| Functions | | Status | |
| | | ID | |
| User Defined | @AppName | StatusID | |
| Functions | | | |

There can also be an integration with a multi-carrier system(s). See U.S. application Ser. No.: 11/488,546, titled “Multi-carrier Management System,” incorporated by reference.

SSL System

In order to get SSL to work with the Sonic for client/server communication, the following process can be followed. For the SSL certificates, a self-signed certificate can be used, or we can purchase certificates from a certificate authority such as verisign.

Generate Certificate Signing Request from Sonic:

1. Launch the Sonic Management Console

2. From the Tools Menu, select “Certificate Manager”

3. Create a new certificate store by giving a path and file name (any can do) and click Open

4. Select the store from the list on the left once it is created

5. Select the requests tab to create a new CSR

6. Fill out the form entirely

7. Click Generate

8. Click Save and save this to a file

Sign the CSR and generate the certificate.

Using Order Fulfillment Service:

1. Copy the CSR file to EngContent

2. Terminal Service to EngContent

3. Open a CMD window and type CertReq and press enter

4. Locate the CSR file and click Open.

5. Select the Order Fulfillment Service certificate Authority when asked

6. Save the generated certificate file

7. Copy it back to the sonic machine

Using Verisign:

1. Send the CSR to verisign to create the certificate

2. Receive the completed certificate.

Import the certificate back into Sonic

1. Go back to the SMC/Certificate Manager

2. Select the Import tab

3. Select the CSR you generated in the Alias list

4. In the Type box, select “Certificate”

5. Browse for the certificate file you created on EngContent (or received from Verisign)

6. Click Import

7. In the Alias list, both Private Key and Certificate should be checked

Export the Certificate in PKCS12 Format for Sonic

1. Sonic Works from a PKCS12 encoded certificate pair

2. Using the SMC/Certificate Manager, select the Export tab

3. Select the Certificate in the Alias List

4. In the Format box, select PKCS12

5. Enter a file name and password

6. Click Export to generate the file

Configure SonicMQ Windows Services to include SSL JARs.

1. Include the SSL classpath in the Sonic startup when started as a windows service

2. Run Regedit on the sonic box

3. Find the SonicMQ service key (LocalMachine\System\CurrentControlSet\Services)

4. Select the Parameters Folder and the CP key

5. Open that key and add this to the end:

6. ;f:\SonicSoftware\SonicMQ1\lib\certj.jar;f:\SonicSoftware\SonicMQ1\lib\sslj.jar;f:\SonicSoftware\SonicMQ1\lib\jsafe.jar;f:\SonicSoftware\SonicMQ13lib\asn1.jar

Configure Sonic Broker to Use this Certificate

1. Copy the PKCS12 file to SonicMQ/Certs folder

2. Copy the CA public key file to the SonicMQ/Certs/CA folder

3. If using the Order Fulfillment Service, it needs to first be DER encoded—this can be done by opening the windows cert manager, finding the Order Fulfillment Service key, then exporting it as DER encoded.

4. If versign was used, just export as DER encoded from any verisign key by opening the key, selecting the verisign parent and export that in DER format

5. Open SMC and go to “Configure” tab

6. Select the broker, right click and select “Properties”

7. Select the SSL tab

8. Make sure the jsafe provider is selected

9. Under Certificate Chain, select PKCS12 format

10. For Path Name, provide the file name of the broker certificate

11. Click Set Password

12. Enter the password used when you exported the key to PKCS12 format

13. Click OK, OK, OK

14. In the SMC, expand the broker, right click on Acceptors and select NEW->TCP/SSL

15. Enter a name for this acceptor (SSL_ACCEPTOR is fine)

16. Enter the URL that matches the certificate (sonicbroker. (Order Fulfillment Service).com)

17. Enter a port number for this SSL connection

18. Check the SSL box

19. Select the SSL tab

20. Under Certificate Chain, do the same process as before (PKCS12, path to key file, set private key password)

21. Restart the broker and verify that log file says “SSL_ACCEPTOR: accepting connections on ssl: . . . ”

22. In the SMC, right click on Acceptors and Select Properties

On the General Tab, make sure that the Primary Acceptor and the Interbroker Acceptor are NOT the SSL acceptor we just created

Repeat for each broker (DS not necessary)

Include the CA Public Key on the Client

1. Copy the DER encoded CA public key and include it with the client distribution

2. Make sure the grower client is configured to look in the correct folder to find this key (can be same folder as EXE)

3. Add this command line parameter to the batch file that launches the JRE for the client:

4. -DSSL_CA_CERTIFICATES_DIR=.

5. (use the . if the CA file is in the same dir as the grower client, otherwise specify the dir)

6. Set the broker connection URL to use ssl://instead of tcp://

Optional: Test SSL connectivity to Broker with OpenSSL (an open source SSL library from www. openssl. org).

1. Once the broker is configured to use ssl, you can test it with openssl

2. Using a command prompt, execute openSSL:

3. Openssl s_client-connect brokerurl:port-cipher RC4-MD5

4. Read the result and look for any fatal errors

Turn now to the appendix for yet further details.

Accordingly, some embodiments can be viewed as including, depending on the implementation, apparatus, a method for use and method for making, and corresponding products produced thereby, as well as data structures, computer-readable media tangibly embodying program instructions, manufactures, and necessary intermediates of the foregoing. Representatively, consider an embodiment characterized as a method for using an apparatus.

More broadly, however, the terms and expressions which have been employed herein are used as terms of teaching and not of limitation, and there is no intention, in the use of such terms and expressions, of excluding equivalents of the features shown and described, or portions thereof, it being recognized that various modifications are possible within the scope of the embodiments contemplated and suggested herein. Although the disclosure herein has been described with reference to specific embodiments, the disclosures are intended to be illustrative and are not intended to be limiting. Various modifications and applications may occur to those skilled in the art without departing from the true spirit and scope of the invention as defined in claims.

Thus, although only a few exemplary embodiments have been described in detail above, those skilled in the art can readily appreciate that many modifications are possible in the exemplary embodiments without materially departing from the novel teachings and advantages herein. Accordingly, all such modifications are intended to be included within the scope defined by claims. As used herein, means-plus-function is intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment fastening wooden parts, a nail and a screw may be equivalent structures.

LENGTHY TABLE
The patent application contains a lengthy table section. A copy of the table is available in electronic form from the USPTO web site (http://seqdata.uspto.gov/?pageRequest=docDetail&DocID=US20070174151A1). An electronic copy of the table will also be available from the USPTO upon request and payment of the fee set forth in 37 CFR 1.19(b)(3).

We claim:

1. A shipment system, the system including:
a system including a proximate end and a distal end,
the proximate end including a computing system communicating, at least in part over the Internet, a real-time stream of delivery date-specific orders,
the distal end including a producer of the perishables and a second computing system receiving the orders and controlling printing of the orders,
a plurality of shipments from the distal end, each of the shipments including at least one of the perishables that is harvested, packed, and shipped to correspond to one of the orders.

2. The system of claim 1, wherein the perishables include a plant.

3. The system of claim 1, wherein the perishables include a flower.

4. The system of claim 1, wherein the perishables include a meat.

5. The system of claim 1, wherein the perishables include a fruit.

6. The system of claim 1, wherein the perishables include a fish or a crustacea.

7. The system of claim 1, wherein at least one of the shipments includes at least one of said perishables and an accessory.

8. A shipment system, the system including:
a system including a proximate end and a distal end,
the proximate end including a computing system communicating, at least in part over the Internet, a real-time stream of delivery date-specific orders,
the distal end including a facility producing the perishables and a second computing system receiving the real-time stream of delivery date-specific orders,
a plurality of shipments from the distal end, each of the shipments including at least one of the perishables that is packed and shipped to correspond to one of the orders.

9. The system of claim 8, wherein at least one of the shipments includes a plant.

10. The system of claim 8, wherein at least one of the shipments includes a flower.

11. The system of claim 8, wherein at least one of the shipments includes a meat.

12. The system of claim 8, wherein at least one of the shipments includes a fruit.

13. The system of claim 8, wherein at least one of the shipments includes a confection.

14. The system of claim 8, wherein at least one of the shipments includes at least one of said perishables and an accessory.

15. The system of claim 8, wherein at least one of said shipments includes a card with a message, the message sent from a purchaser's computing system, to a recipient of one of the shipments.

16. A computer system including:
a computing system receiving, from a wide area network, a real-time stream of delivery date-specific orders, the computing system processing the stream, the processing including controlling printing of the stream of delivery date-specific orders.

17. The system of claim 16, wherein the processing includes managing a wave of said orders by distinguishing the wave from others of said orders; and wherein said controlling includes optimizing printing with a set of printers by using a subset of the printers to maintain integrity of the wave of said orders.

18. The system of claim 17, wherein the controlling printing includes printing a box end label for each of a plurality of the orders, the box end label including a carrier shipping mode image.

19. The system of claim 16, wherein the processing is devoid of sorting the orders according to warehouse efficiency.

20. The system of claim 16, wherein the processing includes sorting the orders according to carrier drop ship locations.

21. The system of claim 16, wherein the processing includes sorting the orders according to carrier shipment routing zones.

22. The system of claim 16, wherein the processing includes sorting the orders according to shipment dates.

23. The system of claim 16, wherein the processing includes sorting the orders according to pre-boxing requirements.

24. The system of claim 16, wherein the processing includes sorting the orders by carrier.

25. The system of claim 16, wherein the processing includes sorting the orders according to delivery dates.

26. The system of claim 16, wherein the processing includes sorting the orders to minimize shipping transit time.

27. The system of claim 16, wherein the processing includes sorting according to shipping mode.

28. The system of claim 16, wherein the processing includes sorting to optimize fulfillment of the orders.

29. The system of claim 16, wherein at least one of said delivery date-specific orders includes a date-specific order of at least one perishable.

30. The system of claim 16, wherein some of said delivery date-specific orders specify a different perishable than others of said orders specify.

31. The system of claim 16, wherein some of said orders signal to pick, pack, and ship.

32. The system of claim 16, wherein said real-time stream of delivery date-specific orders includes a real-time stream of delivery date-specific orders sent by an e-commerce order processing system.

33. The system of claim 16, further including an e-commerce order processing system sending said real-time stream of delivery date-specific orders.

34. The system of claim 33, further including a customer computer, and wherein said real-time stream of delivery date-specific orders includes at least one order communicated by the customer computer to the e-commerce order processing system.

35. The system of claim 34, wherein said the computing system is programmed to send a stream of real time status information, the information corresponding to at least some of the orders, to the order processing system.

36. A system processing a real-time stream of orders for perishables, the system including:
a computing system;
an interface with a wide area network;
means for controlling the computer system to receive, through the interface, a real-time stream of orders for perishables, to process the orders, and to print the orders.

37. The system of claim 36, wherein the means for controlling is comprised of at least one computer program, and the wide area network is comprised of the Internet.

38. A computer-readable media tangibly embodying a program of instructions executable by a computer in a system to perform the operations of:
controlling the computer system to receive a real-time stream of orders for perishables from a wide area network, to process the orders, and to print the orders.

39. The media of claim 38, wherein the media comprises at least one of a RAM, a ROM, a disk, an ASIC, and a PROM.

40. A computer system including:
a computer system arranged to receive information in real time and locate said information into a memory, the information including a plurality of orders, wherein some of the plurality of orders are delivery date-specific orders of at least one perishable, the computer system including at least one input device located for receiving the information from a wide area network, the computer system further including a plurality of printers, the computer system also including at least one processor and at least one computer program controlling the processor to sort the orders and print the orders to facilitate shipping corresponding to the orders.

41. The computer system of claim 40, wherein the computer system is arranged to send, in real time over a wide area network, status information corresponding to some of the orders.

42. A computer system adapted for processing delivery date-specific orders, the computer system including:
a provider computer system programmed to respond to a real-time stream of delivery date-specific orders, received from an e-commerce system, by facilitating shipment of some, but not all, of the orders, wherein:
if there is no intervention by the e-commerce system in fulfillment of one of the orders, the provider computer system defaults to facilitate a shipment corresponding to the one of the orders;
if there is intervention by the e-commerce system in fulfillment of the one of the orders, the provider computer system does not facilitate a shipment corresponding to the one of the orders

43. The computer system of claim 42, wherein the provider information communicates status information for the orders, in real time, to the e-commerce system.

44. A computer-aided method, the method including:
receiving, from a wide area network, a real-time stream of delivery date-specific orders; and
shipping to fulfill at least some of the orders.

45. The method of claim 44, wherein at least one of said delivery date-specific orders includes a date-specific order for at least one perishable.

46. The method of claim 45, wherein said shipping to fulfill at least some of the orders comprises shipping different perishables to correspond to at least some of said orders.

47. The method of claim 44, wherein said receiving a real-time stream of delivery date-specific orders is carried out with at least some of said orders including instructions to pick, pack, and ship.

48. The method of claim 44, wherein said receiving a real-time stream of delivery date-specific orders includes receiving a real-time stream of delivery date-specific orders sent to the wide area network by an e-commerce order processing system.

49. The method of claim 44, further including sending real time status information, the information corresponding to at least some of the orders, to the order processing system.

50. The method of claim 44, further including managing a wave of said orders distinct from others of said orders.

51. The method of claim 44, wherein said managing a wave includes distinguishing the wave from others of said orders by forming at least one batch of the orders.

52. The method of claim 44, wherein said managing a wave includes defining the wave by at least one sorting of the orders.

53. The method of claim 52, wherein said sorting is devoid of sorting for warehouse efficiency.

54. The method of claim 52, wherein said sorting includes optimizing for drop shipping carrier pickup.

55. The method of claim 52, wherein said sorting includes optimizing for carrier shipment routing zones.

56. The method of claim 52, wherein said sorting includes optimizing for shipment date.

57. The method of claim 52, wherein said sorting includes optimizing for-fulfillment.

58. The method of claim 52, wherein said sorting includes optimizing shipping.

59. The method of claim 52, wherein said sorting includes optimizing for shipping respective deliveries according to said date-specific orders.

60. The method of claim 52, wherein said sorting includes optimizing for minimum transit time.

61. The method of claim 52, wherein said shipping to fulfill at least some of the orders includes optimizing fulfillment but not optimizing for warehouse efficiency.

62. The method of claim 52, wherein said shipping to fulfill at least some of the orders includes optimizing for respective deliveries according to said date-specific orders but not optimizing for warehouse efficiency.

63. The method of claim 44, further including, receiving, from the wide area network, a real-time stream of cancellations for a plurality of the orders, the stream of cancellations from an e-commerce order processing system.

64. The method of claim 44, further including, receiving, from the wide area network, a real-time stream of order updates for a plurality of the orders, the stream of order updates from an e-commerce order processing system.

65. A computer-aided method including:
sending, to a wide area network, a real-time stream of status information, the information corresponding to at least some of delivery date-specific orders; and
shipping to fulfill at least some of the orders.

66. The method of claim 65, wherein the sending includes sending the real-time stream of status information to an e-commerce order processing system.

67. The method of claim 65, wherein at least one of said delivery date-specific orders includes a delivery date-specific order for at least one perishable.

68. The method of claim 65, wherein said shipping to fulfill at least some of the orders comprises shipping different perishables to correspond to at least some of said orders.
